(19) United States
(12) Patent Application Publication
(10) Pub. No.: US 2014/0207694 A1
(43) Pub. Date: Jul. 24, 2014

(54) ELECTORAL INTEGRITY ASSESSMENT METHOD, AND SYSTEM

(71) Applicant: International Foundation for Electoral Systems, Washington, DC (US)

(72) Inventors: Chad VICKERY, Chevy Chase, MD (US); Erica SHEIN, Falls Church, VA (US); Staffan DARNOLF, Durban (ZA)

(73) Assignee: International Foundation for Electoral Systems, Washington, DC (US)

(21) Appl. No.: 14/160,066

(22) Filed: Jan. 21, 2014

Related U.S. Application Data
(60) Provisional application No. 61/754,909, filed on Jan. 21, 2013.

(51) Int. Cl. G06Q 30/00

(52) U.S. Cl. CPC G06Q 30/018
USPC 705/317

(57) ABSTRACT

A method of electoral integrity assessment, and system. The method and system includes a qualitative assessment and quantitative assessment.

### FIELD

An electoral integrity assessment method, and system for analyzing the electoral integrity of a particular country.

### BACKGROUND

There exists a need to access the electoral integrity of countries around the world to understand vulnerabilities in their electoral processes. Currently, most information and data regarding electoral integrity is unorganized and subjective.

### SUMMARY

An electoral integrity assessment method comprising or consisting of analyzing or accessing an electoral process.

An electoral integrity assessment method comprising or consisting of analyzing or accessing an electoral process of a particular country.

An electoral integrity assessment method comprising or consisting of analyzing or accessing the integrity of an electoral process.

An electoral integrity assessment method comprising or consisting of analyzing or accessing the integrity of an electoral process of a particular country.

An electoral integrity assessment method comprising or consisting of qualitatively accessing the integrity of an electoral process.

An electoral integrity assessment method comprising or consisting of quantitatively accessing the integrity of an electoral process.

An electoral integrity assessment method comprising or consisting of qualitatively and quantitatively accessing the integrity of an electoral process.

An electoral integrity assessment method comprising or consisting of qualitatively and quantitatively accessing an electoral process, wherein qualitatively accessing the integrity of an electoral process comprises analyzing an electoral process at risk of systemic manipulation.

An electoral integrity assessment method comprising or consisting of qualitatively and quantitatively accessing the integrity of an electoral process, wherein qualitatively accessing the electoral process comprises analyzing an electoral process at risk of systemic fraud.

An electoral integrity assessment method comprising or consisting of qualitatively and quantitatively accessing the integrity of an electoral process, wherein qualitatively accessing the electoral process comprises analyzing an electoral process at risk of systemic manipulation, malpractice, and fraud.

An electoral integrity assessment method comprising or consisting of accessing the integrity of an electoral process, wherein accessing the integrity of an electoral process comprises generating a quantitative vulnerability index.

An electoral integrity assessment method comprising or consisting of accessing the integrity of an electoral process, wherein the method is a computer-implemented method.

A computer-implemented electoral integrity assessment system comprising or consisting of a first tool configured to qualitatively access the integrity of an electoral process and a second tool configured for quantitatively access the electoral process.

A computer-implemented electoral integrity assessment system comprising or consisting of a first tool configured to qualitatively access an electoral process, and a second tool configured to quantitatively access the integrity of an electoral process, wherein qualitatively accessing the integrity of the electoral process comprises analyzing an electoral process at risk of systemic manipulation.

A computer-implemented integrity assessment method comprising or consisting of a first tool configured to qualitatively access the integrity of an electoral process, and a second tool configured to quantitatively access the integrity of an electoral process, wherein qualitatively accessing the integrity of the electoral process comprises analyzing an electoral process at risk of systemic malpractice.

A computer-implemented electoral integrity assessment method comprising or consisting of a first tool configured to qualitatively access the integrity of an electoral process, and a second tool configured to quantitatively access the integrity of the electoral process, wherein qualitatively accessing the integrity of the electoral process comprises analyzing an electoral process at risk of systemic fraud.

A computer-implemented electoral integrity assessment method comprising or consisting of a first tool configured to qualitatively access the integrity of an electoral process, and a second tool configured to quantitatively access the integrity of an electoral process, wherein qualitatively accessing the integrity of the electoral process comprises analyzing the integrity of an electoral process at risk of systemic manipulation, malpractice, and fraud.

A computer-implemented electoral integrity assessment method comprising or consisting of a first tool configured to qualitatively access the integrity of an electoral process, and a second tool configured to quantitatively access the integrity of the electoral process, wherein quantitatively accessing the electoral process comprises generating a quantitative vulnerability index.

An electoral integrity assessment system comprising or consisting of a first tool configured to qualitatively access the integrity of an electoral process, and a second tool configured to quantitatively access the integrity of the electoral process, wherein the method is a computer-implemented method.

A method and system for conducting an electoral integrity assessment. The information and guidelines captured will be useful for funders and technical assistance seeking to understand vulnerabilities in the electoral process and how to professionally assess the integrity of an electoral process. Based on the findings of an electoral integrity assessment, plans to ensure future integrity can be developed.

The output of the electoral integrity assessment can be a comprehensive report outlining vulnerabilities and possible impacts of electoral fraud, according to a quantitative rating system, and information on the resources and timeline required to address the main issues noted. After the report is published and received by the main stakeholders, the next steps can be for the election management body (EMB) to develop and implement a robust fraud control plan and to deploy additional tools to deter malpractice and systemic manipulation such as legal reform, training, and development and enforcement of Codes of Conduct for electoral officials.

The electoral integrity assessment seeks to report on and analyze areas of the electoral process at risk of systemic manipulation, malpractice, and fraud. The three (3) categories can be reviewed during the assessment and in the final report, the focus of the rating system and fraud control plan will be on the vulnerabilities of the election process to electoral fraud. The electoral integrity assessment will also seek to capture effective measures that have been implemented since the last election to mitigate risk, in order to focus efforts on the likely remaining threats.

### BRIEF DESCRIPTION OF DRAWINGS

FIG. 1 is a diagrammatic view of the Vulnerability scale and Intensity of Impact scale.

FIG. 2 is a diagrammatic view of the Guidelines for Assessment Team.

FIG. 3 is a diagrammatic view of the Sub-Category Ratings (with timeline and resource analysis) (Graph 1).

FIG. 4 is a diagrammatic view of the Sub-Category Ratings (with weight) (Graph 2).

FIG. 5 is a diagrammatic view of the calculations that derived the overall scores for the illustrative category.

FIG. 6 is a diagrammatic view of the Overall Malpractice Profile (Graph 3).

FIG. 7. is a diagrammatic view of the Overall Fraud Profile (Graph 4).

FIG. 8 is a diagrammatic view of the Overall Systemic Manipulation Profile (Graph 5).

FIGS. 9A-C are flow diagrams of the methodology.

FIG. 10 is a diagrammatic view of the definitions of fraud, malpractice, and systemic manipulation.

FIG. 11. is a diagrammatic view of the Rating Scale for Vulnerability and Intensity of Impact.

FIG. 12 is a diagrammatic view of Guidelines for Assessment Team.

FIG. 13 is a diagrammatic view of Fraud Profile for Afganistan.

FIG. 14 is a diagrammatic view of Factors to Consider in the Count Process.

FIG. 15 is a diagrammatic view of the Pros and Cons of Moving the Count to a Provincial Center Location.

FIG. 16 is a diagrammatic view of Malpractice Profile for Afghanistan.

FIG. 17 is a diagrammatic view of Systemic Manipulation Profile for Afghanistan.

FIG. 18 is a diagrammatic view of Recommendations for Afghanistan.

### DETAILED DESCRIPTION

The legitimacy of a given election depends in large part on the actual and perceived integrity of the electoral process. If voters and candidates believe that an election is fraudulent or has been poorly administered, they may not accept the outcome. At best, this can breed public dissatisfaction or disinterest; at worst, expensive new elections, violence, ineffective governance and long-term instability. Election managers can take a first, important step towards avoiding these outcomes by conducting an exhaustive and systematic assessment of likely vulnerabilities in the electoral process.

The purpose of this document is to outline a detailed methodology for conducting an electoral integrity assessment. The information and guidelines captured herein will be useful for funders and technical assistance providers seeking to understand vulnerabilities in the electoral process and how to professionally assess its integrity. Based on the findings of such an assessment, election managers can develop plans to improve election integrity.

The immediate output of the assessment will be a comprehensive report outlining vulnerabilities and possible impacts of systemic manipulation, malpractice, and fraud, according to a quantitative rating system, and information on the resources and timeline required to address the main issues noted. After the report has been published and received by the main stakeholders, the next steps will be for the election management body (EMB) in consultation with other stakeholders to develop and implement a robust fraud control plan and to deploy additional tools to deter malpractice and systemic manipulation (such as legal reform, training, and development and enforcement of Codes of Conduct for electoral officials).

The electoral integrity assessment seeks to report on and analyze areas of the electoral process at risk of systemic manipulation, malpractice, and fraud. These three categories are defined in the “Important Definitions” section below. The assessment will also seek to capture effective measures that have been implemented since the last election to mitigate risk, in order to focus efforts on the likely remaining threats.

The definitions below are necessary for understanding the electoral integrity assessment methodology, and should be used as appropriate during meetings and in reports and other publications related to the assessment. These are operational definitions for use in all programming relating to electoral integrity.

Electoral fraud differs from electoral malpractice along several key dimensions. The range of possible actors is wider for fraud, as it can include any person or group with a stake in the election result. This may include voters, political parties, state officials with election-related duties, candidates and the media, in addition to election workers. Malpractice, on the other hand, is solely related to election officials (permanent and ad hoc staff). The nature of the action and the presence of intent is most significant: fraud is committed deliberately and with intent to interfere with the electoral process (manifested as either an action or an omission, in the case of an actor with official election responsibilities), while malpractice results from carelessness or neglect. A poll worker who places a stack of pre-filled ballots in the ballot box on Election Day has committed fraud; that same polling worker who forgets to attach security seals to a ballot box may have breached his duty of care and committed malpractice. When developing fraud deterrence and mitigation strategies, this is an important distinction, and one that will shape strategies to ensure the integrity of elections.

The following definitions apply:

Electoral fraud: deliberate wrong-doing by election officials or other electoral stakeholders, which distorts the individual or collective will of the voters.

Electoral malpractice: the breach by an election professional of his or her relevant duty of care, resulting from carelessness or neglect.

Systemic manipulation: the use of domestic legal provisions and/or electoral rules and procedures that run counter to widely accepted democratic principles and international standards, and that purposefully distort the will of voters.

As highlighted above, fraud refers to deliberate or intentional acts perpetrated by a range of stakeholders. Malpractice, on the other hand, refers to the negligent breach of a relevant duty of care. By applying the “duty of care” concept to election professionals you are able to clearly define their professional roles and responsibilities. In short, election professionals have a professional duty to protect the integrity of the electoral process and should be held accountable for intentional (fraud) and unintentional breaches (malpractice) of this duty. More specifically, for election management professionals, the duty of care refers to the degree of skill, diligence and knowledge commonly possessed and exercised by a competent election management professional in the execution of his or her duties.

Accordingly, election commissioners appointed to the EMB based on their relevant experiences and education would be expected to perform their election duties in a manner that contributes to a credible electoral process (and does not undermine it). For example, an EMB official responsible for procurement of indelible ink must perform due diligence on the available options. If she does not, and selects an inferior ink (perhaps based solely on price) that fails on Election Day, she may have breached her relevant duty of care. A poll-worker who disregards his basic training by failing to check voters' fingers for the presence of ink before issuing a ballot paper might similarly breach the expectations for his position. In each case, the election official should be held to a duty of care that befits the training and qualifications associated with his or her role.

In short, when election professionals are negligent, they have committed malpractice, not fraud. When assessing malpractice and in designing technical assistance programs, drafters can use the duty of care concept in a nuanced way to distinguish among election workers at different levels and with varying levels of education and training, such that the commissioner of an EMB would have a much different duty of care requirement than a poll-worker appointed on an ad hoc basis and would receive different training and technical support relevant to his or her level of responsibility.

The Electoral Integrity Assessment will serve as a critical tool for election managers in their efforts to proactively combat fraud and malpractice. To that end, the methodology seeks to report on and analyze categories of the electoral process at risk of systemic manipulation, malpractice, and fraud. These three dimensions are defined above. The methodology is intended to identify vulnerabilities and potential impacts on the election process should certain types of fraud, malpractice and systemic manipulation occur. In general, most assessments will be conducted primarily during the post-election phase; that is, after sufficient time has passed following one election to take full stock of the outcome, but before full preparations have been made for the next election. The ability and capacity of stakeholders to implement assessment recommendations will, of course, be dependent on the amount of time remaining before the election.

The assessment report will incorporate two main approaches:
1) a qualitative assessment, written in narrative form, which will summarize the findings for each of the three (3) risk areas and recommend approaches for managing these vulnerabilities; and
2) a quantitative vulnerability index that provides greater visual clarity and specificity.

The assessment report will be based on a desk study and in-country research. Both the qualitative and quantitative analyses conducted during this assessment stem from the same data sources, but fulfill two complementary functions (a detailed verbal analysis and a powerful visualization of the quantified findings, respectively). Although individual “scores” will be assigned to each electoral process area, the utility of these assignments will be most evident in their relative “ranks.” The rank order will allow the EMB and its technical assistance providers to prioritize reforms to the electoral process.

Using these qualitative and quantitative assessments, a set of detailed recommendations will be developed and included in the final report to address the areas of the electoral process that are most vulnerable to systemic manipulation, malpractice and fraud. The EMB will likely be the main stakeholder to implement recommendations made for the latter two dimensions, but most cases of systemic manipulation would not be managed by election administrators (as they will frequently be issues for political bodies, such as the legislature or boundary delimitation commissions). When this is the case, the assessment team will identify the issues and suggest long-term reform efforts that could address specific systemic problems. It is important to note, however, that when an EMB does have the mandate to reduce the risk of systemic manipulation by amending its own regulations and rules, the assessment team will identify and make appropriate drafting and reform recommendations. Malpractice vulnerabilities, on the other hand, would be addressed through targeted technical assistance to the election management body in the identified areas, such as poll worker and other election official training programs, internal communications, the introduction or improvement of existing codes of conduct as well as effective enforcement of the provisions therein, and stronger supervision of ad hoc workers.

The assessment process will be divided into nine (9) distinct steps or phases:
1) Conduct desk study
2) Identify focus areas of likely vulnerabilities
3) Identify additional members of the assessment team based on specific focus areas and necessary country/regional expertise, as well as assessment timeline
4) Preparation for deployment
5) Hold relevant meetings in-country using interview/discussion guide
6) Individual experts determine vulnerability type and assign ratings for their categories
7) Team review and revision of all ratings
8) Conduct timeline and resource analysis
9) Prepare and distribute assessment report

### 1. Conduct Desk Study

Once the Team Lead (and possibly other members of the assessment team) has been identified, he or she should lead the development of a desk study that fulfills two important functions. First, the desk study research should collect the information needed to properly prepare members of the assessment team.

Second, based on this information, the desk study will preliminarily identify the potential areas of fraud, malpractice and systemic manipulation. Special attention should be aid to the way in which other observers (such as election monitors, political parties, the media, and the EMB) categorize infractions that might deviate from the IFES approach. Highlighting these discrepancies early on and consistently in the desk study will be extremely useful for the assessment process.

The desk study is an essential tool for both assessment preparation and for development of the final assessment report. The more extensive and well-organized the research at this stage, the less time will be needed to produce and distribute the final report.

Support for this effort can be provided by electoral integrity specialists and field program teams, and/or by a consultant hired for this purpose. Regardless of who is selected to gather research and draft text, the Team Lead and other senior members of the effort should guide its development. The content, format, and length of the desk study are flexible, but should include a review of recent elections, relevant legal and regulatory provisions, and general country context. It should include any previous assessments of fraud in elections or general observation reports that may highlight likely areas of systemic manipulation and malpractice. The desk study is especially essential in countries in which the focus areas for the assessment are not immediately evident. Materials collected for an assessment should be stored on Dropbox (or a similar service) for ease of access by both assessment team members and staff. Materials on Dropbox should be clearly organized in folders labeled with the categories to which the documents are most relevant (see the electoral process categories included in this guide). If documents are relevant to one or more categories, they should be included multiple times for ease of access.

### 2. Identify Focus Areas

Based on the desk study, the Team Lead and the electoral integrity team should identify the overarching categories that are most vulnerable to acts of systemic manipulation, malpractice and fraud. This decision-making process could be incorporated into the “boot camp”. These categories will be the focus during the assessment, but additional efforts to secure more detailed information regarding the identified focus areas should be pursued prior to deployment. The team should also eliminate categories that do not need to be pursued. However, the team should remain flexible, as information obtained while in the field may require significant recalibration of focus areas.

### 3. Identify Additional Members of the Assessment Team Based on Specific Focus Areas and Necessary Country/Regional Expertise, as Well as Assessment Timeline

Among the important decisions to be made during assessment planning and preparation are: What size should the team be? Who should be on the team? How long should the assessment mission be? What is the timeline for finalizing the report? In making these decisions, consider the following issues:
1) Budget. How much money do you have to spend on the assessment? Are these costs being covered by a project or from unrestricted funds? Please refer to this budget to ensure that all necessary cost categories are captured during the planning stages.
2) Time. How much time do you have to conduct the fieldwork and prepare the report? Is there pressure from policy makers, donors, or election stakeholders to finalize a report as soon as possible? Be sure to incorporate an out-brief with key stakeholders prior to departure from the assessment country, if possible.
3) Team presence/history. Does the team have an office and on-going project in country? Will the field office be providing support to and/or participating in the mission? Or, has the team worked there in the past? Does it have pre-existing institutional relationships and contacts? Could it use these intermediaries to provide support to the team? Are there talented local staff members or other personnel who can be utilized as team members? What is the team's relationship with the EMB? Will the assessment be perceived as a hostile intervention, or has the EMB requested the team's presence?
4) Profile/footprint. Is the issue of foreign/U.S. assistance to electoral processes controversial in the country? Do local sensitivities and security considerations suggest that the team should maintain a low profile? If the team needs to limit the size of its footprint, but has a lot of information to collect on the ground, consideration may be given to staggering the presence of assessment team members. Wherever the budget allows, it is strongly recommended that a mid-level member of the electoral integrity team join the in-country assessment. His or her involvement will help ensure that the final assessment report is written and finalized promptly and efficiently.
5) Existing information. How much pre-existing information is publicly available about the electoral process and enabling environment in the country? Is this information sufficiently detailed? Current? Relevant? Reliable? Is it available in the language being used by the team?
6) Required specializations. The expertise represented on the team will be dependent upon the scope of the assessment and probable assistance priorities.
7) Size of country. How large (geographically) is the country? How much ground do you need to cover? Do you need to meet stakeholders, collect information, and make site visits at a sub-national level? How much time will you need to be “on the road” getting from point A to point B?
8) Security. Are there security or other issues that may limit the team's ease of movement within the country, ability to meet with various stakeholders and collect information, and/or the pace at which activities can be undertaken? Are there security protocols that will need to be followed?
9) Sensitive material. The assessment mission will be collecting materials that could be deemed sensitive and therefore a special protocol needs to be followed in order to avoid theft, loss of sensitive material or compromise of sources.

Although the composition of assessment teams will likely vary, the following illustrative list should provide general guidance.

International assessment team:
1) Team Lead;
2) 1-4 senior subject matter experts;
3) Lead writer (if writing coordination will not be done by the Team Lead or other subject matter expert) and/or junior member, if appropriate;
4) Field program team (to provide logistical support and domestic expertise);
5) Chief of Party/Country Director;
6) Local field staff; and
7) Program team (to provide oversight, review, research, logistical support, and other tasks as necessary):
   Regional Director/Deputy Director
   Program staff
   Global Security Manager
   Other members of the electoral integrity team

### 4. Preparation for Deployment

### Training

Once experts have been selected to join the international assessment team, they should participate in a required virtual or in-person training (or “boot camp”) with the electoral integrity team. This targeted training will focus mainly on understanding the assessment methodology and expectations for the final report, as well as how to use the scoring workbook. Every assessment team will be provided logistics support from the program team, and technical support from the relevant electoral integrity point of contact.

A web-based scoring module could be incorporated into the training program. Participants would be requested to review provided primary and secondary source materials, and to independently score a series of categories according to the assessment methodology. After all team members have completed this exercise, the individual scoring profiles can be discussed as a team to ensure that scoring approaches are coordinated prior to the actual assessment. The training “boot camp” is extremely important for ensuring that each member of the team understands the methodology and his or specific responsibilities prior to deployment in the field

### Logistics

Adequate planning and preparations is essential to the success of any pre-election technical assessment mission whether standard or specialized. Certain steps in the planning and preparation process are required, including:
1) Getting travel authorization from the Mission (if required by the funding agreement);
2) Preparing scopes of work and contracts for consultants;
3) Requesting travel advances;
4) Reserving flights and purchasing tickets;
5) Preparing security and safety briefing;
6) Reserving hotels;
7) Visa procurement (depending upon the visa requirements of the country);
8) Scheduling meetings and assessing probable levels of access to needed interlocutors; and
9) Contact list.

### Terms of Reference

A Terms of Reference (ToR) Document will help to ensure that everyone on the assessment team as well as program staff supporting the team have a common frame of reference for the mission. The ToR should provide a concise (e.g. 3 to 5 pages) overview of key elements of the mission as listed below. The ToR should be developed by the program team in coordination with the Team Lead.
1) Context. Provide a brief overview of the catalyst for the assessment such as a shift in donor policy, donor or host country request, or previous fraud ridden elections. This section should also provide some details on team's history in the country (e.g., on-going team and competitor/partner programming, past programming, and engagement of EMB through regional or international networks).
2) Purpose and objectives. Clearly present the purpose of the assessment mission and the objectives to be achieved by the team.
3) Team member bios. Include short bios on each team member with an emphasis on knowledge and skills relevant to the assessment mission as well as the role each will play on the team.
4) Assessment Methodology. Introduce the electoral integrity assessment methodology as outlined herein.
5) Rules of Engagement. Provide guidance on how team members should engage various stakeholders and conduct themselves while in country this section might advise on respect for local culture, security considerations, interaction with the media, institutional relationship building, locally-owned and driven processes, political neutrality, and/or interaction with the donor and embassy. If there are certain sensitivities concerning foreign or U.S. assistance to the electoral process or regarding the focus of the assessment, these should be directly addressed with guidance on how to address local concerns.
6) Deliverables. Identify what deliverables are expected of the team (including meeting schedule, contact list, assessment report, supporting documents, prioritized list of assessment needs, draft proposal, and attendance at daily internal de-briefs, external outbriefs, and other team eetings). This listing should include deadlines for each deliverable.
7) Key Contact Information. List the phone and/or e-mail contacts for the team office and project team in country, USAID, the U.S. Embassy (and other relevant embassies if a multi-national team), hotel, translator/facilitator, driver, emergency services/medical center, taxi service.
8) Donor Acknowledgement. Be sure to acknowledge the donor that is funding the assessment mission and how the mission might fit into existing assistance projects.

Once the ToR for the team is completed, some information can be extracted into a one or two pager that could be shared with local actors with whom the team wishes to meet. This overview might include some contextual information, the purposes and objectives of the mission, team bios, the methodology, and contact information for whoever is handling the team's schedule. It should also include some background information on the team.

### Briefing Book

Inevitably, team members will conduct their own desk research prior to departure and as time permits and based on their particular area of emphasis within the team. To supplement this research, the relevant program team should assemble a briefing package to ensure that all team members have some common information about donor foreign policy and assistance priorities in the country, country context (history, politics, economics, social and cultural issues), the electoral system, and the team's involvement in the country to date (if any). In most cases, the briefing book should be stored electronically on Dropbox, along with materials saved for the desk study. As noted previously, materials on Dropbox should be clearly organized in folders labeled with the categories to which the documents are most relevant (see the electoral process categories included in this guide). If documents are relevant to one or more categories, they should be included multiple times for ease of access.

Items may include:
1) Terms of reference/scope of work;
2) Desk study;
3) Discussion/interview guide;
4) Assessment report outline;
5) Example of previous assessment report;
6) Country background notes/fact sheets;
7) Electoral analyses and observer reports (e.g., IFES, UNDP, OSCE ODIHR, the Venice Commission, OAS, the AU, International IDEA, IRI, NDI, EUEOM, International Crisis Group, and The Carter Center as well as domestic monitoring groups);
8) Electoral laws, regulations, codes of conduct, EMB manuals and organizational charts (headquarters and field/permanent staff vs. ad hoc);
9) Reports on EMB internal communication capabilities;
10) Electoral maps;
11) Crisis risk assessments;
12) News articles and reports on fraud in previous elections;
13) Democracy indices (e.g., the Economist Intelligence Unit's Democracy Index, the World Bank's Worldwide Governance Indicators, Transparency International's Corruption Perceptions Index, or Freedom House's Freedom in the World rankings);
14) Other relevant reports on fraud, corruption, and problems with security forces; and
15) Public opinion polls.

### Discussion Guide

Prior to deployment, each team member should review the questions included in the research guide for their assigned categories. The menu of questions is intended to serve as guidance to help structure discussions in a consistent and systematic way. Although the overarching categories and sub-categories should not be altered by the assessment team, there is flexibility in which questions are posed or researched (and in which categories are selected for coverage in the assessment). The provided list of questions for each category is not exhaustive, but it is fairly comprehensive. Modification of the questions is anticipated as the assessment team works to develop an interview guide that is best tailored to the nature, scope, and priorities of an assessment mission in a particular country and to the types of groups and individuals to be interviewed.

5. Hold Relevant Meetings in-Country Using Interview/Discussion Guide

Meetings should be arranged prior to arrival in-country. The mix of participants from the assessment team in each meeting will vary based on the subject matter area.

It is essential that the team be introduced properly at the beginning of each meeting, whether with existing partners or new contacts. During the introduction an emphasis should be placed on:
1) team's approach to sensitive electoral assessments. We will not make public statements about the conversations held during this assessment, nor talk to the media about our findings without a mutual determination that such an approach would be beneficial. In meetings with the EMB, note that preliminary findings will be shared with that body to provide an opportunity for feedback to be incorporated into the report.
2) team's standardized approach to the integrity assessment methodology, which is peer-reviewed and tailored to the specific needs of each country.
3) team's focus on electoral process as opposed to the political outcomes of elections, i.e. emphasis on the legal and technical aspects of elections and the protection of voting rights.
4) team's commitment to neutrality and its reputation as an honest broker among all electoral stakeholders (i.e., both official institutions and civil society and across the entire political spectrum.
5) team's reliance on comparative models and best practices and a stable of electoral scholars and practitioners from around the world (and as may be evidenced by the multi-national composition of the assessment team).
6) team's practice of using seasoned election practitioners as advisors, i.e. those who have administered elections in their own countries, understand the nature of the challenges facing their peers in the host country, and can offer appropriate solutions (and as may be evidenced by the composition of the assessment team);
7) team's previous work in the country or region (as applicable). In countries where the team may already have a presence, it may be well advised to confirm that it is officially registered and operating legally within the country;
8) team's respect for the country's sovereignty and its appreciation of cultural and social norms as well as an understanding of the political sensitivities surrounding international cooperation on electoral process;
9) team's approach to cooperation, which is based on supporting local initiative, ownership, and leadership of electoral policy reform and electoral management in line with international best practice rather than imposing external solutions.

Ideally, the team should provide a written overview of the assessment mission in advance of the meeting. The overview can be extracted from the team's Terms of Reference or Scope of Work and should include background on the team's mission and programming pillars, the purpose of the assessment and key issues to be explored, the types of electoral stakeholders with whom the team plans to meet, and brief biographies of the team members. Even if these materials are provided, a proper verbal introduction of the team should be made at the start of the meeting.

Provided that all meeting participants agree, the assessment team should consider recording interviews. This recording device should be procured by the field office or a member of the assessment team prior to deployment. This step will reduce the need for detailed note-taking during the meeting and facilitate a more focused discussion.

To the extent appropriate, assessment team members should refer to the interview/discussion questions contained in this document to guide the meeting agenda. As soon as possible following relevant meetings, team members should record their responses to the relevant questions posed in the discussion guide. This information will provide important background for the assignment and defense of category ratings, as well as for the narrative sections of the final assessment report.

Particularly if team members have been attending separate meetings, a daily de-brief should be held to discuss the day's findings, any challenges, and to ensure continued coordination of the assessment team.

Prior to departure, the assessment team should provide an in-person debriefing to the donor and the election management body that includes a brief overview of the mission, preliminary findings as appropriate, and outlines next steps and the likely timeline for the production and distribution of the assessment report.

6. Individual Experts Determine Vulnerability Type and Assign Ratings for their Categories

The first step for each expert is to determine whether each category to which he or she is assigned is most likely to have implications for systemic manipulation, malpractice or fraud. Experts should reference the definitions herein in order to make this determination. In some cases, a category may be analyzed twice (for example, training processes for election officials and poll workers may be relevant for both malpractice and fraud). Using the methodology provided in the next section, team members should then assign ratings to each of their assigned sub-categories, as well as weights to calculate the overall category rating. As noted below, the ratings should be based on international standards and the expert's analysis in relation to the country being evaluated. The total weights for all sub-categories in an individual category should equal 100%. It should be noted that weights should be allocated based on the relevance of a particular sub-category to the overall category, regardless of whether the potential impact is positive or negative or contributes to increased vulnerabilities.

Selection of systemic manipulation, malpractice, or fraud dimensions, as well as all ratings, should be inputted into the Electoral Integrity Assessment Scoring Workbook provided to all team members. This workbook will be used to derive the relevant data for the final report.

### 7. Team Review and Revision of all Ratings.

The in-country assessment schedule should include a team meeting following the conclusion of interviews and prior to debriefs with the donor or EMB. The Team Lead will arrange and chair this meeting with all team members to review ratings assigned to sub-categories and categories. The Team Lead will have primary responsibility for ensuring the accuracy/reasonableness of all ratings and to correct any that seem improper (for example, ensuring that impact ratings are calibrated to the country context and are similarly-defined across all categories). Although the time needed for the meeting will vary depending on the number of categories reviewed and the level of concurrence among team members, at least 3-4 hours should be set aside for this purpose. During the team review stage of the assessment, the team has an opportunity to calibrate scores so that the categories are appropriately ranked for prioritization

This is an essential exercise, as it ensures that each team member does not score his or her assigned categories in a vacuum. It is expected that scores may change one or more times during this process.

### 8. Conduct Timeline and Resource Analysis

In addition to the impact and vulnerability scores, when possible, the team should conduct a timeline and resource analysis that will provide guidance for the development of the fraud control plan and relevant technical assistance programs. Depending on the information available, the team can either assign a specific timeline and resources figure to each sub-category, or assess where it falls in a range. The general ranges proposed for the assessment are as follows, but may be adjusted by the team leader based on the specific country context:
1) Timeline required for implementing approaches or remedies to counter the fraud risk based on an average 5-year election cycle. The range categories are: 0-2 years; more than 2 to 3 years; more than 3 to five years (range can be adjusted for a 4-year or other election cycle as appropriate)
2) Financial resources needed to counter the fraud risk. The range categories are, in U.S. dollars: <100,000; >$100,000 to $500,000; >$500,000 to $1,000,000; >$1,000,000.

It is recommended that every EMB develops and proactively executes a comprehensive fraud and malpractice control plan with the input of all relevant stakeholders. However, when elections are less than twelve (12) months out from the conduct of the assessment, it is unlikely that a comprehensive and fully effective plan can be implemented. In these cases, the team will recommend that the EMB focus on the most pressing fraud and malpractice issues, and integrate the full control plan activity into the organization's strategic plan. The team's recommendations should also make note of any funding (whether from domestic or international resources) and technical assistance needs that must be met in order for the EMB to develop and implement the fraud and malpractice control plan. It is understood that it will not be possible in all countries or on all assessment missions to conduct the resource and timeline analysis.

### 9. Prepare and Distribute Assessment Report

The Lead Writer (or Team Lead, if there is no specific writer assigned to the team) should assign report sections, as appropriate, or gather inputs from all team members in order to complete the final assessment report. Appropriate timelines and assignments should be provided prior to the in-country assessment mission, and updated as necessary after the mission has been completed. The final report should conform as closely as possible to a report template. Consistency in the final reports for these assessments will promote standardization of the team's approach and terminology, and allow for comparability across countries or across multiple assessments over time in one country.

The report should have the following sections, at a minimum:

1) Executive summary;

2) Background;

3) Methodology;

4) Fraud narrative and vulnerability analysis;

5) Malpractice narrative and vulnerability analysis;

6) Systemic manipulation narrative and vulnerability analysis;

7) Recommendations and conclusions;

8) Annexes (including contact list/schedule)

The order of the main text, including fraud, malpractice, and systemic manipulation narratives and vulnerability analyses should be determined based on the number of categories captured in each. The section with the most categories under analysis should be discussed first.

The lead writer should also provide basic guidelines to ensure consistency of inputs. These may include word or page limits (which should be determined based on donor expectations, scope of the assessment mission, the number of issues being assessed, the size of the team, the time on the ground, and the urgency with which the report must be issued); deadlines for input and comments/reviews; and style guidelines (at a minimum, the style guide should be provided).

The lead writer will not be the sole writer; he or she will be responsible for coordinating the writing work of the team, managing deadlines, integrating submissions and ensuring they are written in a similar “voice,” and doing a final edit/review of the draft. He or she should also work with Communications to ensure the application of appropriate donor and branding and marking requirements. Timelines should take into account the necessary time needed for Programs, Communications and Executive Management Team reviews and edits; these should be established prior to the production of the final draft to ensure there are no unnecessary delays. Keep in mind that the length of the report and the extent to which it is polished and written according to the appropriate style guidelines will determine in great part the amount of time needed for review.

The team should also develop a summary briefing document of no more than twenty (20) pages that can be distributed as appropriate. This document should include excerpts from the executive summary, background and methodology sections, as well as key findings and recommendations. Prior to drafting the final report, team members should agree on standardized terms that are likely to appear frequently. For example, voter registry vs. voters list.

Participants in the pilot assessment strongly recommend that one or more team members return to the field to provide a final briefing to relevant stakeholders

The team lead should determine, in coordination with the Regional Director or Deputy Director, the appropriate distribution list for the report, and whether all or part of the document is appropriate for public consumption. In most cases, the Team Lead will submit the report to donors and other beneficiaries.

Following dissemination of the report to relevant stakeholders, members of the assessment team should provide in-person briefings, as requested, to the donor, election management body and other members of the international community.

### Vulnerability Rating Methodology

The interview/research guide developed for this effort contains a set of twenty (20) overarching categories. These categories are further divided into two (2) to six (6) sub-categories, which form the basic unit of analysis. Within the sub-categories, the assessment team can select the relevant questions for interviews and desk research, or use their own. These distinctions are important for understanding the quantitative assessment tool.

For the quantitative assessment, each sub-category will be assigned up to five (5) distinct data points, which would then feed into an overall rating for each category:
1) Vulnerability to fraud, malpractice, or systemic manipulation on a scale of 0-10.
2) Intensity of potential fraud, malpractice, or systemic manipulation impact, on a scale of 0-10.
3) Weighted importance of the sub-category relative to the overall category, out of 100%.
4) Optional: Timeline required for implementing approaches or remedies to counter the risk (based on an average five (5) year election cycle, 0-2 years; more than 2 to 3 years; more than 3 to five years (i.e. range can be adjusted for a 4-year or other election cycle as appropriate).

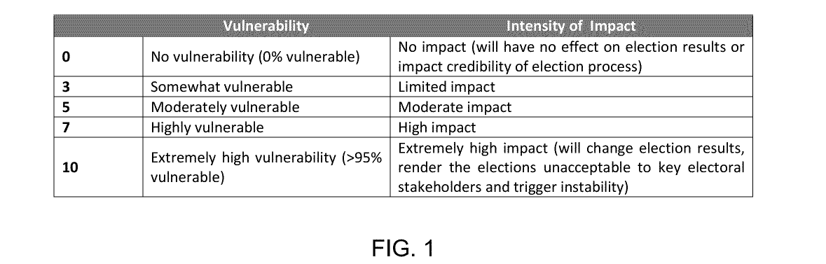

The rating used for the first two data points (vulnerability and intensity of impact) should be assigned according to the scale, as shown in FIG. 1.

The vulnerability rating will be derived from analysis of the specific electoral framework, institutions, capacity and practice in the country in question. The intensity of impact rating will be more contextual; that is, it will be based on the context in which an election will occur or the extent to which the context may exacerbate vulnerabilities in the electoral process.

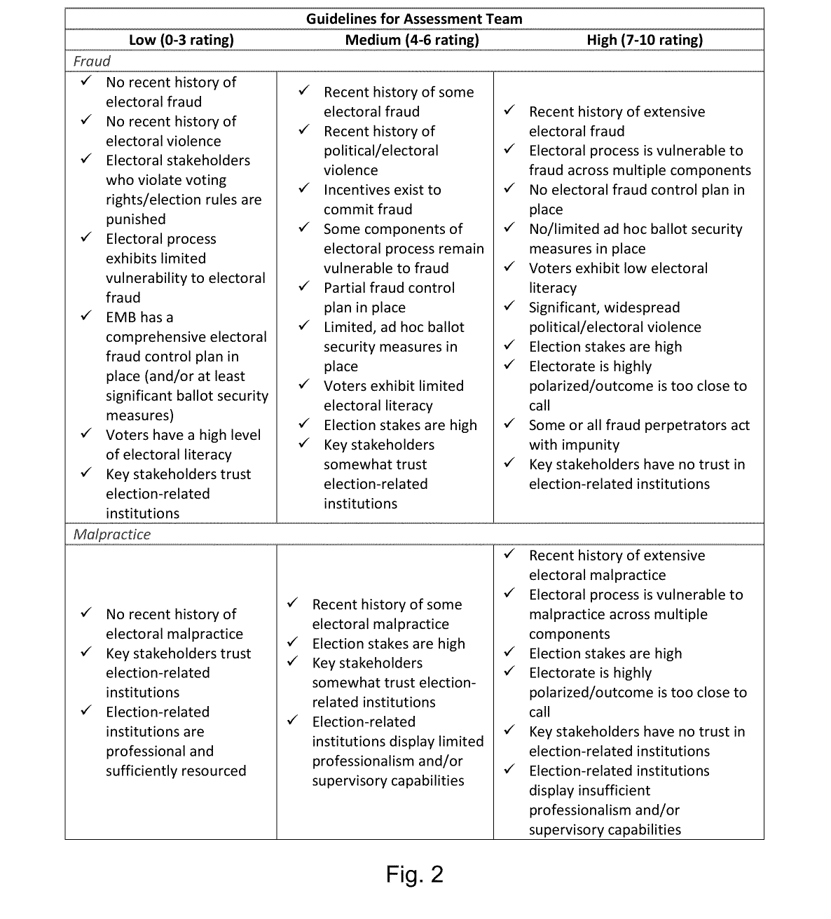

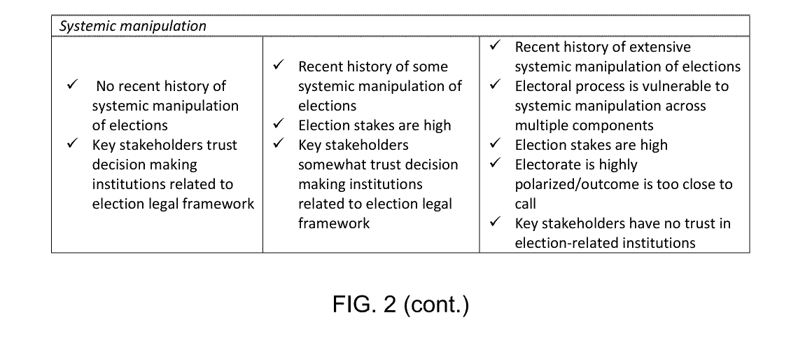

A combination of risk factors, such as the existence of incentives, impunity, and political will to commit systemic manipulation, malpractice or fraud, are generally understood to increase the potential for these issues in an election event. The assessment team considered these guidelines as context for developing the vulnerability and impact ratings, as set forth in FIG. 2.

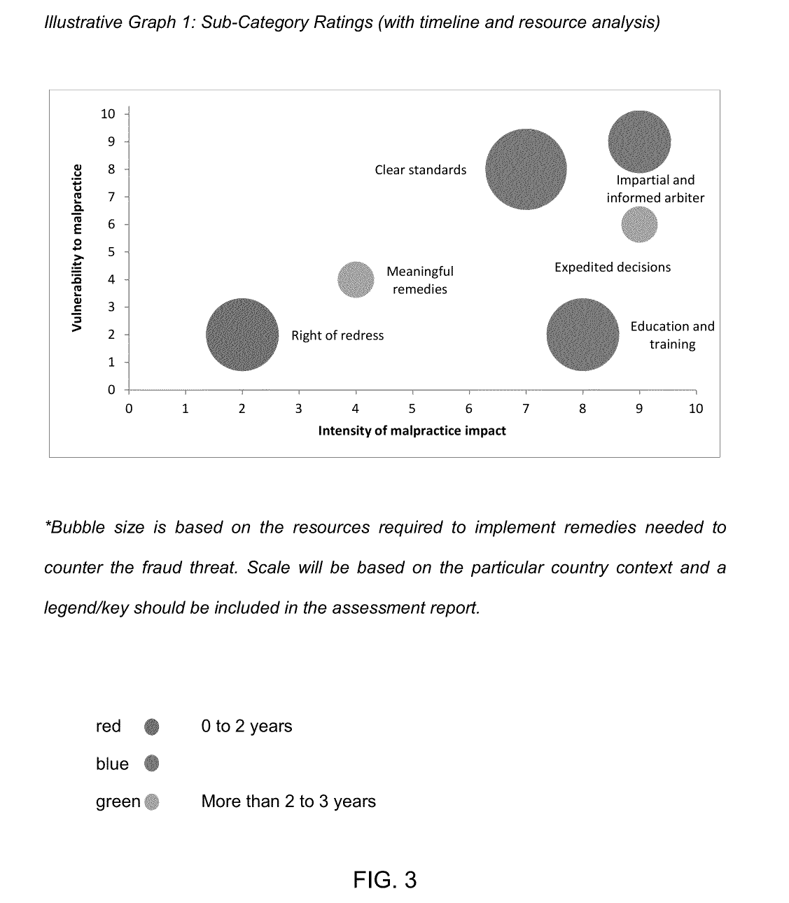

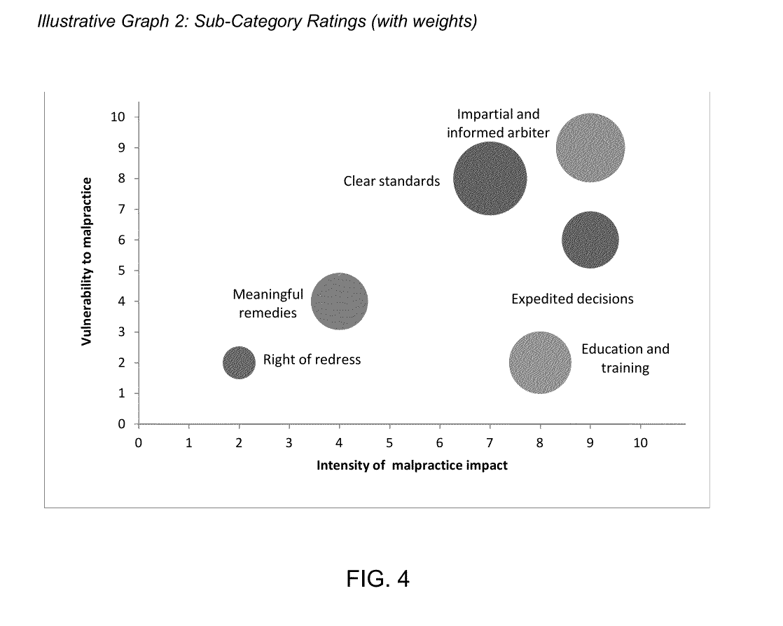

The illustrative graphs, as shown in FIG. 3 (Graph 1) and FIG. 4 (Graph 2), provide several standardized ways to show this information of the final assessment report. In this example, the overall assessment category is Adjudication of Electoral Grievances, and the 6 sub-categories are: right of redress; clear standards; impartial and informed arbiter; expedited decisions; meaningful remedies; and education and training. For illustrative purposes, this category has been assigned to the “malpractice” dimension.

In addition to these four data points, the assessment team should also assign a percentage weight to each sub-category. This weight should be based on the experts' analysis of the significance of each area to the overall category ranking, and the total weights for all sub-categories in a given category should equal 100%. The weighted category rating is derived by summing the weighted sub-category scores.

If resource and timeline analysis is not included in the assessment, the team can use this alternative graph format to display the sub-category data. The bubble size shown in FIG. 4 (Graph 2) is determined by the relative “weight” of each sub-category out of 100%.

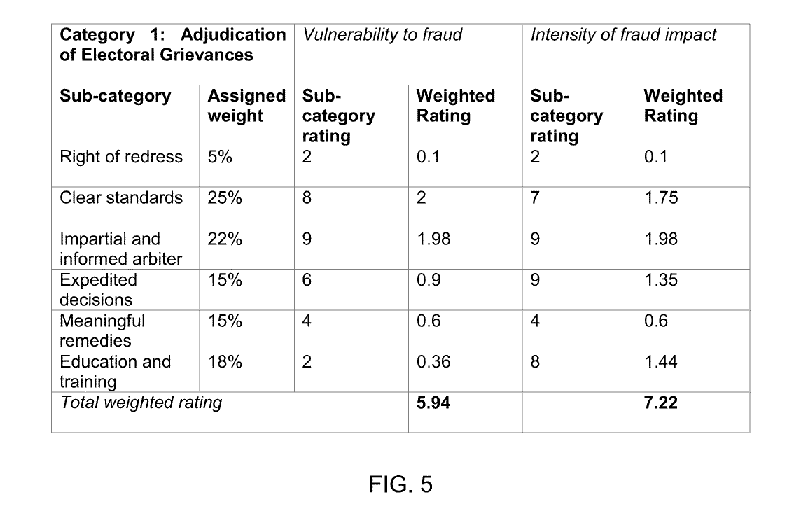

In FIG. 4 (Graph 2), the calculations derived the overall scores for the illustrative category, as shown in FIG. 5.

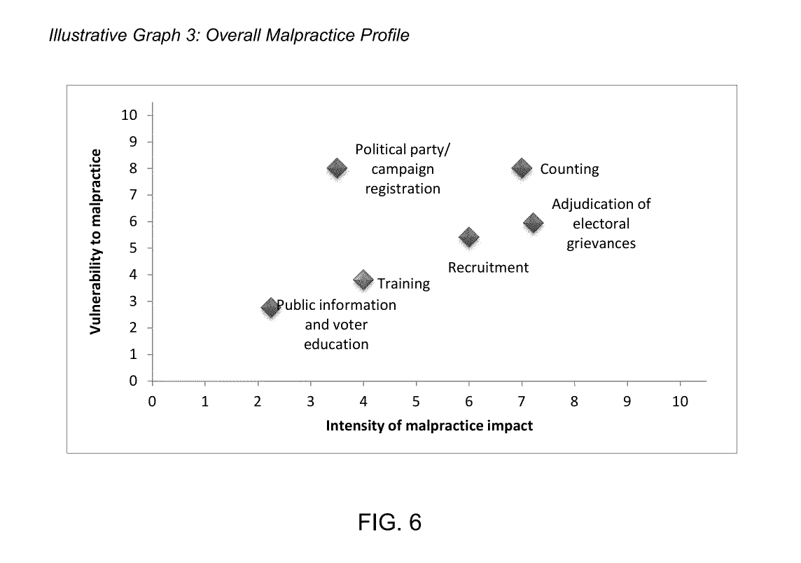

After Illustrative Graphs 1 or 2, as shown in FIG. 3 or 4, are completed for all categories, and appropriate calculations finalized as per the calculation table, as shown in FIG. 5, the weighted category ratings can be plotted on a graph as shown in FIG. 6 (Graph 3). The data points for each category are the weighted vulnerability and intensity ratings, as shown in the lower (blue) cells in FIG. 5 (for example, for Adjudication of Electoral Grievances, 7.22 and 5.94 are plotted on the x and y axes, respectively.

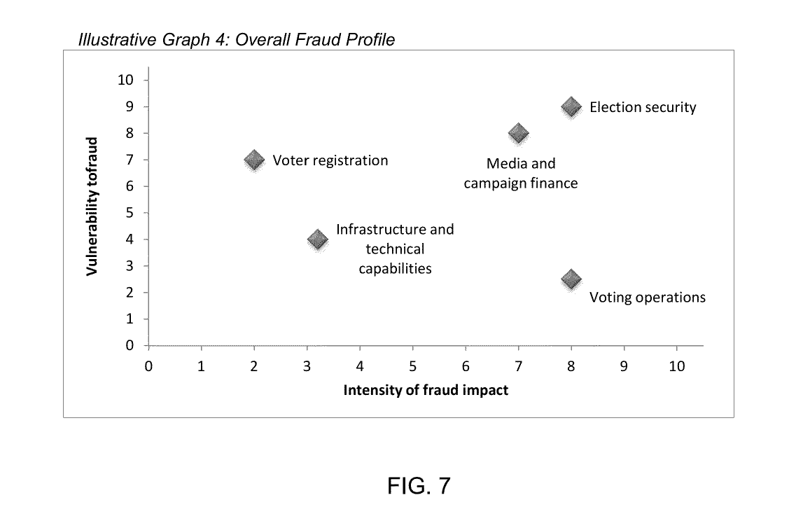

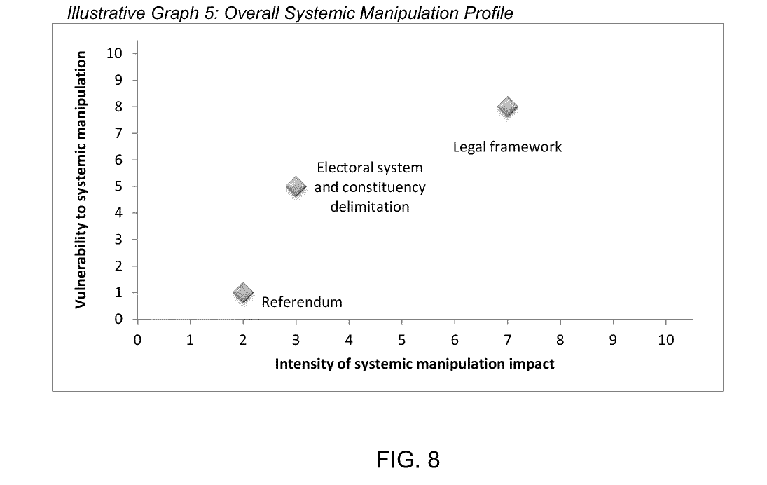

In the final assessment report, graphs similar to Illustrative Graph 1 or 2, as shown in FIGS. 3 and 4, are completed for all sub-categories (to be included in an annex or for briefings), and three (3) overall profile graphs would be generated based on the weighting calculations (systemic manipulation, malpractice and fraud). The systemic manipulation and malpractice graphs are formatted in the same manner, but would contain data for categories designated as such. Examples are shown in FIGS. 7 and 8.

### Discussion/Question Guide

The discussion/question guide is organized according to categories of the electoral process. They are further broken down into sub-categories and questions. This guide is intended to be comprehensive of the entire electoral process, and as such some questions will not be necessary for a targeted electoral integrity assessment. Answers may be based both on current circumstances and on experience during preceding electoral cycles.

For assessment purposes, the team uses the definitions of systemic manipulation, malpractice and fraud. When considering instances of fraud in past elections, team members should ensure that their analysis distinguishes between perceived and actual fraud. Perceptions of fraud have the potential to make a large impact on election credibility, regardless of the veracity of these allegations.

In tailoring this list of questions to develop an interview guide suited to the needs of a particular assessment, team members are asked to remember that that the amount of time spent with any one stakeholder/stakeholder group may be extremely limited. As such, priority will need to be given to certain questions. Not all lines of questioning will be used at every meeting. And, in cases where team members split up to focus on specific aspects of the electoral process, the mix of question to be used in will depend upon the focus of the meeting and the expertise of those involved. Team members should ensure that their analysis distinguishes between perceived and actual fraud. Perceptions of fraud have the potential to make a large impact on election credibility, regardless of the veracity of these allegations.

Information obtained during meetings should be supplemented by a review of pertinent laws, election observer reports, analyses of the country's electoral process, and available election data as well as lessons learned from a previous team (or other political and electoral process assistance providers') experience in the country. These secondary data sources may be sufficient, in some cases, to respond to some of the questions in the discussion guide.

### Referendum Process

Note: Referendum processes are assessed according to the criteria that apply to other types of election. However, in addition to those other questions, there are a number of referendum-specific issues that should be considered.

### Role of the Referendum [Vulnerability Score ______; Impact Score ______]

a. Is the legal effect of the referendum made clear in the Constitution or the law?
b. Is the referendum intended to be legally binding or is it merely consultative?
c. Is the matter at issue in the referendum one that may be decided by referendum under the Constitution and relevant legislation?

### Initiation of the Referendum [Vulnerability Score ______; Impact Score ______]

a. Does the legal Framework establish clear rules for initiating a referendum and for formulating the referendum question?
b. If the referendum was initiated by popular initiative, does the law clearly establish a time limit for collecting signatures? Was the time limit met?
c. Were voters pressured or bribed to sign the initiative petition?
d. Where the signatures on a referendum petition subject to proper scrutiny and verification?

### Referendum Question [Vulnerability Score ______; Impact Score ______]

a. How was the referendum question formulated?
b. Was the referendum question subject to review and correction by a competent authority to ensure that it is not vague or misleading?
c. Is the question vague, leading, or misleading?
d. Does the referendum question satisfy the “three unities” (unity of form, unity of content and unity of hierarchy)? That is, is the referendum asking a single, focused question rather than a question that mixes issues or types of change?

### Referendum Campaign [Vulnerability Score ______; Impact Score ______]

a. Was the legislature allowed to express a non-binding opinion on the referendum? Did it express such an opinion?
b. Were both proponents and opponents allowed to campaign freely? Were both allowed equitable access to the media to make their cases to the public?
c. Did the government take a position on the referendum? If so, did they use public funds or resources to support one side or the other?
d. Did the authorities provide voters with clear and unbiased information about the referendum to enable voters to make informed decisions?
e. Was sufficient time provided to conduct public information, voter education, and campaign activities prior to the conduct of the referendum?

### 2. Legal Framework

Note: This category focuses on the legal and regulatory framework that guides the administration of elections. In addition to questions on this issue, a review and analysis of existing laws should be undertaken.

### Structure of the Legal Framework [Vulnerability Score ______; Impact Score ______]

a. What, if any, election-related provisions are included in the Constitution?
b. What are the laws that address election-related matters?
1) Unified electoral code?
2) Law(s) on elections?
3) Law on voter registration?
4) Law on political parties?
5) Law on the electoral management body?
6) Law(s) on electoral districts or administrative boundaries?
7) Law(s) on political and/or campaign finance?
8) Law(s) on media and advertising?
9) Provisions of the administrative code (electoral violations)?
10) Provisions of the criminal code (electoral violations)?
11) Other?
   c. If there is more than one, are the election related laws consistent with each other both in terminology and in their substantive provisions?
   d. Are the election laws written in clear and unambiguous language?
   e. Do the constitution and electoral legislation together provide a complete legal framework for elections? Do they fail to address any important questions?
   f. Were all laws that address important election related matters in place/finalized at least one year in advance of elections? If no:
1) Within 10-12 months?
2) Within 7-9 months?
3) Within 4-6 months?
4) Within 1-3 months?
5) Timetable is unknown.
g. Does the law allow for subsidiary legal instruments, including implementing regulations and procedures? If so:
   1) Is the scope of the delegated rule making authority clearly defined in the law?
   2) What body is authorized to issue them?
   3) What is the procedure for doing so?
   4) How are implementing regulations and procedures communicated throughout the election administration and to other election stakeholders? Is this done in a timely manner?
      h. If the legal framework includes subsidiary legal instruments:
   1) Do they address matters that are so important that they should have been included in a law?
   2) Do they operate within the jurisdiction delegated by the law?
   3) Were they finalized and implemented in time to give election participants and the public sufficient time to inform themselves and comply, without advantaging any electoral participant(s)?
   4) Are they easily available and on a timely basis to electoral stakeholders and the public?

### Credibility of the Legal Framework [Vulnerability Score ______; Impact Score ______]

a. Based on election observation reports and interviews with election stakeholders, have provisions in the legal framework proven problematic in previous election cycles?
1) If there were problems, were these with a particular provision(s) in the legal framework or with biased or inconsistent application?
   b. Do electoral participants or the general public believe that the existing legal framework for elections (or proposed changes) benefits certain political parties/groups over others? How so?
   c. From the perspective of electoral participants and the general public, what are the priorities for electoral reform, if any?

### Electoral Law Reform Processes [Vulnerability Score ______; Impact Score ______]

a. Is an elected parliament responsible for re-writing/amending laws governing the political and electoral process?
1) If so, was the parliament elected in an election deemed to be free and fair (or meet internationally acceptable standards)?
2) Does one political party have an outright majority (i.e. can political and electoral reforms be forced through by the ruling party/ruling coalition)?
3) Will an ad hoc coalition need to be formed to pass political and electoral reform (i.e. requiring support from both ruling and opposition parties)?
4) Is there any history of vote buying/vote rigging within the parliament to pass key legislation? Was this the case with the passage of political/electoral reforms?
5) Is the parliament inclusive/representative (e.g., women and ethnic, religious, linguistic minority?)
   b. Is a specially appointed body responsible for re-writing/amending laws governing the political/electoral process:
1) Who appoints its members?
2) Is it inclusive/representative?
3) Does it operate transparently?
4) Does it operate independently?
5) How many members?
6) Is a quorum required for decision-making/voting (how many)?
   c. How does this body make decisions?
1) By decision of the chairman?
2) By decision of the leadership (chairman, deputy, secretary)?
3) By unanimous decision of the members?
4) By consensus decision of the members?
5) By open/secret vote (absolute majority, i.e. ⅔'s of members/members present)?
6) By open/secret vote (simple majority, i.e. 50%+1 of members/members present)?
7) By open/secret vote (plurality of members/members present)?
8) Is decision-making politicized?
   d. How will the public be informed about electoral reform in terms of:
1) Proposed changes to the constitutional/legal framework?
2) Process for amending the constitutional/legal framework
3) Substance of the debate over proposed changes
4) How adopted changes will affect voters and their participation in the process.
   e. Will there be a mechanism/process for public consultation and debate on electoral reforms?
1) If yes, elaborate.
2) How will public input be factored into the process of finalizing changes to the legal framework? Are there processes in place to do so?
   f. Is there a budget/funds for carrying out public information on constitutional and electoral reforms?
   g. What body is responsible for carrying out public information on constitutional and electoral reforms? How much time has been allocated for this purpose?
   h. Does the body responsible for amending the constitutional/legal framework for elections want information on comparative models and best practices?

### 3. Institutional Framework

Note: The Institutional Framework category serves several important functions for the analysis. It identifies: the institution responsible for planning and administering elections; its organizational structure and decision-making processes; interactions with other state institutions; public perceptions of the EMB's credibility. Issues related to the EMB's management of the challenges of electoral fraud, strategic, operational planning, and procurement of materials and infrastructure capacity will be considered separately in the Infrastructure and Planning category

### EMB Model [Vulnerability Score ______; Impact Score ______]

a. What body is responsible for election management? Referendum management?
1) Ministry of Interior?
2) A temporary election commission?
3) If a temporary election commission, has one been appointed yet? If not, deadline for doing so?
4) A permanent independent election commission?
5) Hybrid (EMB with Mol acting as Secretariat)?
6) Other?
   b. If an independent election commission:
1) Who is eligible to serve as a Commissioner on the commission?
2) What qualifications are required to serve on the commission?
3) Who nominates/appoints commissioners?
4) How does the nomination/appointment process work?
5) How long do commissioners serve?
6) Are their terms staggered?
7) When do the terms of the current commissioners expire?
8) How many commissioners?
9) Do they have past election management experience?
10) Are criteria for removal of commissioners established in the law? What are they?
   Organizational Structure and Staffing [Vulnerability Score ______; Impact score ______]
   a. How is the EMB structured and staffed at headquarters?
1) Is there a secretariat?
2) What are the departments within the EMB/secretariat?
3) What are the lines of communication and authority (get organizational chart if possible)?
4) How many full time staff (non-election periods/election periods)?
5) Are staff members seconded from other government agencies? Which ones?
6) Percentage of key staff positions (CEO, Deputy CEO, Heads of Department, and Provincial Election Officers) currently filled? Deadline for filling all key staff positions?
   b. How is the EMB structured?
1) How many levels of election administration and offices are there at each level? Identify each level.
2) Which are permanent/temporary?
3) Duration of terms in office of each?
4) What is the total number of election officials at each level? Poll workers?
5) How are sub-national election commissions formed (who nominates/appoints)?
6) What qualifications are required to serve on sub-national election commissions?
7) How are polling stations formed (who nominates/appoints)?
8) What qualifications are required to serve on polling stations?
9) On what basis can sub-national election officials be removed?
10) On what basis can poll workers be removed?

### Decision-Making Model [Vulnerability Score ______; Impact Score ______]

a. How does the EMB make decisions at headquarters?
1) A quorum is/is not required for decision-making/voting. How many people are required for a quorum?
2) By decision of the Chief Elections Officer or Chairperson?
3) By consensus decision of the commissioners?
4) By open/secret vote (unanimous of commissioners/commissioners present)?
5) By open/secret vote (qualified/supermajority majority, i.e., ⅔ of commissioners/commissioners present)?
6) By open/secret vote (absolute majority, i.e., 50%+1 of commissioners/commissioners present)?
7) By open/secret vote (plurality of members/members present)?
8) Unknown?
   b. Is decision-making politicized?
1) At the national/central level?
2) At the sub-national level?
   c. How do sub-national election offices/polling stations make decisions?
1) A quorum required for decision-making/voting? How many people are required for a quorum?
2) By decision of the sub-national Chairperson?
3) By consensus decision of the sub-national commissioners?
4) By open/secret vote (unanimous of commissioners/commissioners present)?
5) By open/secret vote (qualified/supermajority majority, i.e., ⅔ of commissioners/commissioners present)?
6) By open/secret vote (absolute majority, i.e., 50%+1 of commissioners/commissioners present)?
7) By open/secret vote (plurality of members/members present)?
8) Unknown?

### Reliance on State Institutions [Vulnerability Score ______; Impact Score ______]

a. What other government agencies/bodies are required to provide support to the EMB in preparations for/conduct of elections:
1) Ministry of Interior? Role?
2) Ministry of Justice? Role?
3) The Ministry of Foreign Affairs? Role?
4) The military? Role?
5) The police? Role?
6) International peacekeeping/security forces?
7) Local authorities? Role?
8) State-owned media? Role?
9) Other? Role?
   b. How is inter-governmental coordination on elections handled?
1) What are the lines of communication and authority?
2) Are there shortcomings? Elaborate.
   c. Are there examples from previous recent elections of the EMB's operations/administration of elections having been hampered by reliance on other state institutions (e.g., slow or incomplete budgetary disbursements)?

### Public Perceptions [Vulnerability Score ______; Impact Score ______]

a. Does the current EMB have sufficient credibility among key national stakeholders to conduct a genuinely democratic election?
b. Is the EMB perceived by electoral stakeholders (e.g., political parties, candidates, observer groups, media, voters) to be:
1) Independent?
2) Politically neutral?
3) Transparent (in terms of its meetings, activities, electoral preparations, decisions)?
4) Publicly accountable?
5) Professional?
   c. Is the EMB seen by stakeholders as lacking the necessary knowledge and skills to conduct elections within the current timetable/conditions?
   d. What are the key steps that need to be undertaken (benchmarks achieved) to meet the requisite standards of credibility (i.e., honest reflection of the will of the voters/outcome accepted as legitimate by domestic stakeholders and the international community)?
   e. What have been the major shortcomings of election management and administration during recent election cycles?
   f. How have international/domestic observers assessed the performance of the EMB during recent election cycles?

### 4. Election Budgeting/Funding

Note: This category covers funding sources and the relative financial independence of the EMB and legal requirements for reporting of EMB expenditures. The objective of analyzing these issues is to determine how much financial flexibility and independence the EMB has in the conduct of elections. For further information, please refer to the IFES publication “Getting to the CORE: A Global Survey on the Cost of Registration and Elections.

### EMB Funding Arrangements [Vulnerability Score ______; Impact Score ______]

a. How is election management and administration funded?
b. Does this funding arrangement ensure the financial independence of the EMB?
1) Are there concerns that electoral funding (timing and amount of funding) is used to influence EMB decisions and actions?
   c. Does the EMB develop its own budget:
1) For election periods?
2) For interim election periods?
3) Is the election budget transparent (i.e., is it a publicly accessible document)?
   d. What budget and oversight mechanisms are available in the event of unforeseen election expenses?
   e. Is the level of funding adequate to cover the operational expenses for election management and administration?
1) If not, what activities are impacted by shortfalls?
   f. Does the EMB have flexibility in its budget to move funds around between budget headings and activities? If yes:
1) What accountability and oversight is there for such changes?
   g. Does the government provide the EMB with election funding on a timely basis? Elaborate.
   h. Does the EMB provide funding to sub-national election commissions? If yes:
1) Is the level of funding adequate to cover election costs at the sub-national level?
2) And, is this funding provided on a timely basis? Elaborate.
3) Are there discrepancies in the amount and timing of electoral funding to sub-national election commissions that suggest that such decisions are based on political considerations?

### External Funding/Assistance Sources [Vulnerability Score ______; Impact Score ______]

a. Under the law, can the EMB/secretariat receive grants, commodities, and/or technical assistance from international donors/implementing organizations? If yes:
1) Are any such grants, commodities or technical assistance provided?
2) Are there any conditions placed on the delivery of such assistance/funds that may unduly influence the conduct of elections?
   b. Are there other state bodies that are required to or can be requested to provide assistance to the EMB for the purposes of conducting its duties? If yes:
1) Is this assistance provided in a timely and effective manner?
2) Do these state bodies charge the EMB for services rendered, and if so are the charges made reasonable and agreed upon by the EMB?
3) When resources are made available by other state bodies for the purpose of conducting elections are these resources under the direct control of the EMB?
4) Does the EMB have the authority to sanction staff seconded from other state bodies should they fail to conduct their duties appropriately?
5) Does the supporting state body use the power provided by this assistance role to unduly influence the work of the EMB?

### Financial Audits and Reports [Vulnerability Score ______; Impact Score ______]

a. Does the EMB prepare financial reports on its income and expenditures? Elaborate. If yes:
1) Is this information provided on a timely basis?
2) To which body are these reports sent?
3) What powers does this body have to investigate the EMB's financial reports and seek clarification and explanation from the EMB?
   b. Are EMB financial reports made publicly available? Elaborate.
   c. Does the EMB undergo regular financial audits? If yes:
1) When (e.g., annually, after electoral events)? Findings?
2) Who conducts the audit?
3) What powers does the auditing body have to call the EMB to account for its income and expenditure reporting?
5. Training and Capacity Building
   Note: This category covers the training programs provided by the EMB to permanent and ad hoc staff, including funding, mandate, assessment of training needs and types of training offered.

### Mandate and Capacity of the EMB [Vulnerability Score ______; Impact Score ______]

a. Does the EMB have a unit/section/department/center responsible for training?
b. How many staff does the EMB have whose sole responsibility is training?
c. Does the EMB have a capacity building/training plan that is integrated into its strategic plan?
d. What is the budget for training? Is there a separate budget for training?
e. Who does the actual training? The EMB or external trainers?

### Assessment of Training Needs [Vulnerability Score ______; Impact Score ______]

a. Does the EMB engage in any assessment of training needs?
b. Who is responsible for this assessment?
c. If there is a capacity building/training plan, is it based on the regular training needs assessments?
d. How much time is allocated to poll worker training prior to a specific election?

### Training Programs [Vulnerability Score ______; Impact Score ______]

a. Are there training programs for permanent staff of the EMB?
1) What are the training programs for permanent staff of the EMB?
2) Who delivers the training programs for permanent staff of the EMB?
3) Does the EMB have user-friendly and interactive training materials (manuals, video, on-line, etc.)?
4) Is the EMB training methodology interactive and adult-learning based?
   b. Does the EMB have a standardized training program for election workers?
1) Which levels of election workers get trained through the EMB training program?
2) Does the EMB have user-friendly and interactive training materials (manuals, video, on-line, etc.)?
3) Is the EMB training methodology interactive and adult-learning based?
4) How is the training program delivered?
   c. Does the EMB have training programs for other electoral stakeholders?
1) What training programs for other stakeholders does the EMB have?
2) What topics do these training programs address?
3) Does the EMB have user-friendly and interactive training materials (manuals, video, on-line, etc.)?
4) Is the EMB training methodology interactive and adult-learning based?
5) How is the training program delivered?
   d. Who is responsible for evaluating the EMB training programs?
   e. How is the effectiveness of the EMB training programs assessed?
   f. Does the EMB incorporate domestic and international observation reports into its evaluation of training programs?
1) Who is responsible for the implementation of any recommendations?
2) Is there past experience in implementing training recommendations?
6. Voter Registration
   Note: This category focuses on voter registration frameworks and processes, based on the following key principles: integrity, inclusiveness, comprehensiveness, accuracy, accessibility, transparency, security, accountability, credibility, sustainability, cost effectiveness and an informed electorate. For further information on the IFES approach to voter registration systems and processes, please review Civil and Voter Registries: Lessons Learned from Global Experiences.

### Legal Framework [Vulnerability Score ______; Impact Score ______]

To include questions regarding:
Location of the framework (constitution, laws, regulations, etc.) Complexity and completeness of the legal framework
Institutions involved

### Voter Registration Process [Vulnerability Score ______; Impact Score ______]

To include questions regarding:
The physical process and timeline
Voter documentation requirements
Accessibility of the process for distance or physical barriers
Transparency and scrutiny
Security—all data should be protected from unauthorized access or alteration and protected from loss due to user error or disaster
Accountability—all changes to the electoral roll, as well as all claims and objections must be handled according to established laws, regulations and policies; all decisions should be made publicly Credibility—the electoral roll must be compiled and maintained in a way that will create and maintain confidence of all public and political stakeholders

### Inclusiveness and Comprehensiveness of the Voter Registry [Vulnerability Score ______; Impact Score ______]

To include questions regarding:
Inclusiveness—all eligible persons should be allowed to be on the roll without regard to political preference, literacy, ethnicity, etc.
Comprehensiveness—the roll should include all eligible persons, and have a special focus on including segments of the population that are often marginalized; including women, youth, persons with disabilities, the poor, remote location, etc.

### Accuracy of the Voter Registry [Vulnerability Score ______; Impact Score ______]

Accuracy—registration data should be recorded and maintained in a way that guarantees the highest degree of accuracy possible.

### Education and Information [Vulnerability Score ______; Impact Score ______]

Informed electorate—it is a fundamental responsibility of the registration authority to make sure that eligible persons know when, where and how to ensure their information is included and that they have easy access to information about where to go to vote.

### 7. Political Party and Candidate Eligibility and Registration

Note: Registration processes, requirements and eligibility for political parties and candidates will be analyzed in this category, as well as internal rules and procedures of political parties and their impact on the electoral process.

### Registration Processes and Requirements [Vulnerability Score ______; Impact Score ______]

Please consider the processes and requirements for political parties and candidates to participate in elections, with the exception of candidate/party eligibility (which is covered specifically in the 8.2).

a. What institution is responsible for registering political parties/candidates?
1) Is this body considered independent and unbiased?
   b. What are the requirements and process to register as a political party? Candidate?
   c. Are the rules for political party/candidate registration reasonable/equitable?
   d. Are the rules for political party/candidate registration rules administered fairly/consistently?
   e. Are the rules for political party/candidate registration known and clearly understood by political parties/candidates?
   f. On what basis can political party/candidate registration be denied/revoked?
1) Can such a decision be appealed? To what body?
2) Are such cases resolved in a timely fashion and uniformly?
   g. Is the collection of signatures required for party/candidate registration?
1) How is the validity of the signatures determined?
2) Is the process for reviewing lists of signatures and the criteria for refusing a list of signatures clearly established by written rules? Consistently applied?
3) Do political parties or candidates whose registration application (or list of signatures) has been denied have the right to fix and resubmit their application for registration prior to the election?

### Candidate and Political Party Eligibility [Vulnerability Score ______; Impact Score ______]

This sub-category focuses specifically on laws, regulations and practices related to political party and candidate eligibility.
a. Are certain political parties (or types of political parties) banned from participation in elections? Elaborate.
b. Who is eligible to stand for elections?
c. Do restrictions on candidate eligibility violate international human rights or political rights commitments/obligations/standards? For example:
1) Are there medical requirements or limitations on persons with disabilities from standing for election?
2) Are there overly restrictive age limits/minimums?
3) Are requirements likely imposed in order to target specific candidates?

### Internal Functioning of Political Parties [Vulnerability Score ______; Impact Score ______]

This sub-category considers the internal rules and procedures of registered political parties, and the impact they have on the electoral process. In countries with a large number of parties, please focus on the most competitive parties and/or those that represent significant portions of the electorate.
a. Do political parties have established procedures for consultation with party members? With the electorate?
b. Do all registered political parties have regional or national presence?
1) Is this required by law?
   c. Do political parties have transparent candidate selection processes?
   d. Does the law require candidate quotas for women or other groups?
1) If yes, do political parties comply?
2) If no, do any political parties set voluntary quotas for women or other groups?
   e. What are the processes for internal elections for leadership positions in major political parties?
1) Do any major political parties have requirements or quotas to ensure a minimum number of leaders are from marginalized or disadvantaged groups (e.g., women, persons with disabilities, ethnic minorities)?
   f. What internal mechanisms, if any, are available for political party members or members of the general public to lodge complaints about political party operations or decisions?
   1. What external mechanisms, if any, are available for political party members or members of the general public to lodge complaints about political party operations or decisions?

### 8. Electoral System and Constituency Delimitation

Note: In this category, the type of system of representation and its implications for the electoral process (complexity and inclusion issues) are analyzed. Where relevant to the electoral system, constituency delimitation and districting equity are covered as well.

### Complexity [Vulnerability Score ______; Impact Score ______]

a. What is the system of representation, i.e., variations of parliamentary or presidential systems and relative powers, structure and powers of legislative authorities (one or multi chamber, national only or also sub national)?
1) Is the system of representation accepted by a broad consensus of stakeholders?
2) If not, what are the contentious issues and to which stakeholders?
3) What are the advantages and disadvantages of using the system in this country's context?
   b. What is the electoral system or electoral systems used for electing representatives (for both executive and legislative arms if relevant)
1) Is the electoral system or systems used accepted by a broad consensus of stakeholders?
2) If not, what are the contentious issues and to which stakeholders?
3) What are the advantages and disadvantages of using the electoral system or systems in this country's context?
   c. Have the rules of the electoral system for determining representatives been strictly followed in past elections?
1) If not, in what manner, and by which stakeholders, have they been breached and to what effect?
   d. Are the rules for transforming votes into representatives clear, consistent, and unambiguous? If not:
1) On what issues do the rules lack clarity?
2) What are the potential impacts on representation of error in interpreting the rules?
   e. Are the basic elements of the electoral system(s) sufficiently simple to be understandable to the country's political participants, voters, observers and media?
   Critical basic elements of the electoral system(s) include:
1) Manner of validly marking a ballot(s) or using an electronic voting device
2) Relationships of multiple elections or electoral systems
3) Formulae by which votes are translated into seats
4) System determined rules such as candidacy or representation quotas or other special considerations for specified societal groups, compensatory seat mechanisms and thresholds
   f. Is the implementation of the electoral system(s) rules, including application of electoral formulae, transparent? If not, which aspects are not transparent?
   g. Are electoral stakeholders sufficiently well-trained and informed about the electoral system(s) to implement their roles accurately and effectively? If not, on what issues and to what potential impact? For example:
1) Are electoral stakeholders, particularly voters, political parties, observers and the media sufficiently well educated about the operation of the electoral system(s) to be able to understand how winning representatives have been determined using the votes casts?

### Inclusiveness [Vulnerability Score ______; Impact Score ______]

a. Is the system of representation perceived to benefit certain political parties or societal groups over others? If so,
1) By which electoral stakeholders?
2) In what ways?
3) With what evidence from past experience?
   b. Does the electoral system(s), either by design or in practice, promote intra-party and/or inter-party inclusiveness in representation?
1) By what means and to what effect?
   c. Does the electoral system(s) make any specific provision for gender representation, such as by means of candidacy or representational quotas, or compensatory or reserved seats? If yes,
1) By what means and to what effect?
2) Is there any relationship between male/female populations and gender representation?
3) Has there been any dissatisfaction with such arrangements and to what effect?
4) Have there been past attempts to manipulate such arrangements for the benefit of particular political parties or societal groups?
   d. Does the electoral system(s) make any specific provision for minority representation, such as by means of candidacy or representational quotas, or compensatory or reserved seats? If yes,
1) By what means and to what effect?
2) For which societal groups are special provisions made—geographic areas (e.g. remote or abroad), religious, ethnic, cultural, caste groups?
3) Is there any relationship between minority populations and minority representation?
4) Has there been any dissatisfaction with such arrangements and to what effect?
5) Have there been past attempts to manipulate such arrangements for the benefit of particular political parties or societal groups?
   e. Is there a mechanism for redress of:
1) Imbalances in the electoral system(s)/formulae that exclude or negatively affect representation? If there is such a mechanism, has it been used, by which stakeholders and with what results?
2) Any attempts to subvert the rules of the electoral system(s) in determining representation? If there is such a mechanism, has it been used, by which stakeholders and with what results?
   f. Do electoral stakeholders believe that electoral boundaries have been gerrymandered, i.e. intentionally drawn in favor of a specific party or candidate(s) winning in an electoral district? If there are such perceptions:
1) Which electoral stakeholders have these perceptions?
2) Is there evidence to support the perceptions?
3) If there is such evidence, to what extent has the alleged gerrymandering affected election results?

### Districting Equity [Vulnerability Score ______; Impact Score ______]

a. Is there broad support from political parties and other stakeholders of the current electoral boundaries and the methods by which they are determined?
1) If not, what are the issues in dispute?
2) Do the existing electoral district boundaries favor, or are they perceived to favor, any particular party?
   b. Do electoral district boundaries follow existing administrative boundaries or are they specifically determined?
   c. If electoral district boundaries follow existing administrative boundaries:
1) Which administrative boundaries are followed and can they be manipulated to affect electoral districts and representation?
2) How is representation within these electoral boundaries determined?
3) Has the combination of electoral boundaries and the electoral system(s) used resulted in distortions in electoral representation, and if so in what manner and to what effect? Are there any measures in place to mitigate this?
   d. In relation to the framework for specific determination of electoral district boundaries:
1) What criteria are used to determine district boundaries and populations of electoral districts—e.g. populations, geographic or other characteristics, communities of interest?
2) What weights are the specified criteria each given in the constituency delimitation process?
3) What allowances for variations in the populations of electoral districts is allowable, and how does this affect the application of the one person-one vote principle?
4) What population data is used for electoral districting?
5) Is it appropriate and sufficiently current, accurate and complete?
6) If not, what are the deficiencies and how do these affect representation?
7) What demographic building blocks, if any, are used for determining electoral district boundaries?
8) How appropriate are these and can their use be manipulated for political interests?
9) Are there any triggers for review of electoral district boundaries—such as time elapsed since the last determination of boundaries or changes in demographics?
10) If so, are they clearly defined, appropriate to the country's environment, are these triggers and are they consistently applied?
11) When was the last delimitation process undertaken?
   e. In relation to the processes for specific determination of electoral district boundaries
1) What, if any, timetable is mandatory, or usual, for determination of electoral district boundaries?
2) Is there any cut off point prior to announcement of an election or election day after which electoral district boundaries cannot be altered?
3) If so, what is it and how appropriate is it?
4) Which body is responsible for determining electoral district boundaries, how is it appointed?
5) What are the qualifications for membership?
6) What are its powers, functions, term of office, funding and staffing sources and protections from dismissal?
7) Is determination of electoral district boundaries independent of the government and legislature?
8) If not what is the relationship between the executive and the legislature and the determination of electoral district boundaries?
9) Does the judiciary have a role, other than as an appellate body, in the electoral boundary determination?
10) What is the relationship of the EMB to electoral district boundary determination?
11) To what extent are political parties and societal groups generally satisfied with the work of the body that determines electoral district boundaries?
12) What are the administrative procedures for electoral districting? Are these regarded as acceptable by a broad range of stakeholders
13) Is sufficient notice of districting provided to interested parties?
   f. Is there any provision in the districting process for public or private hearings, public or private submissions and which stakeholders, groups or persons have standing to make submissions or give evidence at these?
1) How effectively have any such provisions been used by stakeholders?
   g. Is the electoral districting process accessible to stakeholders, for example through:
1) Public meetings of the relevant body?
2) Public availability of any submissions or advice to the body?
3) Availability of members of the responsible body for public questioning?
4) Public dissemination of districting decisions and reasons?
5) Public dissemination of district maps, descriptions, data?
   h. Does the body responsible for electoral districting make public a draft report for comment before issuing a final report?
   i. Does the body responsible for electoral districting make public a final report with explanations for districting decisions?
   j. Are there any organizations monitoring the districting process?
   k. Are the media and other potential observers of the districting process sufficiently knowledgeable of districting processes to provide informed public comment?
   l. Has any training been provided to key stakeholders such as political parties and the media on the electoral districting process?
   m. Can a determination of electoral district boundaries be challenged or appealed? If yes:
1) Which organizations and/or persons have standing to bring such a case?
2) Which authority determines such a case?
3) Is any further review of this authority's decision available? What is the final authority?
4) Are the rules for such challenges regarded by stakeholders as acceptable, for example—in relation to issues such as standing, deadlines, consistency of process, allowable evidence, and clarity of procedures?
5) Are the procedures for challenging electoral boundary determination known and understood by electoral stakeholders?
   n. Have there been challenges/appeals against electoral boundary determinations?
1) What have been their outcomes?
2) How satisfied have stakeholders in general been with the results?
9. Media and Campaign Finance
   Note: This category analyzes two specific campaign-related issues (policies and practices related to media coverage of elections and campaign finance expenditures and reporting requirements). Media training and public information are covered separately in the next category. For the campaign finance sub-category, vote buying is defined as “a form of political swindling that is intended to increase the number of votes a particular candidate or political party receives in an election by providing money or other benefits to constituents in exchange for their vote.”

### Media Policies [Vulnerability Score ______; Impact Score ______]

a. Do state media outlets predominate?
1) Does state media editorial policy favor the ruling political party/coalition?
2) Does state media news coverage and information programming favor the ruling political party/coalition?
3) Do state media advertising rates/practices or production fees/practices favor the ruling political party/coalition?
   b. Do private media editorial policies favor certain political parties/coalitions?
1) Do private media news coverage and information programming favor certain political parties/coalitions?
2) Do private media advertising rates/practices favor certain political parties/coalitions?
   c. Are there rules governing news coverage of electoral campaigns in state and private media?
1) Are these rules consistently applied?
   d. Are there rules governing paid political advertising in state and private media?
1) Are these rules consistently applied?
   e. What body is responsible for media regulation during elections?
1) Does this body have the political will to enforce media and elections rules equitably/consistently?
2) Does this body have adequate resources to perform its regulatory/enforcement role?
3) Does this body have adequate expertise and capacity to perform its regulatory/enforcement role?
   f. What body is responsible for adjudicating complaints related to media and elections (if not the regulator)?
1) Are they independent?
2) Are they politically neutral?
3) Are their decisions timely?
4) Are their decisions enforced?
   g. Are there any groups undertaking media monitoring?
1) Identify these groups.
2) What are their findings?
3) Are these findings reported to the public? Get copies for current/recent elections.
   h. Does the law forbid threats and intimidation directed at journalists?
1) Do electoral contestants comply with the law?
2) If not, scope of abuse?
3) Is the law enforced? Consistently? Obstacles to enforcement?
   i. Does the law forbid payments or other incentives in exchange for news coverage by journalists?
1) Do electoral contestants comply with the law?
2) If not, scope of abuse?
3) Is the law enforced? Consistently? Obstacles to enforcement?
   j. What is the media environment?
1) What are the most trusted sources of information? Differences among demographic use?
2) Which electronic media outlets have the greatest broadcasting range?
3) Which electronic media outlets have the greatest market share/audience reach?
4) What is the penetration of various electronic media in the country?
   4a) Television?
   4b) Radio?
   4c) Internet? Also Facebook/other social networking site penetration?Differences by demographic group?
   4d) Mobile phones? Smart phones? Difference by demographic group?
5) What time slots or programs are most popular generally and with different demographic groups? (identify television and radio)
6) Are there regional/local stations or programs that are particularly popular?
7) Are there minority language stations/programs?
8) How reliable is power supply throughout the country. Is this an issue in certain parts of the country?
9) Which print outlets have the greatest circulation?
10) Are state media obligated under the law to provide free airtime for EMB public information and voter education PSAs? Private media?
11) Is censorship an issue?
   11a) In television/radio?
   11b) On the Internet?
   11c) In print media?

### Campaign Contributions and Expenditures [Vulnerability Score ______; Impact Score ______]

a. Does the law place limits on the source of campaign contributions? Elaborate. Also, does this include in-kind contributions?
1) Do electoral contestants comply with the law?
2) If not, scope of abuse?
   b. Does the law place limits on the amount of campaign finance contributions? Elaborate. Do electoral contestants comply with the law?
1) If not, scope of abuse?
   c. Does the law place restrictions on certain types of election expenditures? Elaborate?
1) Do electoral contestants comply with the law?
2) If not, scope of abuse?
   d. Must campaign funds be placed in specially designated accounts?
   e. Does the law require reporting of campaign finance contributions prior to the election?
1) If yes, according to what timetable?
2) And, are these reports made publicly available? Online?
   f. Does the law require reporting of campaign finance contributions and expenditures following the election?
1) If yes, according to what timetable?
2) And, are these reports made publicly available? Online?
   g. What body is responsible for carrying out oversight of campaign finance?
1) Does this body have the political will to enforce campaign finance rules equitably/consistently?
2) Does this body have adequate resources to perform its regulatory/enforcement role?
3) Does this body have adequate expertise and capacity to perform its regulatory/enforcement role?
4) Does this body enforce laws/regulations consistently?
   h. Is the media or civil society monitoring campaign finance?
1) Yes, but only during elections.
2) Yes for the whole election cycle.
3) Findings? Get copy of report(s).
   i. Does the law forbid the use of state (or “administrative”) resources for campaign purposes?
1) Does the Government comply?
2) If not, scope of abuse?
3) Is the law enforced? Consistently? Obstacles to enforcement?
   j. Does the law forbid vote-buying and other forms of inducements to voters in exchange for their votes?
1) Do electoral contestants comply with the law?
2) If not, scope of abuse?
   k. Does the law forbid bribes to election officials and poll workers?
1) Do electoral contestants comply with the law?
1a) If not, scope of abuse?
2) Is the law enforced? Consistently? Obstacles to enforcement?
3) Bribe reporting mechanism in place and structure in place to handle bribe reports?
   l. Is there an Anti-Corruption Commission (or similar) in place? If so:
1) Does this body monitor and prosecute the abuse of administrative resources?
   1a) If so, have there been successful prosecutions?
2) Is this body properly resourced and trained?

### 9. Public Information and Voter Education

Note: The purpose of this category is to collect information on EMB mandate and capacity to conduct voter information and education campaigns and to develop relevant messaging. This category will also analyze voter education efforts conducted by non-EMB stakeholders, such as civil society, political parties and the media.

### Mandate and Capacity of EMB [Vulnerability Score ______; Impact Score ______]

a. Does the EMB have a voter education unit? If not—which unit is responsible for voter education?
1) Mandate?
2) Tasks/responsibilities?
3) Capacities?
4) Resources?
   b. Does the EMB have a formal voter education strategy/plan in place?
1) Is it being implemented as planned?
2) Did EMB receive outside technical assistance in developing the strategy?
3) Does it address identified needs for voter education and information?
   c. If the EMB has its own website:
1) What type of content appears on the site?
2) How often is the site updated?
3) How interactive is the site?
4) Does the public information/press office monitor traffic on and use of the site?
   d. Does the EMB/secretariat have a designated spokesperson/press secretary?
   e. Does the EMB/secretariat have a public information/press office?
1) Mandate?
2) Capacities (e.g., public info, traditional media, new media)?
3) Tasks/responsibilities (e.g., write press releases, organize press conferences, schedule interviews and media appearances, write talking points or speeches, issue press credentials, and conduct media training/coaching)?
4) Resources?
   f. Does the EMB public information/press office hold regular press conferences? Schedule?
   g. Does the EMB have a formal communications strategy/plan in place?
1) Does this cover internal communications within the election administration?
2) Does this cover external communications?
   h. Do EMB commissioners and key personnel actively provide interviews and participate in news and information programs? Do EMB commissioners and other designated spokespersons speak with one voice; i.e., deliver consistent messaging?

### EMB Voter Information and Education [Vulnerability Score ______; Impact Score ______]

a. How does the EMB learn about needs for voter education and information?
1) Conduct survey?
2) Use other available surveys/polls?
3) Focus groups?
4) Analyses of previous election cycles (e.g., done by the EMB or election observer groups)?
5) Through their sub-offices?
6) Call-in center?
7) Does it include measuring confidence in the electoral process?
   b. Does the EMB conduct (or procure independent) evaluations of the effectiveness of its voter education efforts or utilize other organizations' studies/reviews? If yes, findings?
   c. What forms of media and social networking does EMB use to get its message out?
1) Print media (e.g., newspapers and other periodicals)?
2) Television?
3) Radio?
4) Mobile devices (e.g., SMS and downloads for smart phones or other handheld devices such as tablets and readers)?
5) The Internet? Mailing lists?
6) Via EMB website?
7) Via EMB Facebook page?
8) Via other social networking sites? Identify by name?
9) Through special events? Elaborate.
   d. What types of voter education products does the EMB produce?
1) PSAs or educational programs for television?
2) PSAs for radio?
3) Special programming for television/radio?
4) PSAs for YouTube (or other social networking sites)?
5) Notices or inserts to appear in newspapers?
6) Posters, billboards, and/or banners?
7) Flyers, brochures, booklets?
8) Collateral materials (caps, t-shirts, stickers, coasters, pens, cups, pins, calendars, etc.)?
   e. What media/communications channels does the EMB use to get feedback from voters and other electoral stakeholders:
1) EMB website?
2) EMB Facebook page?
3) SMS?
4) Call in centers?
5) Direct contacts/meetings?
6) Through EMB sub-offices?
7) Other?
   f. How adept is the EMB at integrating new media and social networking into their public information efforts?
   g. Are the EMBs voter education materials posted:
1) On its website?
2) On its Facebook page?
3) Public places?
4) Polling sites?
5) Other sites? Elaborate.
   h. As part of its voter education efforts, does the EMB engage in public information/voter education activities that public confidence in the integrity of the electoral process?
1) Electoral reforms specifically intended to increase election integrity/deter electoral fraud? At what level:
   1a) Legal and regulatory level?
   1b) Institutional and structural level?
   1c) Procedural and operational level?
2) Efforts to improve the accuracy of the Voters' List?
3) Redistricting (i.e., constituency delimitation)?
4) Training, professional development, and capacity building activities to improve the knowledge and skills of election workers to prevent malpractice and deter fraud?
5) The procurement of election materials and supplies that deter or mitigate fraud (e.g. secure ballot printing and paper stock, tamper resistant ballot boxes and seals, tamper resistant bags for transferring ballots and sensitive materials, indelible ink, etc.)
6) The introduction of automated processes and new technologies that deter, mitigate, or flag fraud?
7) Arrangements to secure the transfer and storage of ballots and sensitive election materials?
8) Polling place procedures specifically directed at preventing malpractice and deterring fraud?
9) Anti-fraud procedures for special voting services (e.g. postal voting, early voting, mobile voting, OCV, etc.)?
10) Steps to reduce malpractice or fraud during the counting, aggregation, and results reporting processes?
11) Electoral oversight by international election observers, domestic monitors, and the media?
12) Improved capacity to investigate allegations/evidence of electoral malpractice or fraud?
13) Improved election adjudication mechanisms, processes, and procedures?
14) Make external stakeholders aware of a stringent Code of Conduct for all EMB personnel, be it permanent staff of ad hoc workers?
15) Promote a fraud/abuse hotline/website/SMS reporting campaign?
   i. Is there collaboration or coordination between the EMB and stakeholders (NGOs, political parties, media) on voter information and education activities? If yes:
1) Is the EMB taking lead in developing priority voter education messages and determining priority target groups?
2) Are the EMB-developed messages used by stakeholders engaged in voter education/information?
   j. What are priority messages/types of information that need to be conveyed to voters for the upcoming election? Elaborate.
1) Are there changes to the election process this time around that will impact voters and that need to be explained to them? Elaborate.
2) During recent elections, on what issues or procedures did voters seem most ill-informed or confused? Is EMB addressing those issues?

### Voter Education by Other Stakeholders [Vulnerability Score ______; Impact Score ______]

a. Are NGOs carrying out voter education efforts? If yes,
1) What is their capacity?
2) What are their resources?
3) Donors?
4) What is their reach?
5) What media are they using?
6) What groups are they targeting?
7) What issues are they addressing?
8) Where are they getting their information? Is it accurate? Timely?
   b. How adept are NGOs at integrating new media and social networking into:
1) Public information efforts?
2) Voter education strategies?
   c. What forms of media and social networking do NGOs use to get messages out?
1) Print media (e.g. newspapers and other periodicals)?
2) Television?
3) Radio?
4) Mobile devices (e.g. SMS and downloads for smart phones or other handheld devices such as tablets and readers)?
5) The Internet?
6) Via NGO website?
7) Via NGO Facebook page?
8) Via other social networking sites? Identify by name?
9) Via web-based advertising
10) Through special events? Elaborate.
11) Via direct contact programs; e.g., door to door?
   d. What media/communications channels does the NGO use to get feedback from voters and other electoral stakeholders?
1) NGO website
2) NGO Facebook page
3) SMS
4) Call in centers
5) Direct contact
6) Membership network
7) Through other activities
8) Other?
   e. If the NGO has its own website:
1) What type of content appears on the site?
2) How often is the site updated?
3) How interactive is the site?
4) How useful is the information on their web site?
5) Do they monitor traffic on and use of the site?
   f. What types of voter education products does the NGO produce?
1) PSAs for television
2) PSAs for radio
3) PSAs for YouTube (or other social networking sites)
4) Notices or inserts to appear in newspapers
5) Posters, billboards, and/or banners
6) Flyers, brochures, booklets
7) Collateral materials (caps, t-shirts, stickers, coasters, pens, cups, pins, calendars, etc.)
   g. Do political parties carry out their own voter education and information campaigns?
1) What is their capacity for voter education?
2) What resources they engage in voter education?
3) What issues are they addressing?
4) Are they in contact with the EMB?
5) Where are they getting their information? Is it accurate? Timely?
6) What is their reach?
7) What media are they using?
8) What groups are they targeting?
   h. Is the media conducting its own voter information and education campaign? If yes:
1) Is it coordinated with EMB?
2) Is it accurate? Timely? General or focused on a particular issue or target group?
3) Resources allocated for the campaign?
4) Is it donor driven?

### Education of Vulnerable Voting Groups [Vulnerability Score ______; Impact Score ______]

a. Are certain voting groups particularly ill-informed of confused about their voting rights/election process?
1) Young and first time voters?
2) Women?
3) Ethnic, religious, or linguistic minorities?
4) Illiterate/semi-literate groups?
5) Rural and remote voters?
6) Poor voters?
7) Voters with disabilities?
8) Voters serving in the military?
9) Voters in institutions (e.g., prisons, hospitals, or other treatment facilities)?
10) Elderly/homebound voters?
11) Voters abroad?
   b. Based on recent elections, is there any indication that certain groups have been particularly vulnerable to violations of their voting rights or to electoral fraud? That electoral stakeholders have targeted certain groups in order to perpetrate electoral fraud?
1) Young and first time voters?
2) Women?
3) Ethnic, religious, or linguistic minorities?
4) Illiterate/semi-literate groups?
5) Rural and remote voters?
6) Poor voters?
7) Voters with disabilities?
8) Voters serving in the military?
9) Voters in institutions (e.g., prisons, hospitals, or other treatment facilities)?
10) Elderly/homebound voters?
11) Voters abroad?
   c. Are voter education messages targeted at the general electorate only? Or, are they also targeted at certain groups:
1) General electorate only.
2) Young and first time voters?
3) Women?
4) Ethnic, religious, or linguistic minorities?
5) Illiterate/semi-literate groups?
6) Rural and remote voters?
7) Poor voters?
8) Voters with disabilities?
9) Voters serving in the military?
10) Voters in institutions (e.g., prisons, hospitals, or other treatment facilities)?
11) Elderly/homebound voters?
12) Voters abroad?
11. Infrastructure and Planning
   Note: This category focuses on the capacity of the EMB to plan for and execute its mandate at the headquarters and field levels. It addresses organizational integrity (which includes codes of conduct, gifts and benefits policies, performance management, financial management, procurement and asset management, whistleblowing and internal investigations), operational and fraud mitigation planning, and infrastructure capacity. When considering operational planning, please do not limit analysis to logistics; it should include activities for the full election process, roles of responsible staff members, and resources dedicated for those activities.

### Organizational Integrity

a. Are commissioners required to sign a code of conduct? If possible, request a copy. If yes:
1) Are follow-up measures in place to track whether the code of conduct is followed?
2) Do internal stakeholders believe that the code of conduct is respected?
3) Have any commissioners been accused of violating the code of conduct? Investigated and sanctioned?
   b. Are other permanent staff members required to sign a code of conduct? If possible, request a copy. If yes:
1) Are follow-up measures in place to track whether the code of conduct is followed?
2) Do internal stakeholders believe that the code of conduct is respected?
3) Have any permanent staff members been accused of violating the code of conduct? Investigated and sanctioned?
   c. Are ad hoc staff members required to sign a code of conduct? If possible, request a copy. If yes:
1) Are follow-up measures in place to track whether the code of conduct is followed?
2) Do internal stakeholders believe that the code of conduct is respected?
3) Have any ad hoc staff members been accused of violating the code of conduct? Investigated and sanctioned?
   d. Does the EMB have a written gifts and benefits policy in place? If possible, request a copy. If yes:
1) Do internal stakeholders believe that the policy is respected and applied?
2) Have any commissioners or staff been accused of violating the gifts and benefits policy? Investigated and sanctioned?
   e. Does the EMB have sufficient professional staff to fulfill its legal mandate at its headquarters?
   f. Does the EMB have sufficient professional staff to fulfill its legal mandate in the field?
   g. Does the EMB have a written performance management policy in place? If possible, request a copy. If yes:
1) Do internal stakeholders believe that the policy is respected and applied?
2) Do staff members feel they have adequate training and other opportunities to meet the performance management requirements?
   h. Does the EMB have a written financial management policy (covering accounting rules and procedures) in place? If possible, request a copy. If yes:
1) Do internal stakeholders believe that the policy is respected and applied?
2) Do staff members feel they have adequate training to meet the financial management requirements?
3) Are there strong incentives for following the policy? Are there disincentives/sanctions in place to reinforce good practices?
   i. Are there clear, written procurement rules and regulations that the EMB must follow when procuring goods and services? If yes:
1) Do they provide for transparent, competitive, and accountable procurement practices?
2) Are there strong incentives for following the policy? Are there disincentives/sanctions in place to reinforce good practices?
   j. Are the more sensitive procurement decisions made according to clear and objective criteria (e.g., procurement of voter registration materials, ballots, ink, tamper evident bags, printing of voter registration cards, ID-cards, ballot boxes and security seals, official stamps, printing of election results forms, election results system-related communication and transmission equipment, sensitive software development tasks)? If not:
1) Are there concerns that inappropriate procurement decisions have been made by the EMB?
2) Are there concerns that any such inappropriate decisions have adversely affected the integrity of past elections? Directly or indirectly negatively affected a party/candidate? Directly or indirectly positively impacted a party/candidate?
   k. Does the EMB use an asset management system so that all sensitive equipment and assets are logged on receipt and the location of deployment is recorded? Specifically:
1) Voter registration forms and kits
2) Results forms
3) Ballot papers
4) Ballot boxes and security seals
5) Tamper evident bags
6) Ink
7) Official stamps
8) ICT equipment of relevance to managing and accessing sensitive systems (e.g., the voter registration database or election results system and database)
   l. How frequently is an inventory check of sensitive assets and equipment conducted?
   m. During the last inventory check were any significant assets and equipment unaccounted for? Elaborate.
   n. Does the EMB have a written whistleblowing policy in place? If possible, request a copy.
1) Do staff members believe that clear guidelines exist for reporting corrupt or unethical behavior?
2) Do staff members feel comfortable reporting corrupt or unethical behavior?
3) Are there incentives for staff members to report corrupt or ethical behavior?
   o. In recent election cycles, have commissioners/staff been formally accused of electoral malpractice? Administratively sanctioned or dismissed?
   p. In recent election cycles, have commissioners/staff been formally accused (in criminal proceedings) of electoral fraud? Found guilty?
   q. During recent election cycles has the EMB been disbanded due to:
1) Electoral malpractice
2) Electoral fraud?
   r. In recent election cycles, have election results announced by the EMB been annulled/overturned by a court decision due to:
1) Electoral malpractice
2) Electoral fraud?

### Operational Planning [Vulnerability Score ______; Impact Score ______]

a. Does the EMB have a dedicated planning unit? Is it an ad hoc taskforce or a permanent entity?
b. Which EMB official is formally responsible for planning? For example, a commissioner? A senior member of the Secretariat?
c. How many staff members are fully devoted to planning?
d. Does the EMB have a mechanism to monitor and report on its planning process to ensure timely and highly quality planning?
e. Are plans well communicated and understood within the election management structure? At headquarters? In the field?
f. Is planning evidence-based, informed by experience and lessons drawn from previous elections, and responsive to recommendations made by election observers and other stakeholders?
g. Does the EMB have a current operational plan covering all critical aspects of the electoral process, including a security plan? If yes:
1) Does the plan provide clear areas of responsibilities, tasks, deadlines, and resources necessary to meet the objectives and an election calendar?
2) Who contributed to the development of the plan? Only senior EMB officials? All headquarters officials? Headquarters officials and field staff?
3) Does the operational plan sufficiently cover all main activity areas for both the headquarters and the field?
4) Can the EMB leadership track progress in the implementation of the operational plan's objectives and tasks?
5) How is the EMB progressing on its current operational plan?
   h. Do the EMB officials responsible for developing operational plans have election operations experience?
   i. If the EMB does not currently have an operational plan, has it had one in the past? If yes:
1) What were the strengths and weaknesses?
2) Why does the EMB no longer have one?
3) Is the EMB planning to reinstate the operational planning process?
   j. If the EMB has not yet developed operational plans, is there sufficient time before the next election?
   k. If proper operational planning was conducted prior to the most recent election, did this process assist the EMB to overcome malpractice and/or fraud risks? Elaborate.
   l. If operational planning was insufficient or nonexistent prior to the most recent election, did this contribute to increased malpractice and/or fraud risks? Elaborate.

### Fraud Mitigation Planning [Vulnerability Score ______; Impact Score ______]

a. Has the EMB established a special fraud deterrence/mitigation unit?
b. Has the EMB conducted a comprehensive fraud risk assessment? Elaborate. If yes:
1) Was the assessment largely a headquarters-driven process, or was it internally inclusive (across headquarters departments as well as inclusive of field personnel representing different regions and positions)?
2) Was the assessment largely an internal EMB exercise, or did it also include external stakeholders (e.g., political parties, election-focused CSOs, and other relevant state institutions)?
3) Were the findings from the assessment shared internally within the EMB (headquarters and field)?
4) Were the findings from the assessment shared with external stakeholders, (e.g., political parties, election-focused CSOs, and other relevant state institutions)?
   c. Has the EMB developed a comprehensive electoral fraud control plan? Elaborate. If yes:
1) Was the control plan development largely a headquarters-driven process, or was it internally inclusive (across headquarters departments as well as inclusive of field personnel representing different regions and positions)?
2) Was the control plan development largely an internal EMB exercise, or did it also include external stakeholders (e.g., political parties, election-focused CSOs, and other relevant state institutions)?
3) Were relevant and appropriate parts of the electoral fraud control plan shared internally within the EMB (headquarters and field)?
4) Were relevant and appropriate parts of the electoral fraud control plan shared with external stakeholders, (e.g., political parties, election-focused CSOs, and other relevant state institutions)?
5) Does the fraud control plan include a reasonable reporting mechanism to ensure compliance?
6) Is the responsible fraud office at the EMB's headquarters tracking adherence to the fraud control plan and its effectiveness?
   d. Has the EMB developed an anti-fraud training program for headquarters and field-based staff? If yes:
1) Is training based on a fraud control plan?
2) Is the training offered of sufficient quality to enable the staff to perform their fraud-related tasks?
   e. Has the EMB developed and implemented a sufficient internal EMB fraud awareness campaign?
   f. Has the EMB developed and implemented a sufficient external EMB fraud awareness campaign?

### Infrastructure and Technical Capabilities [Vulnerability Score ______; Impact Score ______]

a. Does the EMB have sufficient office space/infrastructure to fulfill its mandate at the headquarters level (i.e., offices, equipment, and communications equipment)?
b. Does the EMB have sufficient warehousing capacity at headquarters to securely and safely store fundamental equipment and assets?
c. Does the EMB have sufficient transportation capabilities at its disposal at headquarters to complete its tasks (during both election and non-election years)?
d. Does the EMB have sufficient office space/infrastructure to fulfill its mandate at the field level(s) (i.e., offices, equipment, and communications equipment)?
e. Does the EMB have sufficient warehousing capacity at the field level(s) to securely and safely store fundamental equipment and assets?
f. Does the EMB have sufficient transportation capabilities at its disposal at the field level(s) to complete its tasks (during both election and non-election years)?

### 12. Election Security and Role of Security Forces

Note: This category covers the roles and responsibilities of security forces, and how these relate to the security environment during the electoral process. This should include the institutional framework of security forces and their relationship to the election process and the election management body, as well as well as their ability to positively (or negatively) contribute to a secure environment. Security forces' mandates, planning and training capabilities and ability to implement the security plan are all relevant to this category, as a less secure environment creates room for non-compliance with laws, regulations and procedures. Furthermore, in some instances security forces can contribute to malpractice by being insufficiently trained on their roles and responsibilities. Likewise, members of the security forces can also be perpetrators of electoral fraud. Issues related specifically to the perpetrators and victims of electoral violence and intimidation are captured in the Voting Operations category and therefore should not be assessed here.

### Institutional Framework for Election Security [Vulnerability Score ______; Impact Score ______]

a. What is the mandate and composition of security forces responsible for election-related security?
b. Which stakeholders, if any, are actively and effectively mapping political and electoral violence?
1) The government (Ministry of Interior, Ministry of Defense)?
2) The EMB?
3) Civil society?
   c. If stakeholders are actively and effectively mapping political and electoral violence, is this information being factored into the electoral security planning and preparations by the EMB and/or state security apparatus?
1) Is such planning done only prior to Election Day, or throughout the electoral process?
   d. Is the government implementing conflict management, mitigation, and/or deterrence strategies? If yes:
1) Which government institutions are involved?
2) What types of actions are taken?
3) Are these actions effective?
3A) Why are these actions effective/not effective (knowledge/resources/dedication)?
   e. Is civil society implementing conflict management, mitigation, and/or deterrence strategies?
1) Which government institutions are involved?
2) What types of actions are taken?
3) Are these actions coordinated?
4) Are these actions effective?
4a) Why are these actions effective/not effective (knowledge/resources/dedication)?
   f. Is the EMB implementing conflict management, mitigation, and/or deterrence strategies?
1) Which government institutions are involved?
2) What types of actions are taken?
3) Are these actions coordinated:
4) Are these actions effective?
4a) Why are these actions effective/not effective (knowledge/resources/dedication)?
   g. Does the EMB have its own dedicated professional senior security officer?
   h. Is election security planning based on mapping of political and electoral violence/data on the occurrence of such violence/other evidence?
   i. Is there coordination (Joint Operational Command—JOC) between the electoral authority and different state security apparatuses? If yes:
1) Has the JOC developed an election security plan for the entire electoral process, including personnel, logistics, point and area security?
2) Is the coordination replicated at the sub-national level?
   j. Does the EMB take the lead in security coordination with political parties and civil society?

### Professionalism of Security Forces [Vulnerability Score ______; Impact Score ______]

a. Is there available survey data showing public faith in and credibility of state institutions? If so, how does the public perceive state security forces? Are they viewed as neutral and credible?

### Election-Specific Training of Security Forces [Vulnerability Score ______; Impact Score ______]

a. Is election-specific security training conducted for security officials, either by the EMB or by security organizations themselves (national leadership, Commanders in the field as well as security officials performing point security)?

### Accountability of Security Forces [Vulnerability Score ______; Impact Score ______]

a. Are rules of engagement and rules regarding the use of force by security officials clear, known and followed?

### 13. Election Observation and Oversight

Note: This category evaluates the environment for observation and monitoring of the electoral process by domestic and international observation groups and political party agents, as per The Declaration of Principles for International Election Observation and the Code of Conduct for International Election Observers. It also considers the credibility of domestic observer groups in particular, as they have the potential to play an important role as guardians of a credible election process.
Assessments of international observation should be guided by the Declaration of Principles for International Election Observation, which notes, inter alia, that “In order for an international election observation mission to effectively and credibly conduct its work basic conditions must be met. An international election observation mission therefore should not be organized unless the country holding the election” guarantees “unimpeded access of the international election observer mission to all stages of the election process,” freedom to issue findings and recommendations, and that “no governmental authority will pressure, threaten action against or take any reprisal against any national or foreign citizen who works for, assists or provides information to the international election observation mission in accordance with international principles for election observation.”

### Legal and Regulatory Framework [Vulnerability Score ______; Impact Score ______]

a. Does the electoral legislation provide for observation?
1) If so, who is permitted to observe elections?
1a) Domestic monitors?
   1b) International observers?
   1c) Party/candidate agents
   1d) The media?
2) By law, are observers entitled to oversee the whole electoral process/cycle or are they restricted to Election Day, or only once the election date has been announced?
   b. Are there legal restrictions to freedoms of association that would impact domestic observation groups (NGO law)?
   c. Are there legal restrictions for NGOs/observer groups to obtain foreign funding (NGO law)?
   d. What is the process for accrediting different types of observers?
1) Domestic monitors?
2) International observers?
3) Party/candidate agents/poll watchers?
4) The media?
   e. Are there requirements/criteria that these groups must meet to be eligible to observe? If so, are these requirements largely in line with the Global Declaration of Principles for International Election Observation?
   f. What body is responsible for issuing credentials?

### Challenges to the Work of Observers/Agents [Vulnerability Score ______; Impact Score ______]

a. During recent elections, have observers encountered difficulties:
1) Being pressured? Intimidated? Threatened? Arrested?
   1a) If so, please describe the circumstances and extent of the problem (whether it materially affected the observation mission, or not)
   1b) If so, who were the perpetrators of these acts of intimidations?
2) Being closed down/dissolved?
3) Recruiting monitors (lack of resources, fear of retribution?)
4) Getting credentialed in a timely fashion?
5) Deploying to all constituencies of the country?
6) Obtaining information from the EMB or sub-national election commissions about their meetings, decisions, activities, regulations, procedures, manuals, or election preparations?
7) Gaining access to voter registration and polling sites?
8) Gaining access to boundary delimitation data (if applicable)
9) Gaining access to voter registration data?
10) Accompanying the mobile ballot box (if applicable)?
11) Accompanying poll workers when delivering election results and sensitive election materials to election commissions?
12) Gaining access to counting/aggregation centers?
13) Getting certified copies of the protocol of election results?
   13a) At the polling site?
   13b) From higher-level election commissions (aggregated vote totals)?
14) Gaining access to court proceedings where electoral cases are being adjudicated?
   b. Do legal or regulatory requirements hamper the work of observers?
   c. Has the credentialing process been used to prevent certain groups from observing elections? Which ones? On what grounds?
   d. Do observers have any major restrictions on their credentials (e.g., geographic, time validity of credentials, commission type limitations, etc.) that could impact their ability to observe (re)counting at any level?

### Credibility of Observer Organizations/Agents [Vulnerability Score ______; Impact Score ______]

a. Are there domestic monitoring organizations capable of mounting a credible nationwide observer effort?
1) Are these groups widely perceived by electoral stakeholders to be independent, impartial and non-partisan?
2) Do they undertake long-term observation or only short-term?
3) Do they have the knowledge, expertise, and capacity to conduct their effort in accordance with professional standards and best practices of election observation (their most recent election observation report is a often a good indicator)?
4) Have they endorsed the Declaration of Global Principles for non-partisan election observation and Monitoring by Citizen Organizations that define common observation standards?
5) Are observers required to sign a Code of Conduct by the EMB or the organization itself?
   b. Does the NGO provide training to its monitors? Ask for copy of training materials.
1) Is this training conducted by the group, the EMB, or other?
2) How does the organization ensure observers fully understand their role, responsibility and how to complete the forms correctly?
   c. How is the observation mission structured?
1) Are observers deployed throughout the country?
2) What are the lines of communication and authority?
3) How does the organization ensure observers are adhering to the deployment plan and are truly visiting polling stations?
   d. Do they observe and report on all aspects of the electoral process?
   e. Do observation checklists include questions regarding access to polling centers for persons with disabilities and women?
   f. Do they undertake media monitoring? Do they apply a quantitative and qualitative methodology?
   g. How does the NGO collect and analyze data from its monitors?
1) Process and timetable?
2) Does the NGO use a standardized election observation methodology/observer reporting form?
   2a) From how many polling stations did they receive completed observer reporting forms in the last election (absolute figure and of polling stations)?
      h. Do they integrate mobile technologies, the Internet, content sharing, mapping and other innovations into their observer strategy?
1) Do they have the financial resources and know-how to do so?
   i. How does the NGO report its findings?
1) Formal reports including interim reports issued during the election campaign and/or after the election?
   1a) Are these reports posted online?
2) Press statements issued throughout the election period?
3) Press conferences held during the election period?
4) Do these reports include recommendations?
   4a) Are conclusions and recommendations linked to findings/evidence based?
      j. Have there been allegations of misconduct on the part of domestic observation groups in recent elections? Elaborate.
      k. Have there been allegations of misconduct on the part of international observation groups in recent elections? Elaborate.
      l. Have there been allegations of misconduct on the part of political party agents in recent elections? Elaborate.

### 14. Special Voting Services

Note: This category includes voting operations related to the following types of voters and voting processes that take place outside of the polling centers and/or prior to Election Day: out-of-country voting; absentee; early; users of mobile balloting services; and voters who are in prison, hospitals and the military or who have other special voting concerns. Inclusion of voters with disabilities is covered in the Voting Operations category. For further information on IFES' approach to out-of-country voting, please refer to Out-of-Country Voting: A Brief Overview.

### Out-of-Country Voting [Vulnerability Score ______; Impact Score ______]

a. Is out-of-country voting provided for under the law?
b. Do other institutions support the election management body in conducting out-of-country voting (e.g., the Ministry of Foreign Affairs)?
c. Who is eligible to vote out of country?
1) Are there clearly defined eligibility criteria?
2) Are there clearly defined documentary requirements for proving voter eligibility?
3) Is the eligibility criteria politically neutral, or does it favor/hinder a certain segment of the electorate?
   d. Has the EMB developed clear, objective criteria for determining in which countries voting services will be provided?
   e. What is the process/procedure for applying to vote out of country?
1) On what grounds might such a request be denied?
   f. Are those who are registered to vote out of country entered into a special voters' list? If yes:
1) Is this list publically available to observers and parties to ensure transparency?
   g. How does the EMB ensure voters are not able to register to vote twice (OCV and in-country)?
   h. What is the timeline for registration, voting and counting of out-of-country votes?
   i. Where do out-of-country voters cast their ballot? Is the venue secure and politically neutral?
1) Embassies?
2) Refugee camps?
3) Other facilities?
   j. What security and logistics arrangements are in place for transport of election materials (both deployment and retrieval of sensitive election material)?
   k. What arrangements are in place to ensure sensitive material is not manipulated while in transit?
   l. Is monitoring of out-of-country voting permitted?
1) By whom?
2) Requirements/process to be credentialed as an observer?
   m. Are the steps in out-of-country voting the same as at the polling station on Election Day?
1) How do they differ?
2) Are ballot security measures in place? Elaborate.
   n. How are out-of-country ballots counted?
1) When?
2) Where?
3) By whom?
   o. Is voter education and voter information disseminated to potential external voters in a timely and accessible fashion?
   p. How are results of out-of-country voting recorded/reported?
   q. During recent past elections, have there been issues with out-of-country voting? Elaborate.
1) Issues stemming from electoral malpractice? Perceived or actual?
2) Issues stemming from electoral fraud? Perceived or actual?
   r. If this is a post-conflict election, have there been efforts to ensure that all groups involved have access to out-of-country voting?
   s. If the out-of-country voting location is the embassy, what steps have been put in place to ensure that there is no bias towards the incumbent/ruling party (e.g., is there a large portrait of the current president if he/she is running for re-election? Is the environment safe for out-of-country voters to cast their ballot for the candidate of choice in secrecy)?

### Absentee Voting [Vulnerability Score ______; Impact Score ______]

a. Does the election law provide for absentee voting? If yes:
1) By post?
2) Online?
3) At specially designated early voting centers?
4) At polling stations on Election Day?
5) Embassies?
   b. Who is eligible to vote absentee?
1) Are patients in hospitals or medical treatment facilities allowed to vote absentee?
2) Is the eligibility criteria politically neutral, or does it favor/hinder a certain segment of the electorate?
   c. What is the process/procedure for applying to vote absentee?
1) On what ground might such a request be denied? Right of appeal?
   d. What is the timeline for absentee voting? Is it sufficient to allow voters to cast their ballot?
   e. Are those who are registered to vote absentee entered into a special voters' list? If yes:
1) Is this list publically available to observers and parties to ensure transparency?
   f. How does the EMB ensure voters are not able to register twice (absentee and regular voting)?
   g. Is monitoring of absentee voting permitted at voting centers/polling stations?
1) By domestic monitors?
2) By political party/candidate agents?
3) By journalists?
4) By international observers?
   h. What security and logistics arrangements are in place for transport of election materials (both deployment and retrieval of sensitive election material)?
   i. What arrangements are in place to ensure sensitive material is not manipulated while in transit?
   j. Are the steps in the absentee voting process the same as at the polling station on Election Day?
1) How do they differ?
2) Are ballot security measures in place for absentee voting? Elaborate.
   k. How are absentee votes counted?
1) When?
2) Where?
3) By whom?
4) How are the results of absentee voting recorded/reported? Integrated into overall results, or reported separately?
5) If reported separately, what steps have been taken to ensure secrecy of the ballot in case there is only one or a few voters?
   l. Is monitoring of the counting of absentee votes permitted?
1) By domestic monitors?
2) By political party/candidate agents?
3) By journalists?
4) By international observers?
   m. Are there large populations of voters who are internally displaced due to conflict? If yes:
1) How are these voters assigned to polling locations?
2) Are these voters permitted to cast votes according to their precinct of origin?
3) In recent elections, have there been issues with absentee voting for persons who are internally displaced?
   3a) Issues stemming from electoral malpractice? Perceived or actual?
   3b) Issues stemming from electoral fraud? Perceived or actual?
      n. In recent elections, have there been other issues with absentee voting? Elaborate.
1) Issues stemming from electoral malpractice? Perceived or actual?
2) Issues stemming from electoral fraud? Perceived or actual?
   o. In recent elections, has the EMB or a court ordered a recount of absentee voting due to suspicions of electoral fraud?
   p. In recent elections, has the EMB or a court thrown out the results of absentee voting:
1) Due to electoral malpractice? Perceived or actual?
2) Due to electoral fraud? Perceived or actual?
   q. Is there sufficient and targeted voter education on absentee voting?
1) Is the information easily available to eligible voters?
   r. Do women face barriers to absentee voting that are different from men in any way? Do women have equal access to absentee voting?
1) Are there any proactive measures and/or special provisions needed to ensure equal access?
   s. Are there marginalized/vulnerable populations (e.g., ethnic/religious minorities/indigenous populations) that face barriers to absentee voting that are unique?
1) Are there any proactive measures and/or special provisions needed to ensure equal access?

### Early Voting [Vulnerability Score ______; Impact Score ______]

t. Does the election law provide for early voting? If yes:
1) By post?
2) Online?
3) At specially designated early voting centers?
4) At polling stations?
5) Embassies?
   u. Who is eligible to vote early?
1) Are patients in hospitals or medical treatment facilities allowed to vote early?
2) Is the eligibility criteria politically neutral, or does it favor/hinder a certain segment of the electorate?
   v. What is the process/procedure for applying to vote early?
1) On what ground might such a request be denied? Right of appeal?
   w. Are those who are registered to vote early entered into a special voters' list? If yes:
1) Is this list publicly available to observers and parties to ensure transparency?
   x. How does the EMB ensure voters are not able to register twice (early and regular voting)?
   y. What security and logistics arrangements are in place for transport of election materials (both deployment and retrieval of sensitive election material)?
   z. What arrangements are in place to ensure sensitive material is not manipulated while in transit?
   aa. Is monitoring of early voting permitted at voting centers/polling stations?
1) By domestic monitors?
2) By political party/candidate agents?
3) By journalists?
4) By international observers?
   bb. Are the steps in the early voting process the same as at the polling station on Election Day?
1) How do they differ?
2) Are ballot security measures in place for early voting? Elaborate.
   cc. How are early votes counted?
1) When?
2) Where?
3) By whom?
4) How are the results of early voting recorded/reported? Integrated into overall results, or reported separately?
5) If reported separately, what steps have been taken to ensure secrecy of the ballot in case there is only one or a few voters?
   dd. Is monitoring of the counting of early votes permitted?
1) By domestic monitors?
2) By political party/candidate agents?
3) By journalists?
4) By international observers?
   ee. In recent elections, have there been issues with early voting? Elaborate.
1) Issues stemming from electoral malpractice? Perceived or actual?
2) Issues stemming from electoral fraud? Perceived or actual?
   ff. In recent elections, has the EMB or a court ordered a recount of early voting due to suspicions of electoral fraud?
   gg. In recent elections, has the EMB or a court thrown out the results of early voting:
1) Due to electoral malpractice? Perceived or actual?
2) Due to electoral fraud? Perceived or actual?
   hh. Is there sufficient and targeted voter education on early voting?
1) Is the information easily available to eligible voters?

### Mobile Balloting [Vulnerability Score ______; Impact Score ______]

a. Does the election law provide for voting by mobile ballot box?
b. Who is eligible to vote by mobile ballot box?
c. Is the eligibility criteria politically neutral, or does it favor/hinder a certain segment of the electorate?
d. What is the process/procedure for applying to vote by mobile ballot box?
1) On what grounds might such a request be denied? Right of appeal?
   e. Are those who are registered to vote by mobile ballot box entered into a special voters' list? If yes:
1) Is this list publicly available to observers and parties to ensure transparency?
   f. How does the EMB ensure voters are not able to register twice (mobile and regular voting)?
   g. Is monitoring of mobile voting permitted?
1) By domestic monitors?
2) By political party/candidate agents?
3) By journalists?
4) By international observers?
   ii. What security and logistics arrangements are in place for transport of election materials (both deployment and retrieval of sensitive election material)?
   jj. What arrangements are in place to ensure sensitive material is not manipulated while in transit?
   h. Are the steps in the mobile voting process the same as at the polling station on Election Day?
1) How do they differ?
2) Are ballot security measures in place for mobile voting? Elaborate.
3) Is secrecy of the vote protected during mobile balloting (e.g., are tactile ballot guides available so blind voters can vote in secret)?
   i. How are mobile votes counted (e.g., are they counted separately, or are they mixed with ballots in the stationary ballot box before counting)?
1) When?
2) Where?
3) By whom?
4) How are results of mobile voting recorded/reported?
   j. Is monitoring of the counting of mobile ballots permitted?
1) By domestic monitors?
2) By political party/candidate agents?
3) By journalists?
4) By international observers?
   k. In recent elections, have there been issues with mobile voting? Elaborate.
1) Issues stemming from electoral malpractice?
2) Issues stemming from electoral fraud?
   l. In recent elections, has the EMB or a court ordered a recount of mobile ballots due to suspicions of electoral fraud?
   m. In recent elections, has the EMB or a court thrown out the results of mobile voting:
1) Due to electoral malpractice?
2) Due to electoral fraud?
   n. Is there sufficient and targeted voter education on mobile balloting?
1) Is the information easily available to eligible voters?
   o. Do women face barriers to mobile balloting that are different from men in any way? Do women have equal access to mobile balloting?
1) Are there any proactive measures and/or special provisions needed to ensure equal access?
   p. Are there marginalized/vulnerable populations (e.g., ethnic/religious minorities/indigenous populations) that face barriers to mobile balloting that are unique?
1) Are there any proactive measures and/or special provisions needed to ensure equal access?

### Special Voter Eligibility [Vulnerability Score ______; Impact Score ______]

t. Are voters in hospitals and medical treatment facilities eligible to vote? If yes:
1) Are special polling sites set up within their institutions?
2) Are the steps in the voting process the same within hospitals as in a regular polling site?
3) How do they differ?
4) How is the secrecy of the vote protected? (e.g., are folders provided that can be used by a voter in bed to shield their ballot?)
5) Are ballot security measures in place for voting in hospitals? Or, are mobile ballot boxes taken to hospitals and medical facilities?
6) Are observers eligible to monitor voting in hospitals and medical facilities?
7) In recent past elections have there been issues with voting in hospitals and medical treatment facilities? Elaborate.
   7a) Issues stemming from electoral malpractice? Perceived or actual?
   7b) Issues stemming from electoral fraud? Perceived or actual?
      u. Are prisoners eligible to vote? If yes:
1) Are special polling sites set up in prisons?
2) Are the steps in the voting process the same in prisons as in a regular polling site? How do they differ?
3) Are ballot security measures in place for voting in prisons? Elaborate. Or, are mobile ballot boxes taken to prisons?
4) Are observers eligible to monitor in prisons?
5) In recent past elections have there been issues with voting in prisons?Elaborate.
   5a) Issues stemming from electoral malpractice? Perceived or actual?
   5b) Issues stemming from electoral fraud? Perceived or actual?
      v. Are military personnel eligible to vote? If yes:
1) Are special polling sites set up in military installations?
2) Are the steps in the voting process the same in prisons as in a regular polling site? How do they differ?
3) Are ballot security measures in place for voting in military installations?Elaborate.
4) Are observers eligible to monitor voting within military installations?
5) Or, do soldiers vote at regular polling stations in the district where they are stationed?
6) In recent past elections have there been issues with voting in military installations? Elaborate.
   6a) Issues stemming from electoral malpractice? Perceived or actual?
   6b) Issues stemming from electoral fraud? Perceived or actual?
      w. Is there sufficient and targeted voter education on special voter eligibility?
1) Is the information easily available to eligible voters?
   x. Do women face barriers to accessing special voting opportunities that are different from men in any way? Do women have equal access?
1) Are there any proactive measures and/or special provisions needed to ensure equal access?
   y. Are there marginalized/vulnerable populations (e.g., ethnic/religious minorities/indigenous populations) that face barriers to special voting opportunities that are unique?
1) Are there any proactive measures and/or special provisions needed to ensure equal access (especially in post-conflict situations)?

### 15. Voting Operations

Note: This category is the primary during the assessment in which we analyze the voter experience specifically. Questions herein will focus on secrecy of the ballot, precinct setup and management (especially as it impacts voting processes), violence and intimidation occurring on Election Day, and the inclusion of persons with disabilities. Voters requiring other special services (such as early or out of country voting) were covered in the previous category.

### Precinct Setup and Management [Vulnerability Score ______; Impact Score ______]

a. What is the procedure for:
1) Opening of the polls?
2) Voting?
3) Closing of the polls?
4) Counting of votes and preparation of the official protocol of results?
5) Reporting to higher EMB level during E-day (opening, turnout, closing, results)
6) Transfer of election results, ballots, and other sensitive election materials to the higher-level commission?
   b. What are the respective duties of each person on the polling board (i.e., Chairman, Deputy, Secretary, other members)?
1) How many poll workers are manning the polling stations and what are their individual titles/functions?
2) Are these duties established by law/regulation/instruction? Or assigned on site?
3) Despite this division of labor, does the Chairman dominate the work of the polling board?
4) Are poll workers administering voting exclusively?
   c. During recent past elections, did poll workers appear knowledgeable about election rules and procedures?
1) Where they able to administer voting in a professional and efficient manner? Issues?
2) Were the polling stations in general manned with the predetermined number of poll workers?
3) Do poll workers have sufficient training/instruction materials for on-site guidance?
4) Was there any confusion evident in the polling site due to lack of certainty?
5) Have there been any conflicts arising from a lack of clarity regarding procedures?
6) Do all stakeholders have access to information about the polling process, especially in terms of new procedures being introduced for the first time?
7) Were there inconsistencies in the way voting is being conducted from one polling site to another?
   d. During recent past elections, have polling boards or election officials reported any of the following problems? Please elaborate on the scale of the problems and how they were handled.
1) Polling boards dominated by a single political party/coalition?
2) Poll workers not showing up for work?
3) Untrained poll workers showing up for work?
4) Problems with election materials/supplies (insufficient or inappropriate)?
5) Problems with election technology/equipment?
6) Issues with improper sealing of the ballot box?
7) Congestion/crowding in the polling site?
8) Discrimination against certain populations while queuing?
9) Are voters being transported to the polling site in large numbers? Are they registered in another district?
10) Is there underage voting?
11) Observers/journalists appearing without their credentials?
12) Observers/journalists appearing with their credentials but not given access to the polling site?
13) Unauthorized persons assisting voters to cast their ballots?
14) Bribing or threatening of voters? By whom?
15) Bribing or threatening of poll workers? By whom?
16) Ballot box stuffing?
17) Failure to check voters for/mark voters with ink (if used)?
18) Failure to check voters' name on the voters' list?
19) Failure to have voters sign the voters' list?
20) Failure to properly validate ballots before issuing them (e.g., applying a stamp)?
21) Poll workers instructing voters which candidate they should vote for?
22) Voters being issued more than one ballot?
23) Non-standard ballots being issued (counterfeit ballots)?
24) Voters taking an unmarked ballot out of the polling site?
25) Campaign propaganda or campaigning within/proximate to the polling site?
26) Ballot boxes not properly sealed/secured?
27) Ballots not properly sealed/secured?
28) Other?
   e. How were problems handled at the polling site?
1) Were provisional ballots available for those voters not able to find their names on the voters' list (where applicable)?
2) Were complaints noted down in a logbook or documented in a similar manner?
3) Are courts involved in Election Day adjudication procedures? Were they responsive?
4) Did conflict arise from dissatisfied voters or other stakeholders surrounding the implementation of this procedures?
5) Were procedures ignored in order to avoid conflict and the voter allowed to vote without demonstrating the necessary qualifications?
   f. What steps are taken to secure the ballots and other sensitive materials and provide for ballot security at the polling site at each stage of the day:
1) At opening of the polls? Issues?
2) During voting? Issues?
3) During closing of the polls? Issues?
4) During the transfer of election results such as the use of tamper evident bags? Issues?
5) Are security forces involved? Is this generally accepted by the public and other stakeholders?
6) What policies, regulations and actions are taken to ensure transparency during the transportation of election materials to the polling station and retrieval of sensitive election material from polling stations?
   g. Are all planned polling stations opened on Election Day? If not:
1) Due to security concerns?
2) Due to fraud?
3) Due to malpractice?
   h. During recent elections, have there been reports of “ghost polling stations?”
1) What actions are the EMB taking to overcome a ghost polling station problem?
2) Are results generated and tabulated from these ghost polling stations?
3) Are security forces and/or police complicit in setting up and manipulating ghost polling stations?
4) Are EMB officials complicit in setting up and manipulating ghost polling stations?

### Secrecy and Security of the Ballot [Vulnerability Score ______; Impact Score ______]

a. During recent past elections, have there been reports of violations of secrecy of the ballot due to:
1) Open voting?
2) Family voting?
3) Voters showing poll workers how they marked their ballots?
4) Improper positioning of secrecy booths, or lack of sufficient secrecy solution supplied by the EMB (material missing or solution non-effective)?
5) Poll workers, observers, or others positioned behind the secrecy booths?
6) Use of mobile phones to take pictures of marked ballots?
7) Carousel voting?
8) Pre-marked ballots by polling officials?
9) Persons with intellectual or psychosocial disabilities are improperly influenced?
10) Impersonation of voters?
11) Other?
   g. What ballot security procedures and measures are applied at each stage of the process?
1) Voter registration data and production of voters' lists?
2) Ballot design/paper stock (ballot security features)?
3) Printing of ballots?
4) Printing of other sensitive forms, e.g. control slips, results reporting forms?
5) Packaging of ballots and other sensitive forms?
6) Storage of ballots and other sensitive forms/materials (at each storage location)?
7) Procurement of election materials and supplies (e.g., ballot boxes, seals, tamper evident transfer bags, indelible ink)?
8) Handling of ballots and other sensitive forms/materials in the polling site?

### Election Day Violence and Intimidation [Vulnerability Score ______; Impact Score ______]

a. During recent elections, have there been reports of intimidation on Election Day of:
1) Voters? By whom?
2) Poll workers? By whom?
3) Election observers? By whom?
4) Journalists? By whom?
5) Political party/candidate representatives? By whom?
6) Are women subject to different forms of intimidation?
   b. During recent elections, have there been reports of disruptions or violence at the polling site? Requiring a temporary halt to voting?
   c. Does intimidation against various electoral stakeholders rise to the level of politically motivated/electoral violence?
   d. Who/which groups are being attacked?
1) How severe and recurrent is the violence/intimidation?
2) Who are the attackers?
3) Why are these groups/individuals being attacked (ethnic/religious/linguistic/tribal/political issues)?
   e. What are the patterns of electoral violence during the different phases of the electoral process?
1) Voter registration?
2) Candidate registration?
3) The electoral campaign?
4) Polling and counting?
5) Announcement of results?
6) After the election?
   f. To what extent is the election itself a trigger for violence or to what extent do the electoral processes mitigate violence in the society?
   g. If a winner-take-all type of electoral system, is this contributing to violence/intimidation?
   h. Is impunity and/or lack of rule of law fueling violence?
   i. Are there international dimensions to the electoral violence?
1) Are patterns of violence linked to regional trends in conflict?
2) Patterns of foreign funding/support related to electoral violence?
3) Are patterns of violence linked to patterns of transnational organized crime?
   j. How does political and electoral violence impact:
1) The ability of the EMB to carry out elections?
2) Participation in elections? (e.g., by candidates, election workers, journalists, election observers, and voters)?
3) Legitimacy of elections/election results? (e.g., does the violence make the process vulnerable to manipulation)?
   k. Are electoral authorities the victims of violent attacks? Elaborate.
1) Are such attacks limited to specific regions in the country?
2) What levels of electoral officials are targeted (Commissioners/secretariat staff/field-based staff/ad hoc staff)?
3) Are electoral facilities targeted for violence (e.g., voter registration centers, warehouses, polling centers, results centers, transportation of material, central or local headquarter facilities)?
4) How do perceptions of the independence and neutrality of the EMB influence the occurrence of violence?

### Inclusion and Accessibility [Vulnerability Score ______; Impact Score ______]

a. Is there a provision in the law that enfranchises all persons with disabilities?
1) Does the law have any discriminatory provisions towards persons with intellectual or psychosocial disabilities? (e.g., does it have clauses not allowing persons of “unsound mind” to vote?)
2) If the law does have discriminatory clauses against persons with intellectual and psychosocial disabilities, how/who determines if voters fit into this category?
   b. Does the law require polling sites to be physically accessible?
1) Are reasonable accommodations selectively applied (e.g., are ramps to polling stations only built in areas where one political party has a stronghold)?
2) Are polling sites physically accessible?
3) Scope of inaccessible sites?
   c. Are there alternative procedures for dipping a finger in ink if the voter does not have the designated finger?
   d. Is there a provision in the law pertaining to voters requiring assistance? If yes:
1) What restrictions apply to assisted voting (e.g., who can and cannot assist)?
2) Are assistants required to sign an affidavit promising to maintain the secrecy of the vote?
   e. Is all voter education information disseminated in accessible formats (e.g., Braille, sign language, easy-to-read, pictorial)?
1) Do persons with disabilities know they have the right to vote?
2) Are complaint adjudication mechanisms accessible?
   f. Is special voting equipment available to enable visually or hearing impaired voters to cast their votes without assistance (e.g., tactile ballot guide that can be used without assistance)?
   g. Do women face barriers to casting their votes that are different from men in any way? Do women have equal access?
1) Are there any proactive measures and/or special provisions needed to ensure equal access?
   h. Are there marginalized/vulnerable populations (e.g., ethnic/religious minorities/indigenous populations) that face barriers to casting their votes that are unique?
1) Are there any proactive measures and/or special provisions needed to ensure equal access (especially in post-conflict situations)?

### 16. Counting

Note: This category covers count processes at the lowest level (in some cases, the precinct/polling station level or at a centralized count center) and transmission. It does not cover aggregation and certification processes. The primary principles governing this process are transparency, uniformity, accuracy.

### Counting Process [Vulnerability Score ______; Impact Score ______]

a. Are ballot counting procedures contained in the electoral legislation, subsidiary acts, or an EMB regulation?
1) What is the process for amending such procedures, i.e., who has authority to do so and how?
   b. Are ballots counted at polling stations or at central counting centers or other hybrid system?
   c. If there are multiple elections, are the ballots easily distinguishable to poll workers and observers (i.e., a different color)?
   d. What is the procedure/process for counting of votes?
1) Is the total number of ballots cast established first and reconciled with the voters' list, before determining the number of preferences for each party/candidate?
2) Are there any aspects of these procedures that may unintentionally cause counting errors?
3) Are there any aspects of these procedures that would give opportunities for fraudulent behavior?
   e. Are there clear and unmistakable definitions and/or terminology used for:
1) Valid ballots?
2) Invalid ballots?
   2a) Is there specific guidance in the law/procedures on what constitutes an invalid ballot?
3) Unmarked ballots (or is unmarked considered an ‘invalid’ ballot)?
4) Unused ballots?
5) Spoiled ballots?
   f. What is the procedure/process for invalidating unused ballots upon closing of the polls?
1) Are ballots torn/cut or otherwise marked so it is impossible to use?
   g. What is the procedure/process for determining whether a marked ballot is invalid?
1) Is there a voting procedure when the intent is unclear and the law/procedures do not clarify whether the marking is valid?
   h. What is the procedure/process for handling challenges to the results (or dissent within the polling board) at the polling site?
1) Are dissenting opinions allowed to be attached to the protocol?
   i. If a recount is required, is this done at the higher-level election commission/counting center, or (back) at the polling site?

### Results Forms [Vulnerability Score ______; Impact Score ______]

a. Is there a form of a reconciliation formula used whereby: # of ballots issued to polling site=the sum of used, spoiled, and unused ballots (thereby offering a safeguard against ballot theft and box stuffing)?
b. Are the procedures written in a way that the counting cannot be finalized if reconciliation formulas like those above do not compute, or they have to obtain approval from a pre-determined senior EMB official so this anomaly can be flagged, tracked and properly investigated?
c. Does the results form itself contain security features to reduce the risk of tampering, such as:
1) Serial numbers that are tracked by the EMB (results form tied to unique polling station)?
2) Micro printing?
3) Bleed through printing?
4) Transparent scotch tape used to cover the results?
5) Results spelled out in numbers and letters?
   d. Is there a clearly defined process whereby officials at the polling station should recount ballots already counted under certain circumstances/outcomes?
1) Must a quorum be present for recounts equal to regular counting procedures?
   e. During recent past elections, have there been issues with the count at the polling station? Elaborate.
1) Stemming from procedural or legislative deficiencies, ambiguities or gaps?
2) Stemming from electoral malpractice?
3) Stemming from electoral fraud?
4) Stemming from unusually slow process resulting in suspicion?
5) Stemming from faulty technology?
6) Stemming from poorly trained election officials?
7) Stemming from insufficient material necessary to complete the count?
   f. If ballots counted at a regional/national counting center has there been issues with the count at in recent elections? Elaborate.
1) Stemming from procedural or legislative deficiencies, ambiguities or gaps?
2) Stemming from poor/incorrect reconciliation at the polling stations?
3) Stemming from electoral malpractice?
4) Stemming from unusually slow process resulting in suspicion?
5) Stemming from faulty technology?
6) Stemming from poorly trained count officials?
7) Stemming from insufficient material necessary to complete the count?
   g. What is the procedure/process for preparation of the protocol of election results?

### Transmission of Results [Vulnerability Score ______; Impact Score ______]

a. What is the procedure/process for packing of sensitive election materials at the counting level?
1) Are tamper proof packing methods used for any or all sensitive materials?
   b. What is the procedure/process for transferring sensitive materials and voting results from the polling station to a higher-level election commission?
   c. How many levels of aggregation are there before results reach the chief electoral authority?

### External Monitoring [Vulnerability Score ______; Impact Score ______]

a. Is a certified copy of the protocol posted at the polling station?
1) Are certified copies provided to election observers?
1a) If so, which type of observers?
2) Are copies posted online by the election authority?
   b. Are credentialed observers, party agents, and journalists permitted to remain inside the polling station for the count?
   c. Is the invalidation of unused ballots, counting of ballots, preparation of the official protocol, and packaging of election materials done in full view of election observers, party agents, and journalists?
1) Are the observers, party agents and journalists able to verify the voter intent on each ballot as it is counted?
2) In the case of disputed ballots, are observers, party agents and journalists able to examine the ballot?
3) Is filming of the count permitted?
4) Are observers/agents allowed an official copy of the results forms?
5) Are photographs allowed to be taken of the protocols?
   d. Are credentialed observers, party agents, and journalists permitted to accompany voting results and sensitive election materials to the higher-level election commission?
   e. Are credential observers, party agents, and journalists permitted to observe the aggregation of votes at higher-level election commissions?
   f. Are credentialed observers, party agents and journalists and citizens legally allowed and able to file complaints to the commission, higher level commission or judicial authority on the counting process?
1) On individual polling stations, partial results and/or the final results of the count?
   g. Are results posted online (or by a similarly transparent and accessible method) and within an immediate time frame so that observers, party agents and journalists and citizens have access to the information within the legal deadlines for filing complaints on results and tabulation?
1) If posted, are results disaggregated in sufficient detail to make a comparison to an observed count result at the polling station level?
   h. Is there any role played by the international community in overseeing or assisting counting and results tabulation?
   i. Do international observers enjoy the full rights of other credential observers in order to perform effective observation of the count in according to their organizations' statutes?

### 17. Aggregation and Certification of Final Results

Note: This category covers aggregation and certification of final results by the EMB or other relevant body. It does not cover issues relating to the initial count conducted at the precinct or polling station level, or at a centralized count facility. Analysis should determine whether the mechanisms for determining and certifying election results are accurate, transparent and trusted, and whether the timetable for determining election results is adhered to and of an appropriate length to promote public confidence in the integrity of the result. It should also consider if announced results are broadly accepted by stakeholders, resulting in a peaceful transition to newly elected positions and/or government.

### Receipt of Results [Vulnerability Score ______; Impact Score ______]

a. What is the procedure/process for receiving polling site results protocols and sensitive election materials (i.e., transfer)?
b. What is the procedure/process for intake and verification of the accuracy of polling site results protocols by the higher-level election commission?
1) If the higher-level commission detects errors how is this corrected? Who has the authority to correct the results forms, as they are legal documents? Do they use a correction form, which has security features and serial numbers? Does the EMB have the signatures of the officials allowed to sign a correction form on file to avoid fraud? How are these forms shared with observers, party agents and the public?
   1a) Are there minor inaccuracies that can be remedied by the higher level commission or must the materials be returned to the polling station commission in all cases?
   1b) On what process and procedures for quarantining polling station results?
   1c) Does the EMB have user-friendly manuals/guides to assist the staff charged with investigating quarantined ballot boxes?
   1d) Has the staff been trained on the regulations and procedures governing the quarantining and investigation of suspicious results forms and ballot boxes?
      c. What is the procedure/process for aggregating votes?
1) If manually entered into a computer-based system, is the data-entry of results done using double-blind methodology to reduce the risk of errors?
2) How does the EMB ensure that the aggregation of results is done in a transparent manner (projects connected to results entry computers, aggregation done on larger whiteboards, actual results entered searchable online, or printed for display at a designated location for accredited stakeholders).
   d. If ballots are aggregated at regional/national counting centers, have there been issues with the tabulation in recent elections? Elaborate.
1) Stemming from procedural or legislative deficiencies, ambiguities or gaps?
2) Stemming from poor/incorrect reconciliation at the polling stations?
3) Stemming from substandard design of tabulation process by EMB headquarters?
4) Stemming from poorly planned results tabulation process at the center?
5) Stemming from poorly trained count officials?
6) Stemming from insufficient material necessary to complete the count
7) Stemming from electoral malpractice?
8) Stemming from unusually slow process resulting in suspicion?
9) Stemming from faulty technology?
   e. What is the procedure/process for preparing and approving of the protocol of aggregated vote totals?
1) Is a certified copy posted at the election commission broken down by polling stations, or only aggregated total?
2) Are certified copies provided to election observers?
   f. What is the procedure/process for delivery of aggregated results protocols and sensitive election materials for delivery to the next higher-level election commission (or storage facility)?
1) Is there a legal deadline?
2) If polling station results forms and correction forms are transported to the next EMB-level, how is this conducted in a secure manner? Are tamper evident bags used, physical security ensured by police?
3) Can observers accompany?
   g. What is the procedure/process for packing of aggregated results protocols and sensitive election materials?
   h. If results are entered into the computer and relayed electronically, do they legally become the official protocols, or does the paper copy still remain the official legal document?
   i. During recent past elections, have there been issues with the delivery of aggregated voting results and sensitive election materials to higher-level election commissions?
1) Stemming from inadequate IT/communications or physical infrastructure?
2) Stemming from substandard design of delivery process of aggregated results by EMB headquarters?
3) Stemming from poorly planned delivery process from the center by local

EMB?
4) Stemming from electoral malpractice?
5) Stemming from electoral fraud?

### Reconciliation and Certification of Final Results [Vulnerability Score ______; Impact Score ______]

j. Are the processes for determination of election results and notification to stakeholders, and the terms of office of elected candidates clearly defined?
k. At what level are final election results determined—centrally or at a lower level?
1) If other than centrally, have results been determined in a consistent manner?
   l. Which body or bodies is/are responsible for determining and certifying final results, how is it appointed, what are the qualifications for membership and what are its powers, functions, term of office, funding and staffing sources and protections from dismissal?
1) Is there potential for, or haves there been perceptions of, political interference in the work of this body or bodies?
2) Has there been a history of extensive challenges to final results? If so, to what extent have these been successful?
3) If there are different bodies responsible for determining and certifying results, what is the relationship between them?
   3a) Have there been disagreements between these bodies or overrules of result determinations? If yes, what were the nature of these and their impacts?
      m. Is a certified copy of the aggregated results form posted at the polling station?
1) Are certified copies provided to election observers?
   1a) If so, which type of observers?
2) Are copies posted online by the election authority?
   n. Can the electoral authority invalidate results at polling stations for any defined reasons?
1) By law, does the invalidation of results require a re-poll where the outcome might be affected by the invalidated results?

### Timetable and Public Acceptance of Election Results [Vulnerability Score ______; Impact Score ______]

a. Are interim results made freely available to parties, candidates and/or other stakeholders and/or published?
1) If interim results have been made available, have they differed significantly from the final result determination? If so:
2) Are the differences plausibly explicable and have they been publicly explained?
   b. What is the deadline for the announcement of final election results?
1) Does the deadline give sufficient time for accurate determination of results, including conduct of recounts if required?
2) Is the deadline so long after Election Day that it has raised perceptions that it provides opportunities for manipulation?
   c. In recent past elections, has the announcement of final election results ever been delayed?
1) If yes, have reasons for the delay(s) been plausible and broadly accepted by stakeholders?
   d. Is the public made aware of the results determination/certification process through education campaigns?
   e. Are copies of the interim results (if applicable) and final results determination provided freely to parties, candidates and other stakeholders and published in mass media?
1) By what method/using what media are final results made publicly available?
2) Is there a time limit within which final results must be made publicly available and/or published?
3) To what level of detail are final election results published—both level of administrative unit and details of those elected?
4) Are all supporting documents—e.g. tally and aggregation sheets, electronic count records—also made publicly accessible?
   f. Can a recheck, recount or fresh ballot be ordered before final certification of results?
1) Are there provisions for compulsory recounts/rechecks of ballots before final results are determined and/or certified?
2) Can the body responsible for determining or certifying results order rechecks or recounts of ballots or a fresh election?
3) Are procedures and deadlines for triggering, requesting, determining and conducting a recheck, recount and repeat election well-defined and understood by stakeholders?
   g. Have results in past elections suggested there are abnormalities? For example:
1) An abnormally high (or low) voter turnout?
2) A high invalid ballot rate? Spoiled ballot rate?
3) Occurrences of no votes cast or minimal votes cast for a major political contender?
4) Reciprocal voting—i.e., voting patterns exactly reversed for different elected positions?
5) Has any statistical analysis of past election results been undertaken—e.g., last digit analysis, and has this indicated any potential anomalies?
   h. In recent past elections, has the announcement of election results lead to public unrest or violence? If yes:
1) What were the causes?
2) What impact did the unrest or violence have?
3) How was it managed?
   i. In recent past elections, have there been issues with an orderly transfer of power due to one or more of the contestants refusing to accept the election results? If yes:
1) How has this been resolved?
   j. Is there any requirement that election materials relevant to the determination of results (such as ballots, voters lists, count tally and aggregation sheets, any declarations by voters, seat allocation calculations) be stored securely for a minimum period? If yes:
1) What is this period? Is it sufficient to cover the adjudication of any challenge to final election results?
2) Have the relevant materials been stored securely and accessibly?

### 18. Adjudication of Electoral Grievances

Note: In some countries, administrative and criminal violations may be subject to very different systems, standards and procedures. Please respond to the following set of questions as appropriate for both types of issues, noting any differences where relevant. For further information on the IFES approach to electoral complaints adjudication, please refer to Guidelines for Understanding, Adjudicating, and Resolving Disputes in Elections (GUARDE).

### Right of Redress [Vulnerability Score ______; Impact Score ______]

a. What bodies are responsible for handling election complaints adjudication (e.g., election commissions, the court, a special electoral tribunal)?
b. Does the electorate know that they have the right to redress for their election-related grievances?
c. Do complainants believe that the process is effective/legitimate?
1) If not, what issues have complainants encountered with respect to the complaints and appeals process?
   d. Does the arbiter believe that the process is effective/legitimate?
1) If not, why not?

### Clear Standards [Vulnerability Score ______; Impact Score ______]

a. Is there a codified and well-defined process in place for filing complaints and appeals?
1) Is this process used and applied consistently and is it understood by legal professionals and stakeholders in the country?
2) Are the procedures and process for filing a complaint/appeal known to and clearly understood by electoral stakeholders:
   2a) Political parties/candidates?
   2b) Domestic monitoring groups?
   2c) The media?
   2d) Voters?
      b. Does the court have an effective case management system in place?
1) Is it transparent and open to the public to monitor the status of complaints?
   c. Are there clearly defined and accepted “burdens of proof” established for each type of offense?
   d. Are there clearly defined and accepted “standards of evidence” for each type of offense?
   e. Is it clearly defined who has standing to bring cases about the violations of voting rights?
   f. Is it clearly defined who has standing to bring cases about the violations of electoral rules (administrative cases)?
   g. Is it clearly defined who has standing to bring cases about the election results?
   h. In recent past elections, has there been a tradition of political parties/candidates bringing frivolous lawsuits as a campaign strategy (i.e., to tie up an opponent's resources in court and to create a public impression of wrongdoing)?
   i. What is the percentage of cases thrown out due to lack of standing/evidence?
   J. Who is responsible for investigating and prosecuting criminal offenses?

### Impartial and Informed Arbiter [Vulnerability Score ______; Impact Score ______]

a. Is the arbiter independent (i.e., based on the appointment process for members and their terms of office, credibility as an independent body in the public eye, and the presence of safeguards against political or other pressures)?
1) What is the process for appointing arbiters? Removing arbiters?
   b. Is the arbiter neutral (i.e., does not unduly favor a particular political party or other grouping in the course of discharging his or her responsibilities)?
   c. Are the decisions and processes of the arbiter transparent?
1) Are dissenting opinions issued?
   d. Is the arbiter part of a professional body? Are arbiters employed full-time? Full-time only during the election period?
   e. Is the arbiter accountable for his or her conduct and decisions (i.e., can he or she be prosecuted or removed for illegal conduct)?
   f. Are judges well-versed in electoral law (including any recent changes resulting from reforms)?
   g. Are the arbiters paid a salary at a level that discourages corruption?
   h. Have election arbiters previously been accused of or convicted for taking bribes or other forms of financial corruption?
   i. Have election arbiters previously been subjected to physical or other coercion?

### Expedited Decisions [Vulnerability Score ______; Impact Score ______]

a. Are there established timetables for decisions?
1) Are these timelines followed?
   b. Do election commissions/courts have the professional and institutional capacity to handle the volume of complaints they receive?
   c. Do these bodies have a system for prioritizing the caseload? Is it utilized/effective?
   d. Have delays in adjudicating complaints in previous elections led to credibility crises for the EMB or the government? Have delays led to violence?

### Meaningful Remedies [Vulnerability Score ______; Impact Score ______]

a. Is there a right to an appeal for decisions taken on electoral complaints?
b. During recent elections, what has been the volume of complaints? Appeals?
1) Is the docket transparent and open to the public?
   c. What was the resolution of these cases?
1) Were the judgments enforced?
   d. In recent elections, has the arbiter:
1) Rejected candidate or party registration? On a legitimate basis?Elaborate.
2) Ruled against a party or candidate for campaign finance violations? On a legitimate basis? Elaborate.
3) Revoked the mandate of elected officials? On what basis?
   3a) Due to electoral malpractice?
   3b) Due to electoral fraud?
4) Called for a partial or full recount of election results? Elaborate.
   4a) Due to electoral malpractice?
   4b) Due to electoral fraud?
5) Overturned by a decision of the court? On what basis?
   5a) Due to electoral malpractice?
   5b) Due to electoral fraud?
6) Disbanded the EMB for electoral malpractice or electoral fraud?
7) Have election officials been found guilty of electoral malpractice? Elaborate.
8) Have any electoral stakeholders been found guilty by a court of committing electoral fraud:
   8a) Candidate?
   8b) Political party representative?
   8c) Election official?
   8d) Other government official?
   8e) Businessman/woman?
   8f) Trade union representative?
   8g) Member of the media?
   8h) Other civil society representative?
   8i) Ordinary voter?
   8j) Other?
      e. Is alternative dispute resolution (ADR) ever used to resolve election disputes? Issues?

### Education and Training [Vulnerability Score ______; Impact Score ______]

a. Does the EMB conduct educational outreach programs focused on complaints adjudication for:
1) Political parties/candidates?
2) Domestic monitoring groups?
3) The media?
4) Voters?
   b. Does the EMB facilitate NGO or party educational programs?
   c. Do EMB educational campaigns focus on the needs of:
1) Women?
2) Minority and indigenous groups?
3) Persons with disabilities?
4) Youth?
5) The elderly?
6) Inhabitants of rural areas?
   d. Are political parties encouraged or required to adopt Codes of Conduct?
   e. Do political parties support public understanding of complaints processes?
   f. Does the EMB provide sufficient training and information on the law and procedural rules to:
1) Central EMB staff?
2) Regional or provincial EMB staff?
3) Investigation teams?
4) Polling station workers?
5) Election lawyers?
   g. Are adequate resources provided to the EMB to provide ongoing training for their staff on complaints adjudication processes?
   h. Does the media cover electoral complaints and electoral issues in a fair and accurate way?

### Methodology

The electoral integrity assessment tool seeks to analyze areas of the electoral process at risk of 1) fraud, 2) malpractice, and 3) systemic manipulation. These three (3) categories are defined in FIG. 1. The following sections summarize each of the three risk areas, and provide greater clarity on individual vulnerabilities using a quantitative vulnerability index.

The method comprises a set of twenty (20) overarching categories. Of these, fifteen (15) categories are analyzed for a particular country. These categories are each further divided into two (2) to six (6) subcategories, which form the basic unit of analysis. Within these subcategories, the assessment team selects relevant questions for interviews and desk research.

Each subcategory is assigned three (3) distinct data points that produce an overall rating for each category:
1) Vulnerability to fraud, malpractice or systemic manipulation is rated on a scale of 0-10;
2) Intensity of potential fraud, malpractice or systemic manipulation impact is rated on a scale of 0-10; and
3) Weighted importance of the subcategory relative to the overall category, out of 100 percent.
   FIG. 2 shows the rating scale used for the first two data points.

A combination of risk factors, such as the existence of incentives, and political will to commit fraud, malpractice or systemic manipulation, are generally understood to increase the potential for these issues in an election event. The assessment can consider these guidelines (seen in FIG. 3) as context for developing vulnerability and impact ratings.

Again, the electoral integrity assessment method is to report on and analyze areas of the electoral process at risk of fraud, malpractice and systemic manipulation for a particular country. The following summarize the three risk areas, and provide greater clarity on individual vulnerabilities using a quantitative vulnerability index.

The research methodology used in this effort contains a set of twenty (20) overarching categories. The assessment can use all twenty (20) categories, or a smaller group of categories selected from the group of twenty (20) categories.

These categories are each further divided into one or more subcategories (e.g. two (2) to six (6) subcategories), which form the basic unit of analysis. Within the subcategories, the assessment team selects relevant questions for interviews and desk research.

The subcategories are analyzed based on the following:
1) Vulnerability to fraud, malpractice or systemic manipulation, rated on a scale of 0-10;
2) Intensity of potential fraud, malpractice or systemic manipulation impact, rated on a scale of 0-10; and
3) Weighted importance of the subcategory relative to the overall category, out of 100 percent.

A combination of risk factors, such as the existence of incentives and political will to commit fraud, malpractice or systemic manipulation, are generally understood to increase the potential for these issues in an election event. The assessment team considers the rating guidelines shown in FIG. 3, as context for developing vulnerability and impact ratings.

The rating guidelines are based on three (3) rating ranges in the three (3) categories of fraud, malpractice, and systemic manipulation, as set forth below:
1) Low (0-3 rating);
2) Medium (4-6 rating); and
3) High (7-10 rating).

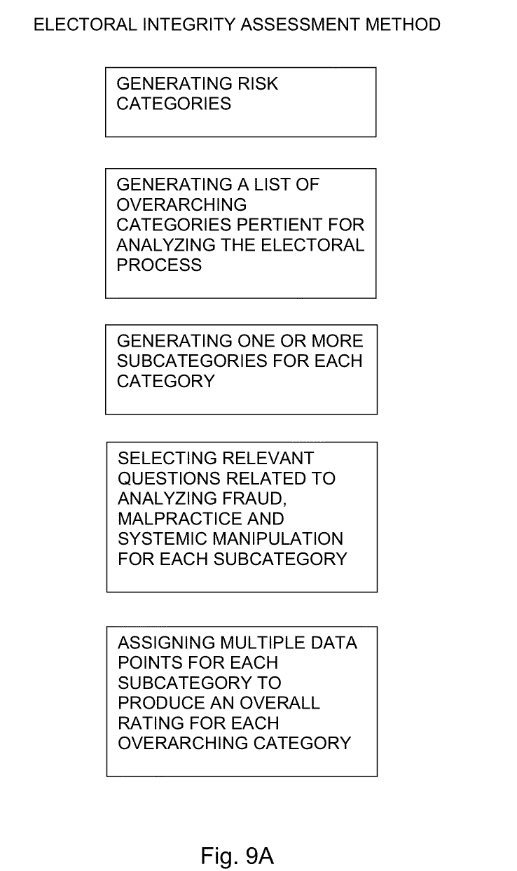

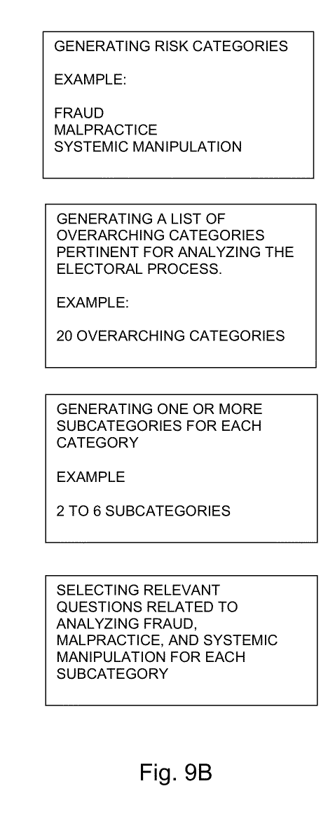

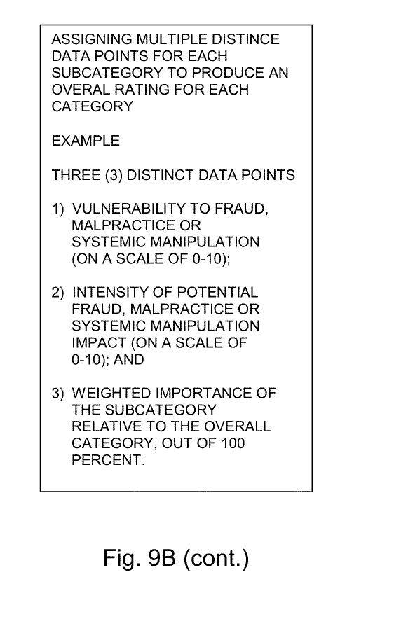

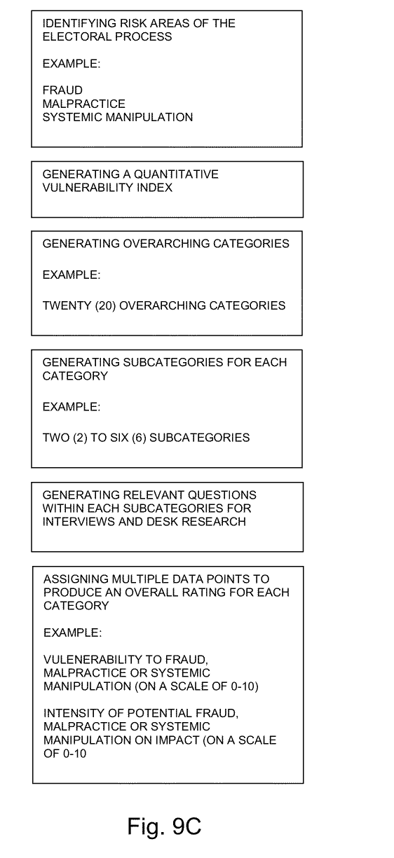

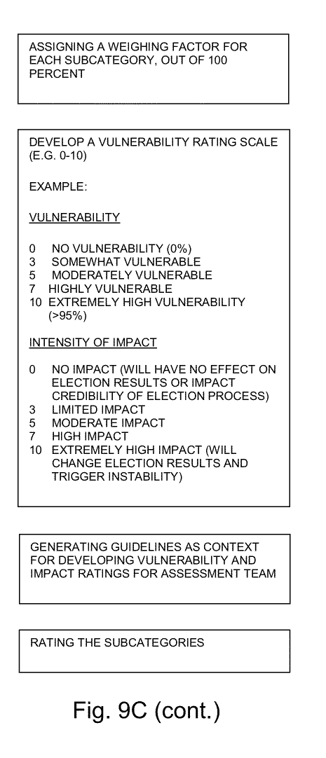

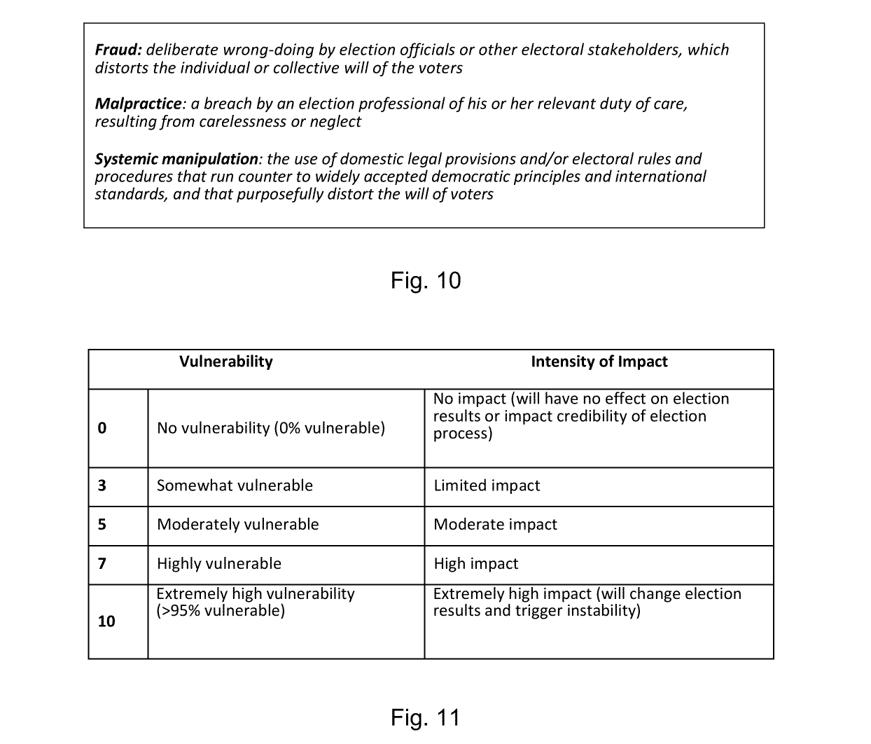

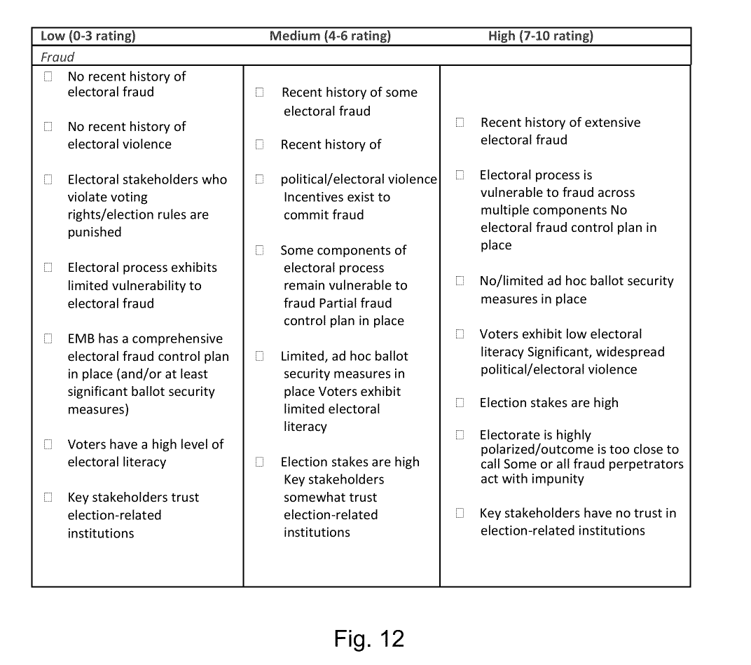

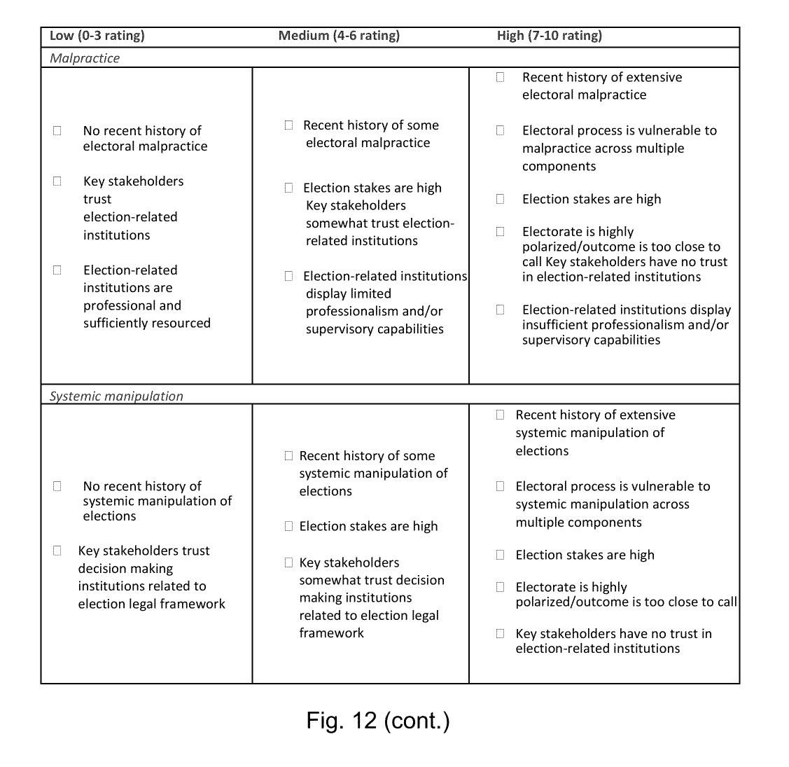

A core of the analysis/method is shown in the flow diagrams shown in FIGS. 9A, 9B, and 9C.

The broad steps include 1) generating risk categories, 2) generating a list of overarching categories pertinent for analyzing the electoral process, 3) generating one or more subcategories for each overarching category, 4) selecting relevant questions related to analyzing fraud, malpractice, and systemic manipulation for each subcategory, and 5) assigning multiple data points for each subcategory to produce an overall rating for each overarching category, as shown in FIG. 9A. FIGS. 9B and 9C show more detailed flow diagrams based on FIG. 9A.

### EXAMPLE

The electoral integrity assessment methodology was applied to the country of Afghanistan. The following sets forth the particulars of this applied method.

### DEFINITIONS/ACRONYMS

### AGCHO Afghan Geodesy and Cartography Head Office

### AGO Attorney General's Office

### AIHRC Afghanistan Independent Human Rights Commission

### AIMS Afghanistan Information Management Service

### ANA Afghan National Army

### ANP Afghan National Police

### ANSF Afghan National Security Forces

### CEO Chief Electoral Officer

CRPD Convention on the Rights of Persons with Disabilities

### CSO Central Statistics Office

### DFC District Field Coordinators

### DFID UK Department for International Development

### ECC Election Complaints Commission

### EEC Electoral Education Center

### ELECT Enhancing Legal and Electoral Capacity for Tomorrow

### EMB Election Management Body

### EUPOL European Union Police Mission in Afghanistan

### FEFA Free and Fair Election Foundation of Afghanistan

### FPTP First-Past-The-Post

### GoA Government of Afghanistan

### ICCPR International Covenant on Civil and Political Rights

### IDLG Independent Directorate of Local Governance

### IEC Independent Election Commission of Afghanistan

### IFES International Foundation for Electoral Systems

### ISAF International Security Assistance Force

### IWPR Institute for War and Peace Reporting

### JEMB Joint Electoral Management Body

### LTO Long-Term Observer

### MoU Memoranda of Understanding

### NATO North Atlantic Treaty Organization

### NDI National Democratic Institute

### NDS National Directorate of Security

### PECC Provincial Election Complaints Commission

### POD Public Outreach Department

### PRT Provincial Reconstruction Team

### RCF Regulation on Campaign Finance

### SNTV Single Non-Transferable Vote

### SRSG Special Representative of the Secretary General of the United Nations

### STO Short-Term Observer

### UDHR Universal Declaration of Human Rights

### UNAMA United Nations Assistance Mission in Afghanistan

### UNDP United Nations Development Programme

### USAID United States Agency for International Development

### USIP United States Institute of Peace

As past elections in Afghanistan have demonstrated, electoral malpractice and fraud are highly complex issues. A fragile security context, in addition to the lack of political consensus and arbitrary and untimely intervention by the executive in the process, has largely allowed fraud and malpractice to go unchecked. No single solution will resolve the severe integrity problems facing elections in Afghanistan. However, a proactive electoral integrity strategy and an integrated malpractice and fraud control plan that includes improved detection, deterrence and mitigation mechanisms are possible. For maximum effectiveness, these activities must be accompanied by efforts to improve the public perception of the election process.

As Afghanistan prepares for the 2014 presidential and 2015 Wolesi Jirga (parliamentary) elections, the Independent Election Commission of Afghanistan (IEC) is working to ensure that the upcoming polls are not marred by the same issues that undercut previous elections. As part of that effort, an assessment team was assembled to provide assistance in assessing vulnerabilities in the process. The assessment team, composed of individuals with extensive experience in the Afghan context, used the electoral integrity assessment methodology to research and evaluate past elections and prospects for upcoming polls. The results are set forth below.

The distinctions made by the electoral integrity assessment methodology between and among fraud, malpractice and systemic manipulation are especially important in the Afghan context. Emphasizing these distinctions will provide the following benefits to the Afghan electoral process:

1) By making the distinction between malpractice and fraud and tackling the two problems appropriately (and separately), the risk of unnecessarily invalidating large number of ballot boxes from the final count is reduced, which will improve the credibility of the entire process.

2) True fraud risks will no longer be diluted by or confused with issues of systemic manipulation and malpractice.

3) Appropriate, tailored remedies can be designed, implemented and assigned to accountable stakeholders.

4) Administrative weaknesses can be identified, allowing the IEC to prioritize relevant reforms and manageable improvements.

The assessment covered the following electoral process categories:
1) Legal Framework
2) Institutional Framework
3) Recruitment
4) Training and Capacity Building
5) Voter Registration
6) Electoral System and Constituency Delimitation
7) Media and Campaign Finance
8) Public Information and Voter Education
9) Infrastructure and Planning
10) Role of Security Forces
11) Election Observation and Oversight
12) Voting Operations
13) Counting
14) Adjudication of Grievances
15) Aggregation and Certification of Final Results

Bright spots on the Afghan electoral horizon include an election management body (EMB) with substantial capacity, infrastructure and resources, and a reasonably strong public information and voter education capability.

Overall, electoral administration in Afghanistan has matured over the last decade. However, as this assessment has confirmed, the election process still faces significant and wide-ranging fraud and malpractice vulnerabilities that require extensive actions by several stakeholders.

The prevailing narrative after previous elections focused on the impact of multiple voting as a result of an inaccurate voter registration process and the availability of duplicate and unreliable voter identification cards. The assessment findings show, however, that ballot stuffing not multiple voting was the main fraud vulnerability in the Afghan electoral process. Other vulnerabilities identified include gaps in the legal framework and inconsistent application of regulations and procedures; poorly-managed appointment and recruitment practices for election officials and poll-workers; a broken voter registration and identification card system; an electoral system that undermines the development of political parties, resulting in a large number of wasted votes and erosion of confidence in the process; censorship, biased content and violence influence the media; abuse of administrative resources and inconsistent application of campaign finance rules and regulations; exploitation of challenges to women's participation; fraudulent and negligent counting practices; and an unstable security environment that has implications for the entire electoral process.

During the count and aggregation process for previous elections in Afghanistan, the IEC invalidated 28 and 23 percent of the preliminary ballots cast, respectively, based on the identification of fraud “triggers.” These fraud triggers, which should have initiated an investigation and collection of corroborating evidence, were instead improperly treated as sufficient evidence in and of themselves to invalidate ballots. A major finding of this assessment, therefore, is that the categorization of all invalid ballots as fraudulent was inaccurate and served to undermine the credibility of the IEC. In actuality, a range of actors and causes were responsible for improper balloting, including interference by the executive branch of government; negligence and low skill levels of precinct workers; corrupt district field coordinators and security forces; insufficient planning and allocation of resources by the IEC; and abuse of administrative resources.

The following list provides high-level recommendations for each stakeholder based on the assessment findings. Detailed recommendations for each electoral category are included throughout this report.

### Independent Election Commission

1) Develop a fraud and malpractice control plan to deter, detect and mitigate vulnerabilities in close collaboration with Afghan election stakeholders;
2) Ensure that activities to combat malpractice and fraud become an integral part of the organization's public information and other education strategy from the outset;
3) Establish proper investigative processes and allocate a sufficient amount of resources to the count, aggregation and investigation process;
4) Consider the introduction of provincial count centers into the counting process;
5) Develop and implement improved security and tracking of results forms;
6) Improve communications strategy regarding the release of partial and final results;
7) Strengthen the District Field Coordinator (DFC) recruiting process by ensuring that hiring is merit-based only and by setting aside significantly more time for recruitment efforts to allow for a period of public scrutiny of candidates;
8) Improve DFC training and supervision;
9) Implement a more transparent poll worker recruitment process;
10) Improve training and supervision of poll workers;
11) Revise and strengthen codes of conduct for all election officials;
12) Use available data to determine appropriate provision of ballots to polling stations and processes for supplying additional ballots where needed on Election Day Election Complaints Commission;
13) Establish a clear and consistent process for filing, hearing and resolving complaints and appeals;
14) Identify and train a team of investigators on a core set of standards for election investigations Parliament/Political Stakeholders;
15) Carefully consider adoption of a new system of representation in order to reduce complexity in the electoral process;
16) Enhance the capacity of the IEC to manage the delimitation process;
17) Establish the Election Complaints Commission (ECC) sufficiently in advance of Election Day, ensure financial independence and appoint impartial and informed arbiters;
18) Launch an inclusive and comprehensive review of the 2009 Political Parties Law, with a special focus on party registration;
19) Reform the Electoral Law to:
a) Clarify the provision for reserved seats for women to ensure that it does not encourage assassination or intimidation of female candidates;
b) Clarify Article 58 on the correction of errors;
c) Require that Commissioners have specific skills and educational qualifications that ensure that electoral cases are heard by informed arbiters;
   d) Clarify the jurisdiction of each body involved in the electoral adjudication process and provide legal certainty to improve the election legal framework Security Forces;
   e) Increase awareness of the roles and responsibilities of security forces during the election process through improved training and an emphasis on values, ethos and service to the nation;
f) Consider moving the location of security officials shortly before Election Day in order to avoid dependency on local powerbrokers;
   g) Prosecute members of security forces who violate the electoral legal framework Domestic Observers and Civil Society Organizations;
   h) Improve domestic observation methodology, reporting templates and training approaches to distinguish between fraud, malpractice and systemic manipulation International Diplomatic and Donor Community;
   i) Encourage the Afghan government to ensure the legal framework is more inclusive and transparent for the 2014 electoral process; and
   j) Provide sufficient funding and other resources to ensure the successful development and implementation of an IEC fraud and malpractice control plan.

The Wolesi Jirga (parliamentary) elections previously held presented the Independent Election Commission of Afghanistan (IEC) with a range of logistical, legal and political challenges. The security environment deteriorated rapidly, with violent incidents exceeded previous levels. The IEC had less time to prepare for what was, in reality, 35 unique elections, given the varying conditions of Afghan provinces. The election management body (EMB) also had to repair a deficit of public credibility stemming from widespread allegations of favoritism and involvement in fraud in previous elections. Although the IEC made significant improvements to its ability to detect and resolve irregularities, significant levels of fraud—and the perception of fraud—once again undermined the electoral process.

Three (3) issues in particular have had wide-ranging implications for fraud and malpractice in the electoral process in Afghanistan: the unstable and pervasive security environment; the overall disregard for the rule of law; and the reinforcement of cultural norms that limit the political rights of women and make them vulnerable targets for election fraud.

The first issue is the general security environment, which negatively affects most aspects of the electoral process (and life in Afghanistan, generally). Accordingly, the deteriorating security environment in Afghanistan was mentioned by interlocutors in every meeting the assessment team held. Armed conflict has escalated each year, and violence levels reached an all-time high on Election Day. Following joint IEC-Afghan National Security Forces (ANSF) security assessments, the IEC publicly announced that it would open only limited planned polling stations due to security concerns. This trend is likely to worsen in the coming years, as suggested by the International Crisis Group report: “The commission could well conclude in 2014 that the presidential election can only be held in certain parts of the country, or at the least that significant centre closures are necessary, thus again preventing thousands of citizens in the south and the east from voting. Such an outcome would undoubtedly spark accusations of fraud and charges that election results were skewed, likely precipitating a pro-longed crisis over the transfer of power from President Karzai to his successor.”

The security environment poses a range of significant challenges to electoral integrity in Afghanistan. It has been impossible to conduct a national census and delimitation process, develop a credible voter registry or conduct nationwide voter education campaigns reaching remote areas (especially those in the southeast). The IEC and other stakeholders cannot ensure the security of candidates and election workers, especially women and candidates who are opposing local warlords/strong men. On Election Day, the Commission is unable to open as many polling centers as deemed necessary, ensure safe custody of sensitive election material or secure poll workers, polling stations or election and complaints commission offices. The security situation also results in “ghost polling stations” and selective disenfranchisement and/or barriers to access for certain regions and ethnic groups.

While the adverse impacts of a security environment hostile to democratic development are obvious in many cases, more subtle—yet no less significant—ramifications were brought to the attention of the assessment team. These include barriers to monitoring and supervising recruitment, training and voter education activities.

The security situation in Afghanistan has direct implications for the rule of law, the absence of which in turn stymies the conduct of credible elections. In addition to the insecure and unstable environment, the development of the rule of law in Afghanistan is complicated by several factors identified by the Congressional Research Service in a report: negative perceptions of the government; limited governmental capacity; existence of traditional justice mechanisms that compete with modern models; and traditional ethnic, personal or factional affiliations and attitudes. As noted throughout this report, many Afghan stakeholders view laws and regulations (both generally and specifically for elections) as formalities that can be manipulated or discarded as needed. This systemic issue has widespread and serious implications for the effectiveness of the election process governing framework, the credibility of electoral institutions, and the overall legitimacy of the election process.

Against this backdrop of insecurity and instability, women in Afghanistan face a stunning array of challenges. Afghan society affords women minimal support and safeguards for “health, deprivation of rights, protection against violence, economic productivity, education and literacy, and public participation.” The average life expectancy for women is 44 years and the fertility rate is 6.6 children per woman. Early marriages and high fertility contribute to one of the world's worst maternal mortality rates. The incidence of violence against women, including exchanging women for the settlement of disputes, is alarmingly high. All of these factors are linked to the disempowerment of women, both in the family and in Afghan society.

The Afghanistan Constitution, however, does provide for reserved seats for women in parliament. In the Wolesi Jirga (House of the People), 27 percent of seats are reserved for women (two from each province) and in the Meshrano Jirga (House of Elders), approximately 17 percent of seats are reserved for women. The Electoral Law provides that 25 percent of seats in Provincial Councils must be reserved for women. The voter registry, with all its flaws, still claims 39 percent registration of women.

However, Afghan women who decide to run for office or serve as electoral officials face extraordinary challenges arising from cultural prejudices. This often results in intimidation, violence and loss of life. Women seeking to be voters, candidates, election officials, voter educators or other electoral stakeholders face significant barriers to access to the process. The IEC reported difficulty in recruitment of female civic educators, polling officials and security personnel. Even when women were hired, they faced significant restrictions on their mobility, which impacted their ability to fulfill their responsibilities in these positions.

Women remain vulnerable not only to intimidation throughout the election campaign but also to manipulation on Election Day. Voter suppression, violation of women's free expression of will and ballot secrecy, and tactics such as ballot stuffing and use of false identification at polling stations designated for female voters are among the ploys used by local officials and political actors to perpetrate election fraud in some areas of the country. Interlocutors have also mentioned that female candidates and voters who feel their rights have been violated are less likely to register a complaint for several reasons, including intimidation, knowledge gaps and lack of support, encouragement or permission from family members. These issues require further attention from the IEC and the international community as well as forward planning to mitigate electoral fraud and the disenfranchisement of women.

Major problems that surfaced during previous elections included ballot box stuffing, multiple registrations of voters and large numbers of invalidated votes.

Ballot box stuffing, which was the primary problem, took on various forms previously. In some cases, poll workers were either coerced or bribed into facilitating ballot box stuffing in their polling stations. In other instances, ballot boxes and sensitive election material were seized by local strongmen (former members of Afghan security forces, warlords, politicians or drug barons). Due to the security situation, when some polling stations were not opened, so-called “ghost polling stations” still generated results forms and marked ballot papers. Compared to the previous elections, there was less prominent issues in more recent elections, but still sufficiently frequent to warrant concerns.

Multiple registrations of voters was also an important issue. To limit the increase in voter cards, the IEC's limited voter registration drive opened static registration centers only in provincial centers and deployed mobile, district-level registration teams over an abbreviated two-month period. Stakeholders criticized the drive for excluding many people who were unable to travel to provincial centers. More broadly, the registration system lacked any mechanism to prevent the issuance of multiple registration cards per voter or detect multiple registrations across registration drives. Without an accurate and current civil registry or census data, the IEC had no means to create reliable voter lists to mitigate voter fraud.

During the count and aggregation process for previous elections in Afghanistan, the IEC invalidated 28 and 23 percent of the preliminary ballots cast, respectively, based on the identification of fraud “triggers.” These fraud triggers, which should have initiated an investigation and collection of corroborating evidence, were instead improperly treated as sufficient evidence in and of themselves to invalidate ballots.

Both actual and perceived fraud impacted the credibility of the electoral process. The importance of transparent and open communications with the voting public cannot be overemphasized. As the United States Institute of Peace (USIP) notes in a recent special report on “Afghan Perceptions of Electoral Processes,” widely reported anecdotes about fraud made it seem even more common than it actually was, inflaming would-be spoilers and harming public perceptions of the process.

Now, as Afghanistan prepares for the 2014 presidential and 2015 Wolesi Jirga elections, the IEC must work to prevent issues of fraud and malpractice from marring the credibility of these important polls. As part of that effort, the IEC invited the International Foundation for Electoral System (IFES) to conduct an assessment and make recommendations to manage vulnerabilities in the electoral process. The following outlines the main findings of the Afghanistan electoral integrity assessment in the areas of fraud, malpractice and systemic manipulation.

The electoral integrity assessment methodology set forth above was applied in the country of Afghanistan.

In addition to the desk research, which included election observation reports, as well as documented laws, regulations, policies and procedures, the team conducted field-based research and data collection with the IEC, former Election Complaints Commission (ECC) and Provincial ECC members, civil society organizations (including a cross-section of gender organizations), political parties, representatives of security forces (including Afghan National Army and Afghan National Police) and the international donor and diplomatic community. Meetings were held in Kabul as well as in Herat and Nangarhar provinces, in order to better capture the various security and socioeconomic operational environments in which elections are conducted. A final debrief and initial findings were provided to the IEC, the United States Agency for International Development (USAID), the United Nations Assistance Mission in Afghanistan (UNAMA), the United Nations Development Programme (UNDP), the European Union (EU), the United Kingdom Department for International Development (DFID) and embassy representatives from Japan, Italy, Norway, Australia, France and the Netherlands.

The following are the detail findings and recommendations for the electoral process categories surveyed during this assessment. They are divided by the appropriate risk dimension (fraud, malpractice or systemic manipulation); in some cases where the team has determined it is appropriate, category scoring and recommendations are included for multiple dimensions.

Fraud in the election context is defined as “deliberate wrong-doing by election officials or other electoral stakeholders, which distorts the individual or collective will of the voters.” Fraud differs from malpractice on several key dimensions, including relevant actors, intent and legal character/possible sanctions. The range of possible actors is wider for fraud, as it can include any person or group with a stake in the election result. This may include voters, political parties, state officials with election-related duties, candidates and the media, in addition to election workers. The nature of the action and the presence of intent is most significant: fraud is committed deliberately and with intent to interfere with the electoral process (manifested as either an action or an omission, in the case of an actor with official election responsibilities), while malpractice results from carelessness or neglect.

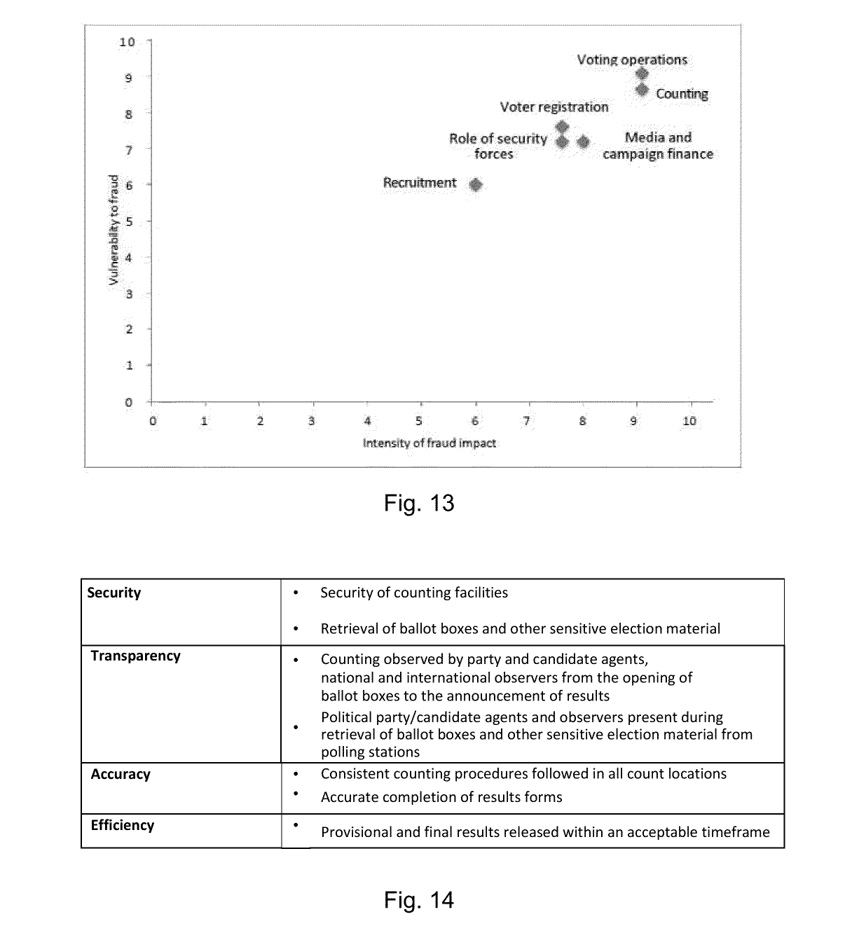

The assessment team determined that the following six (6) electoral process categories in Afghanistan are most vulnerable to fraud. They are scored in FIG. 13 according to the guidelines described in the Methodology section of this report.
1) Voting operations;
2) Voter registration;
3) Counting;
4) Role of security forces;
5) Media and campaign finance
6) Recruitment

### 1. Voting Operations

### Impact Score: 9.1

### Vulnerability Score: 9.1

a. Major Weaknesses/Explanation of Ratings

### Adherence to the Law (Subcategory Weight: 70%)

### Impact Score: 10.0

### Vulnerability Score: 10.0

The Electoral Law, as well as the IEC's polling regulations and code of conduct for election officials, clearly define the parameters under which voting is supposed to take place in a polling station. The legal framework clearly states that eligible voters are only permitted to vote in person and that election officials cannot influence individual voters' choices, indirectly or directly. There is no ambiguity as to the illegality of ballot box stuffing within the Afghan electoral process. Problems related to voting operations are clearly related to adherence to the laws, regulations and procedures governing the casting of ballots.

Given the poor record keeping during and after the tabulation of results at the National Tally Center, the assessment team has been unable to review documentation and decisions taken by various organizational entities at IEC headquarters related to official results forms. Although the assessment team cannot reconstruct the direct cause of events and apportion fraudulent behavior to various categories, we can still conclude that ballot box stuffing was the single most significant fraud category directly impacting the results in every province of the country. Thus, the real and perceived effects of ballot box stuffing undermined the integrity of the previous elections. Due to its pervasiveness and potential for impacting the overall outcome of the election, ballot box stuffing remains one of the highest concerns (only surpassed by the security environment) leading up to the 2014 elections and must be tackled effectively.

Ballot box stuffing took various forms. Based on the assessment research, the most prominent forms of ballot stuffing were as follows:
1) IEC poll workers were either coerced or bribed into facilitating ballot box stuffing in their polling station. In some instances, these ad hoc workers were hired by the District Field Coordinator because of their loyalties to a certain candidate and therefore willingly took part in the fraud.
2) Ballot boxes and sensitive election material were seized by local strongmen (former members of Afghan security forces, warlords, politicians or drug barons).
3) Polling stations never opened, but so-called “ghost polling stations” still generated result forms and marked ballot papers. Compared to previous elections, this was a less prominent issue, but still sufficiently frequent to warrant concerns. As the security situation has further deteriorated, the IEC is increasingly reliant on Afghan security forces for security assessment of viable polling centers, as well as for area and point security. Accordingly, this fraud issue could resurface and become a concern for the 2014 elections.
4) For a variety of reasons, female polling stations were particularly vulnerable to ballot box stuffing. Insufficient numbers of trained female poll workers, observers and agents, as well as cultural barriers and traditions, resulted in male proxy voting. A seriously compromised voter registration process, generating a large number of fraudulent voter registration cards without photographs, further facilitated widespread ballot box stuffing in female polling stations.

### Securing Sensitive Material (Subcategory Weight: 15%)

### Impact Score: 7.0

### Vulnerability Score: 7.0

Even before previous elections, the IEC initiated a proactive approach to safeguard against and reduce the risk of abuse of its sensitive material. Its procedures were clear and appropriate, and the polling and counting manual emphasized the importance of and how to properly handle and account for the sensitive material. The election authority made extensive use of tamper-evident bags, security seals on ballot boxes and handover forms to track both deployment and retrieval of sensitive material.

Based on lessons learned from previous elections, additional measures were put in place to further strengthen the IEC's tracking capability of sensitive material once it left Kabul. For instance, ballot papers and tamper-evident bags were supposedly barcoded and earmarked to be used only at an assigned polling center. The actual movement of polling material was also to be tracked more carefully the IEC's Field Operations Department to ensure material as not compromised while in transit.

To a large extent these new procedures were implemented and as a result the IEC had significantly better control over election materials distributed from headquarters to the provincial level even though tracking of distribution by trucks to the provincial level proved incomplete.

The introduction of a web-based retrieval management system enhanced and facilitated the headquarters' ability to track the retrieval of ballot boxes and results forms from the polling stations. As soon as District Field Coordinators (DFCs) arrived with materials from the polling centers within their respective area of responsibility, the provincial intake team logged the identifiers of the polling center and the number of results forms obtained from the center in question.

The major weakness in distribution and retrieval of sensitive material in previous elections was only partially rectified in later elections, as the control of material continued to be limited or non-existent once handed over to the DFCs. Only infrequently did provincial elections officers exercise their supervisory responsibility by verifying the work of the DFCs on the ground. The assessment team has not been able to establish to what extent provincial elections officers, or intake teams at the provincial level, noticed attempts to tamper with the results consignments. Having said that, information gathered indicates that DFCs intent on defrauding the elections engineered these efforts prior to Election Day by recruiting poll workers s/he could influence.

### Training (Subcategory Weight: 15%)

### Impact Score: 7.0

### Vulnerability Score: 7.0

Although the overall voting operation category is most susceptible to fraud, training has additional consequences for malpractice. In fact, the root cause of electoral malpractice and poll workers' inability to honor their duty of care during voting is often related to poor training. Poll workers may simply not be aware of the correct procedure, or the training offered does not give polling staff sufficient hands-on experience to properly complete the required tasks. As a result, procedures are not followed and forms are incorrectly completed.

At a first glance, the cascade-style training program designed to train more than 85,000 poll workers for previous elections was solid. IEC's Training Department as charged with three (3) critical responsibilities: (1) develop training materials to be used by trainers and poll workers; (2) train the trainers; and (3) quality control during roll-out of the training program.

The training materials used by the IEC, and in particular the training manuals, are high quality and make extensive use of illustrations to facilitate learning. In addition, the train-the-trainer program is based on modern adult pedagogical teaching techniques that enhance the learning experience by offering interactive, hands-on training exercises. In the provinces, the DFCs conduct training for poll workers within their area of responsibility. DFCs undergo a five-day training program to prepare them for their task of training polling officials. The poll workers are each officially exposed to a four-day training program in which two days are dedicated to polling and the remaining two days to counting procedures. From an international comparative perspective, dedicating four days to the training of poll workers is generous, especially for the fourth election in six years. However, given the extremely low literacy and numeracy levels in Afghanistan, extraordinary measures are required to increase the ability of poll workers to adhere to regulations and complete forms correctly.

Unfortunately, the IEC's ability to control actual adherence to the training program by DFCs as very limited. Indications are that the quality of the poll worker training program was poor, thereby limiting poll workers' abilities to perform their duties at an acceptable level. DFCs seriously curtailed the actual trainings and largely abandoned the pivotal practical, hands-on training elements and instead reverted to the ineffective lecture-style teaching methodology (see training category for additional details).

### Recommendations

Given the plethora of actors and their diverse reasons for perpetrating fraud, only a multi-pronged approach can effectively overcome the ballot box stuffing challenge. It is important to note that moving the count of ballot papers from the polling station level to provincial count centers does not reduce the risk of ballot box stuffing, as this fraud type is perpetrated before counting commences. Instead, a wide variety of measures must be initiated that include both IEC and other Afghan electoral stakeholders.

### Improve DFC Recruitment

The IEC used two different recruitment strategies for its DFCs during the previous. Leading up to the more recent election, the provincial election officers were largely in control of identifying, screening and employing the 3,000 DFCs. Due to a lack of sufficient guidelines, time and supervision from IEC headquarters, a significant number of DFCs on contract underperformed or were complicit in the electoral fraud plaguing those elections. In order to rectify those shortcomings, the IEC decided to centralize the recruitment process. The IEC Field Operations Department took the lead by developing guidelines for recruitment, terms of reference, written test and interview questions and answer keys. In addition, officers from IEC headquarters served on the recruitment panel and supervised recruitment in the field. However, in approximately 40 percent of the provinces no members of headquarters staff were present during the recruitment process. IEC also recognized that background checks—including security, education, or past performance references—were inadequate, mainly due to insufficient time.

The IEC is largely dependent on its DFCs to perform core pivotal operational tasks, such as Election Day logistics and recruitment and training of poll workers. The IEC must also recognize that one of its main vulnerabilities is the cadre of DFCs; and, therefore, needs to focus significantly more on recruitment and supervision. The recruitment process would benefit from three improvements:
a) IEC must set aside significantly more time for the recruitment of new DFCs. It is insufficient to base recruitment on the existing roster of DFCs as too many of underperformed and/or were complicit in the fraud.
b) The IEC should significantly increase transparency by publishing the names of the DFCs locally that they intend to hire before signing their contracts. This will enable a period of public scrutiny and feedback from political parties, civil society and traditional leaders.
c) Even with the improvements outlined above in place, the IEC leadership must proactively evidence its leadership and dedicate time to the recruitment and vetting of the DFCs. They must clearly show that the recruitment is merit based only. If it is not, the recruitment process will be undermined from the outset.

Improve DFC training programs through an emphasis on positive values, duty of care and the code of conduct

Until now, the training of DFCs has largely focused on logistics and practical considerations regarding their work. More emphasis must be put on values, ethos and the service to the nation performed by DFCs. Reinforcement of these positive values is an important aspect of the honor code associated with other cadre-based institutions, like the armed services, and has proven an effective tool where clearly integrated into training curricula and reinforced throughout the training program.

### Promote Effective Supervision of DFCs

Although it is important to highlight the positive ramifications associated with DFCs properly performing their duties, the repercussions of failing to conduct themselves in accordance to laws, regulations and the DFC Code of Conduct should not be underemphasized. By aggressively and immediately supervising and monitoring the work of DFCs, the IEC leadership will send a strong signal to new recruits and Afghan stakeholders that the IEC is serious about improving supervision of its staff.

The IEC eventually fired 114 DFCs for their involvement in fraud, but the organization's overall reaction to the problem was sluggish and overly lenient. A deterrence effect can only be achieved if swift actions are taken when improprieties are detected and perpetrators are appropriately prosecuted. A fast-track mechanism could be negotiated with the Ministry of Justice to expedite criminal prosecution of electoral offenders.

These changes should form an integral part of the IEC's public information strategy specifically focusing on combating electoral fraud (see the public information and voter education category for additional details).

### Improve Recruitment of Poll Workers

Recruiting almost 100,000 Afghans with sufficient literacy and numeracy skills as temporary poll workers for the first post-Taliban election proved an immense challenge. The election authority's goal at the time as to put one “sufficiently educated” person in charge of each polling station.

Massive improvements have taken place within the Afghanistan education sector. Millions of Afghans have graduated from secondary education facilities and hundreds of thousands now hold a tertiary degree. Accordingly, the pool from which the IEC can draw new recruits has drastically expanded and improved. Thus, the IEC leadership must ensure that poll workers are no longer routinely recruited from the existing dataset of former poll workers. Concerted efforts must be made to attract new groups, and youth in particular.

As with DFCs, the quality and impartiality of poll workers must improve. One of the more effective tools that can be applied toward this effort is a more transparent recruitment process. Publishing the names of presiding officers and polling center managers that the IEC intends to hire will enable stakeholder input. However, in some areas the personal safety and security of polling officials must be weighed against the desire for increased transparency.

### Increase the Number of Female Polling Day and Commission Staff

The IEC should develop a plan to increase efforts to secure adequate numbers of female staff for polling day and increase female staff at the Commission. The goal should be to continue to hire 33 percent (or more) female electoral officials in IEC headquarters and provincial election offices, in line with goals set by other Afghan governmental institutions.

### Improve Poll Worker Training and Supervision of Trainings

The problems with the current IEC training strategy are three-fold. First, the training task put on the shoulders of the DFCs is too cumbersome, as each official has a number of competing tasks leading up to Election Day. As a result, DFCs have insufficient time to properly prepare for training and trainings are often curtailed and include only the easier tasks to perform, such as how to set up a polling station and provide service to a voter. Tasks requiring more planning and more complicated training, such as counting and filling out forms, are often ignored. Second, the training program puts equal emphasis on polling and counting, even if experiences clearly show that poll workers mainly struggle with counting and completing the results forms correctly. Third, supervision of the poll worker trainings was only intermittent and therefore most instances of non-compliance to the training program went unnoticed and without repercussions.

The quality of the poll worker training could be enhanced by reducing the number of days required and focusing more on known areas of weakness. Furthermore, by conducting intensive monitoring of poll worker training during the initial phase of the training, the IEC would not only send a strong signal that this is a very important task, it would also identify shortcomings early on and therefore be able to quickly rectify mistakes and omissions.

### Increase Accountability and Effectiveness of Afghan Security Forces

Given the deteriorating security situation in Afghanistan, national security forces will continue to play an important role during the electoral process. Although many Afghan service members have performed exceedingly well under very harsh and difficult conditions, a number of them have not. In order to overcome these shortcomings, several actions can be taken to increase awareness of roles and responsibilities during elections among Afghan security forces, as well as to break their links to local strongmen. It will be equally important to overcome the sense of impunity currently existing among various security institutions.

Security forces in general and the Afghan National Police (ANP), in particular, cannot be expected to perform their respective election duties in accordance with the laws and rules if they have not been previously informed about them. In previous elections, election security training programs were initiated, but both failed due to poor implementation by the Afghan police and allegedly due to poor supervision by the European Union Police Mission in Afghanistan (EUPOL). However, it is instrumental that ANP be trained on their respective duties. The training program should also emphasize values, ethos and the service to the nation performed by ANP officers who are conducting election-related duties. These positive values are an important part of the honor code associated with traditional Afghan culture.

As the IEC has noted, it achieved the required 33% female workers level in 2010 and should seek to improve on this ratio in future election cycles.

Over the years, IEC has recognized that part of the fraud problem rests with its own staff and has subsequently fired, and on rare occasions also prosecuted, offenders. These actions have a deterrent effect that should not be ignored. Unfortunately, to date it appears that not a single security official has ever lost his job, been demoted or penalized for failing to perform while on election duty. As long as this level of impunity goes unchecked, there are very few incentives for Afghan security officials to perform at a high level.

The IEC has also resorted to moving key election officials from one province to another, or within a province, shortly before Election Day in order to break ties with local strongmen. This has proven partially effective. In discussions held with senior provincial security officials, the assessment team learned that a similar approach could prove equally effective. The officers noted that such a policy directive can only come from the very highest level within the Ministry of Interior.

### Revise and Strengthen Codes of Conduct

As election administrators, election officials have a duty of care responsibility. The duty of care refers to the degree of skill, diligence and knowledge commonly possessed and exercised by a competent election management professional in the execution of his or her duties. In Afghanistan, election officials are bound by a signed code of conduct. However, the code of conduct for every official is identical, irrespective of the specific duties required of him or her. This undermines the duty of care responsibility, as a senior election management official should have a heightened duty relative to the responsibilities of a temporary poll worker.

The current code of conduct for DFCs and poll workers need to be revised to better reflect the it respective roles and responsibilities. More emphasis needs to be put on the code of conduct during their training and ad hoc election officials need to be held accountable to the signed document.

### 2. Counting

### Impact Score: 9.1

### Vulnerability Score: 8.65

a. Major Weaknesses/Explanation of Ratings

### Counting Process (Subcategory Weight: 40%)

### Impact Score: 10.0

### Vulnerability Score: 10.0

The counting process is clearly regulated and outlined in the IEC's Regulations on Counting and its Polling and Counting Manual. The process contains several standard security features to ensure a correct and transparent counting process, including observer and agent access to opening ballot boxes, reconciliation and counting ballot papers.

The fraudulent counting problems identified below partially emanate from the vulnerabilities identified in the voting operations category, since the same individuals controlling voting operations are also responsible for the count. As a result, poll workers were either threatened, bribed or willingly produced results forms that were not a true reflection of the ballots cast in the polling station in question, or poll workers rigged the entire voting exercise and subsequently the results form reflected the orchestrated result. The dearth of observers and party agents was even more pronounced during the count, clearly limiting their ability to deter and detect fraudulent counting practices and opening up the process to abuse. It is important to note that not all problems with the count resulted from fraud. In fact, a significant problem was the substandard training and recruitment of poll workers, and processes that were poorly controlled by permanent IEC mangers (see the counting category in the malpractice section for further details).

### Results Form (Subcategory Weight: 15%)

### Impact Score: 10.0

### Vulnerability Score: 10.0

The procedures outlined in the IEC's Polling and Counting Manual clearly facilitate completion of the results form and the instructions are largely easy to follow. The results form the IEC introduced for the 2010 election has two commendable features that reduce the risk of fraud during counting and completion of the forms in polling stations. First, instead of solely writing the numerical number of votes received by each candidate, the polling official must also spell out the actual figure on the results form, thereby reducing the chance changes will be made to the forms post facto. The polling center manager is also required to put clear tape over the results section of the form, once he or she has checked the numbers for consistency.

Despite the improvements made to the results form, counting and completion of the form proved highly problematic in previous elections. The IEC reported that it was forced to order recounts and audits at approximately 3,345 polling stations based on the results forms received at the National Tally Center. Unfortunately, no clear records were kept at the National Tally Center or IEC headquarters that would explain the reasons for excluding 1.3 million ballots from the final results. Anecdotal evidence, largely based on interviews with key national and international officials actively involved in the tabulation process, clearly shows a significant part of the count was fraudulent. Specifically, the results forms were not a true reflection of the actual ballot papers in the ballot box, or the results form simply mirrored the ballot box stuffing. Given the fundamental importance of the count and completed results forms for the overall integrity of the electoral process, even a minor level of fraud could impact the outcome of the poll. Unfortunately, the single non-transferable vote (SNTV) electoral system used for the parliamentary election in Afghanistan is extremely susceptible to minor irregularities. Given the magnitude of the fraud problems during voting and counting, it is highly plausible that every single provincial race to elect members of parliament suffered from outcome determinant fraud.

It is clear that regardless of the scope of electoral malpractice and fraud perpetrated during the count, these challenges and risks were known well in advance of Election Day to IEC leadership and its technical service providers. Indeed, many improvements were made to the National Tally Center process and procedures. Still, insufficient attention was paid to the need to devise an effective mechanism to distinguish between and document incorrect results forms stemming from fraud or malpractice. This resulted in an unnecessary large number of ballot papers (1.3 million) being thrown out from the count. Although the IEC did introduce changes and made improvements to its results system management before the 2010 election, these efforts were obviously insufficient.

### External Monitoring (Subcategory Weight: 30%)

### Impact Score: 8.0

### Vulnerability Score: 7.0

As mentioned earlier, the IEC's rules and regulations allow for the presence of observers and agents during the opening of ballot boxes, reconciliation and actual counting of ballot papers. It is unfortunate that an official copy of the results form was only made available to agents and no dedicated results form was envisaged for domestic observers in previous elections. From a comparative international perspective, it is worth noting that domestic observers are increasingly receiving official copies of polling station result forms.

Due to logistical, security and financial reasons, most of the convoys transporting ballot boxes and results forms to the provincial centers, as well as onward to the National Tally Center, were conducted without any external election stakeholders present. Even if observers or party agents had the necessary organizational capability to trail these convoys, the IEC had no procedures in place to facilitate their contribution to a transparent retrieval of sensitive election material.

### Transmission of Results (Subcategory Weight: 15%)

### Impact Score: 8.0

### Vulnerability Score: 7.0

In previous election(s), ballot papers were first counted in polling stations and then results forms were transported by DFCs to provincial centers for verification of retrieval and onward transportation to the National Tally Center for results aggregation. The ballot boxes containing used/unused ballot papers were closed with uniquely numbered security seals, while results forms were transported using tamper-evident bags. Both procedures are in line with best international practices.

In order to enhance its control capabilities, the IEC introduced a new reporting system for the previous Election Day. The web-based reporting mechanism gave IEC headquarters a very good overview of polling center and polling station readiness leading up to Election Day across Afghanistan, as well as the number of centers and polling stations open in the morning (and reasons if not open). The system was also designed to generate turnout numbers at noon and at the close of polling.

The requested data was phoned in by polling center managers to DFCs, who conveyed the same information to their respective provincial office for data-entry into web-based software. Unfortunately, the system proved less than reliable as the IEC initially announced a voter turnout of 4,265,354. When publishing interim results, the turnout had jumped to 5.6 million voters. The possible reasons for this discrepancy are plentiful, although it cannot be classified as fraudulent. The problems instead resulted from malpractice, as the reporting system itself had weaknesses that made errors more likely (see the counting category in the malpractice section for details).

Reporting opening and closing times of polling stations, as well as turnout numbers at noon and at close of polls, is an effective way for the election authority to control the information flow on Election Day. Several other EMBs are using this strategy, which is widely regarded as an appropriate approach and therefore often recommended by technical assistance service providers. However, given the recent history of fraud-ridden elections in Afghanistan, the IEC could have better integrated reporting turnout into its anti-fraud portfolio. If they had collected at least one more turnout data point in the morning they could have tracked the pace with which voters were processed. This would have allowed the IEC to identify suspicious trends and would have provided an early indication of problematic locations. However, this would have required the collection of data by individual polling stations, not aggregated by polling center (as was the practice in 2010). In addition to collecting at least one additional data point, the software should also have included specially-tailored algorithms to identify suspicious turnout patterns. The latter is relatively simple but needs to be preloaded, given the number of polling stations and data points included in the dataset.

### Recommendations

1) Increase transparency of the count by providing results forms to domestic observers Domestic observers are significantly better organized than political party or candidate agents in Afghanistan. Allowing election observers to receive an official copy of the results forms would not only increase the transparency of the count, ut also strengthen domestic observer missions' capabilities to deter and detect electoral fraud.
2) Improve security and tracking of results forms. The IEC should increase the security of results forms by using tamper-evident paper, which allows attempted tampering to be easily detected. In addition, the IEC can improve tracking of results forms by ensuring they are each uniquely serial-numbered and barcoded.
3) Introduce new correction forms for changes to results. The IEC should introduce a new correction form to be used when making any changes to a results form. Only pre-authorized and specially-trained IEC officers should be permitted to use the correction forms, and their signatures should be kept on file for verification and prosecution in the case of abuse.
4) Improve results tracking mechanisms. Improved turnout and results tracking mechanisms from polling stations to the central results center could identify unusual or unrealistic voting paces and provide triggers for audits. Depending on the available cellphone network and familiarity in Afghanistan with SMS services, SMS-based systems similar to those used Uganda and Kenya could be contemplated. Based on our assessment, it is likely that such a system could be implemented in a significant number of dense population areas and therefore warrants serious consideration.
5) Carefully weigh introduction of provincial count centers to counting process

The IEC leadership informed the assessment mission that it is considering moving the counting of ballot papers from polling stations to provincial-based count centers. The main reason for this shift is to overcome the many challenges associated with the count in the previous election(s); to promote an accurate count and correct completion of results forms; and to enhance accountability through increased presence of observers and agents during count and tabulation processes. However, shifting the count to a higher administrative level also has its drawbacks. For instance, the retrieval of sensitive material (uncounted ballot boxes) will become a more valuable target, requiring additional security assets. In addition, the presence of observers and agents during the transportation of ballot boxes from polling stations to provincial count centers will be instrumental to the credibility of the results—otherwise there will be no transparency during this instrumental component of the results process.

Before such a decision is made, a thorough analysis of the benefits and disadvantages of the various options should be explored. It is the assessment team's understanding that the IEC will conduct such a review prior to finalization of its operational plan. As such, this report will only briefly discuss the strengths and weaknesses of the two options, largely from an integrity perspective. The factors to consider in the count process is shown in FIG. 14.

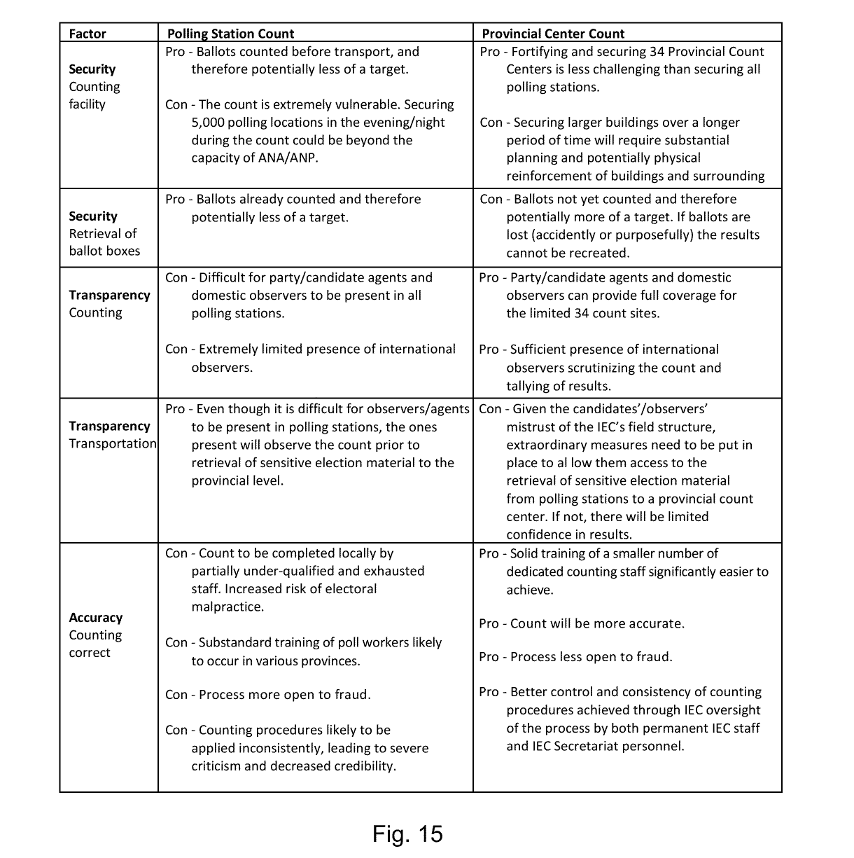

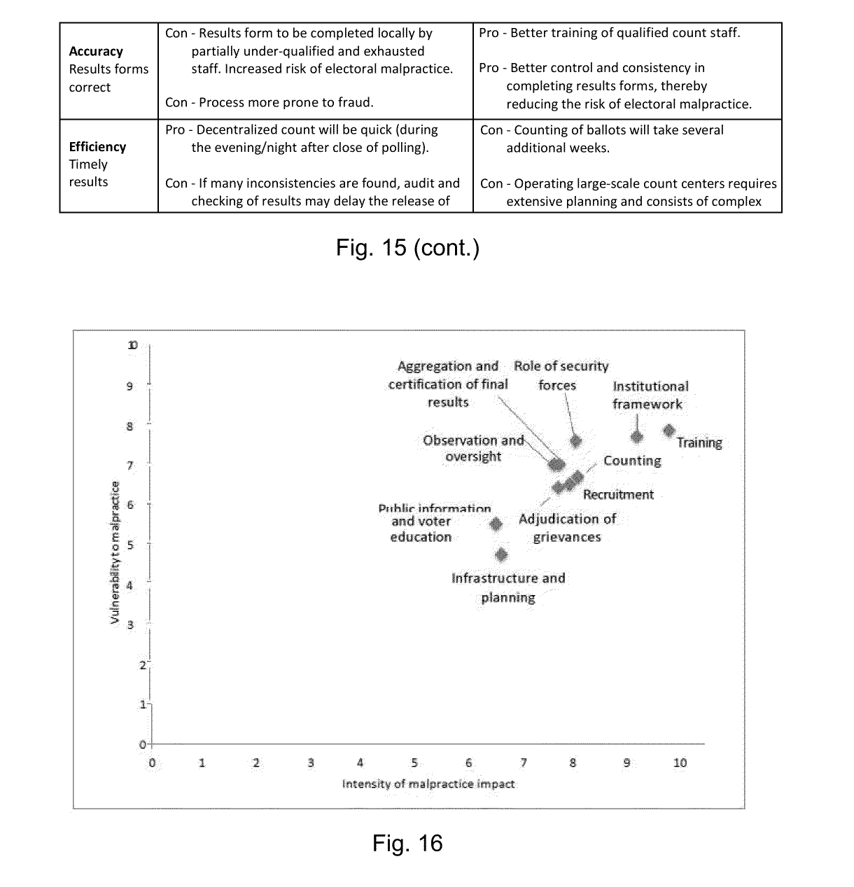

Based on these factors, FIG. 15 discusses the pros and cons of moving the count to a provincial center location in the Afghan context. Although some factors are more important than others, all need to be analyzed and considered before a decision is made on this very important issue.

While considering the factors included in FIG. 15, one need also keep in mind that actions taken (or lack thereof) by various electoral stakeholders leading up to the 2014 election can alter the analysis. For instance, should the IEC manage to significantly improve its recruitment of poll workers, strengthen its supervision of DFCs and ensure better adherence to polling and counting procedures, the risks of electoral malpractice and fraud could be significantly reduced. However, if national security forces have continued impunity, are deployed with limited understanding of their electoral roles and responsibilities and are unable to break ties with local strongmen, then the fraud risk profile of the balloting and counting process will be adversely affected. Given the complexities associated with establishing and running large provincial count centers, the IEC is well advised to dedicate significant time and resources to developing effective and transparent procedures. These will enable the IEC to run a reasonably fast counting and tabulation process, yet also allow election stakeholders accessibility to and understanding of the process for credible election results. A complete dry run of a provincial counting exercise is highly recommended, both to iron out procedural and logistical bottlenecks and to instill confidence in the IEC among political entities, media and the Afghan electorate.

### 3. Media and Campaign Finance

### Impact Score: 8.0

### Vulnerability Score: 7.2

a. Major Weaknesses/Explanation of Ratings

### Media Policies (Subcategory Weight: 40%)

### Impact Score: 8.0

### Vulnerability Score: 6.0

The media framework of Afghanistan states that the government will respect international legal principles, such as those enshrined in the Universal Declaration on Human Rights (UDHR) and the International Covenant on Civil and Political Rights (ICCPR). For example, Article 7 of the Afghanistan Constitution states that “The United Nations Charter, inter-state agreements, as well as international treaties to which Afghanistan has joined, and the Universal Declaration of Human Rights shall be respected.” Article 34 of the constitution reflects this commitment by specifically protecting freedoms of press and expression. The 2009 Mass Media Law guarantees the rights of citizens to obtain information and prohibits censorship. Despite these guarantees, the political environment is hostile to an independent media and there are road restrictions on any content that is “contrary to the principles of Islam or offensive to other religions and sects.”

Another weakness is the confusion regarding the current law; that is, because there have been several media laws approved since March 2002, many journalists are unsure which media law is in effect. Accordingly, some practice self-censorship to avoid violating cultural norms or their understanding of the law, or to ensure they are not offending local sensitivities.³⁰ Therefore, the foremost barrier at this time to the development of a robust, independent, free and trustworthy media is not the framework itself, but confusion about its meaning as well as lack of respect for rule of law in general.

Freedom House finds that the media environment in Afghanistan is “increasingly open and robust;” however, there is extensive “censorship, biased content, violence and insecurity.” In fact, the Freedom House Freedom of the Press rating for Afghanistan in 2012 as “not free,” placing the country at 164 out of the 192 nations scored. A primary driver of this lack of a robust, independent, free and trustworthy media is harassment of journalists. To confront this issue, the Afghanistan Media Defense Lawyers Committee was established in September 2011; however, its effectiveness in limiting violence and coercion has been insufficient. For example, in Mazar-e-Sharif during the previous election(s), a journalist with the Institute for War and Peace Reporting (IWPR) reported that journalists were unable to travel to some insecure districts because they faced threats in the cities if they reported on certain powerful figures alleged to be warlords or former warlords. In some instances, according to IWPR, reporters removed candidate names from their stories for fear of retribution.

In short, Afghanistan is not respecting its international commitments for an unfettered media. Average citizens do not enjoy the “freedom to hold opinions without interference,” journalists are not free to report the news without threat and coercion and citizens do not have access to trustworthy information and ideas “regardless of frontiers.”

### Campaign Contributions and Expenditures (Subcategory Weight: 60%)

### Impact Score: 8.0

### Vulnerability Score: 8.0

Political parties and candidates must raise money to conduct election campaigns and to finance political party organizations. The development of democracy is often severely undermined by scandals and rumors surrounding the sources and misuse of political money, as well as by actual vote buying. A frequent reaction to this problem is to enact regulations to control campaign expenditures of political candidates and parties. However, it is too simplistic to argue that tighter regulations are the key to eliminating corruption. Campaign finance needs to be regulated and assessed within the broader electoral integrity environment and considered along with electoral rules, culture and the system of governance. Properly constructed legislation can encourage more transparency in the reporting of contributions, reduce the influence of wealthy individuals and corporations and increase public trust in politics. To be effective, the oversight institution (e.g., the IEC in Afghanistan) must have the power to ask questions, seek documents and request interviews, not just of candidates and party officials, but also of other stakeholders with relevant information. They also need the authority to sanction individuals or groups that break the law.

With these requirements in mind, and building on the experiences of the Joint Electoral Management Body (JEMB) in 2005, the IEC created a basic campaign finance regulation system to regulate previous elections. Unfortunately, interlocutors outside of the IEC knew very little about the regulation system and nearly all cited the abuse of administrative resources and vote buying as degenerative elements of the electoral process in Afghanistan that consistently undermine the entire process. In fact, the abuse of public resources by candidates or in electoral campaigns (in support of or against candidates) during any stage of the electoral campaign is common. This occurs despite the fact that this practice is a clear violation of Afghan Electoral Law, including the unequal use of public resources by candidates in electoral campaigns and the intervention of government and state employees in the electoral process.

Specifically, Article 3, Paragraph 3 of the IEC's Regulation on Campaign Finance (RCF) Disclosure by Wolesi Jirga candidates states that “no government department can contribute to a certain candidate's campaign or provide him/her with the public resources unless equal conditions and facilities have been made available for all candidates.” In addition, Paragraph 4 of the same article states that “no one may use public resources for an electoral campaign unless Government [sic] of Afghanistan supplies all candidates with the same resources.” However, in 2010 the Free and Fair Election Foundation of Afghanistan (FEFA) “found that a number of candidates had the support of government officials. For example, candidates received support through the provision of public resources, such as government vehicles or facilities.

As with many legal frameworks in Afghanistan, enforcement of the current campaign finance regime is a serious weakness. That is, there is a general disrespect for the rule of law by candidates and voters, and the IEC has limited resources and time to dedicate to monitoring and enforcement. Regardless of the IEC's past limitations, in evaluating the effectiveness of enforcing a particular campaign finance regulation regime, there are four essential principles to consider: (i) the laws themselves must be enforceable, whereby the elements of violations are clearly defined and the governing body has the ability to gather the proof needed to enforce the regulatory regime; (ii) controls should be enforced vigorously, without bias or favoritism; (iii) the agency charged with enforcement should be independent and non-partisan, free from influences of partisan political considerations; and (iv) the penalties should be effective, proportionately dissuasive and enforced. Unfortunately, many of our interlocutors believed that the law was neither clear nor known by relevant stakeholders and that controls were not vigorously enforced. Nearly all stakeholders questioned the IEC's impartiality and credibility in this arena, due to the appointment process. Overall, the current system in Afghanistan does not meet these basic enforcement requirements.

However, based on these findings and recommendations gleaned from previous electoral cycle(s), the IEC has drafted and is in the process of adopting a new RCF. The new framework constitutes a step forward in creating a comprehensive campaign finance system in Afghanistan. On the whole, the draft regulation provides a relatively clear, basic framework for financing campaign activities and advances the effectiveness of the overall campaign finance regulation process. While many positive aspects of the draft regulation should be noted, there are shortcomings that still need to be addressed (see recommendations below).

As the current system does not meet basic enforcement requirements, even with the improvements in the regulatory regime, the immediate impact of campaign finance violations on the integrity of the electoral process is weighted higher than the weight assigned to the media environment (the previous subcategory). The lack of enforcement of campaign finance provisions in Afghanistan and the overall disregard for the rule of law makes the system very vulnerable to fraud. The potential impact on the Afghan election is significant as the misuse of political funds gives some candidates and parties an unfair advantage in the process and, in the eyes of Afghan citizens and the international community, this practice greatly undermines the credibility of elections.

### Recommendations

1) Continue to Support the Creation of a Free and Independent Media that Will Function after Donor Support has Ended.

There are a significant number of international implementers providing technical assistance to national and local media groups in their efforts to become free, unbiased and independent. These efforts obviously need to continue. However, well in advance of the next election, training and technical assistance provided should include modules that focus on how to cover elections in an informed and unbiased way and how to play a positive role in protecting the integrity of the electoral process. This training should also focus on the use of the Internet and wireless technologies to reach audiences with unbiased and trustworthy information about the electoral process.

2) Support and Train Journalists in Investigative Reporting Techniques with a Focus on Elections.

In addition to the overall media training as outlined in the recommendation above, the international community should fund training programs for independent journalists in investigative reporting techniques, with a focus on electoral integrity and responsible reporting on election issues. This will promote the role Afghan media can play in deterring, detecting and reporting on cases of electoral fraud and malpractice. Technological solutions could also be introduced to allow journalists to support the investigative work of election administrators. In coordination with the media and other stakeholders, the IEC and ECC could introduce an SMS-based system to monitor, map and immediately investigate fraud allegations supported by probable cause.

3) Reform the 2009 Mass Media Law.

The Wolesi Jirga should ensure that mass media laws are unambiguous, transparent, require unbiased reporting, protect journalists from coercion, respect international legal principles and include effective remedies for violations of the law.

4) Maintain IEC Operational and Financial Independence.

The more effective control mechanisms are, the more resistant the regulated community (in this case, politicians, political parties and candidates) becomes to accepting strong oversight from an independent body. Therefore, the IEC's mandate should be strengthened to allow it to properly fulfill its supervisory function (i.e., by vesting it with greater powers to obtain requested information and explanations and to review financial reports). In particular, the IEC should be given the power to monitor bank accounts and conduct audits of financial reports submitted by candidates and parties. The process for conducting such audits should be stated in relevant legislation and regulations.

Additionally, as financial regulation is susceptible to discrimination or biased actions by regulatory bodies, the RCF should specify the process and procedures to determine how and which reports are selected for review and referral to other enforcement agencies. In all cases it is necessary that reviews be nondiscriminatory and objective in their application.

5) Strengthen Key Provisions of the RCF and the Enforcement of the Electoral Law.

To promote both comprehensiveness and consistency of various legal provisions dealing with campaign finance in Afghanistan, the general electoral framework containing key regulations for campaign finance should first be outlined in ordinary legislation (e.g., the Electoral Law). The law should be supplemented by detailed campaign finance regulations adopted by the IEC and ECC. The current election law related to campaign finance is very weak in Afghanistan, relative to the legal provisions made by other countries around the world. Although the IEC has issued regulations to supplement the gaps in the law, absent a stronger election law, these regulations could be legally challenged by parties and candidates. A stronger legal foundation could also function to strengthen the credibility of the IEC's regulations and promote the idea that they should be taken seriously by other institutions.

The draft IEC RCF would benefit from adjustment of the provisions to differentiate among three levels of elections. The IEC should allow for variations among funding levels, complexity and sophistication of political campaigns for national and local elections (e.g., presidential vs. provincial). For example, financial operations during presidential campaigns might create the need for more complex interventions and more robust monitoring and enforcement.

Serious consultations should take place between the IEC, the Ministry of Justice, civil society and political parties and candidates regarding the enforcement regime. The IEC should also strengthen cooperation with other bodies (e.g., ECC and the High Office of Oversight for Anti-Corruption). A fair, flexible, yet workable enforcement process is the core of any campaign finance law's effectiveness. The experience of other countries around the world shows that many violations of campaign finance rules are committed as a result of ignorance, negligence, misunderstanding or mistakes. Those types of administrative offenses can be pursued in Afghanistan by the IEC, with the usual penalty being that the offending transaction must be returned; the missing information must be sent to the IEC; and the candidates are required to pay a small monetary penalty. On the other hand, purposeful and financially significant violations of the law, committed by offenders with precise knowledge of what is required or forbidden, should be subject to more serious sanctions where merited, such as criminal prosecution. Finally, oversight, public control and disclosure requirements should extend to the periods before, during and after the elections.

6) Within the RCF, the Campaign Finance Reporting Regime should be Clarified and Strengthened.

Reports on campaign financing should be submitted to the IEC within a specified deadline of no more than 30 days after the elections. Such reports should be required not only after the elections but also during the campaign period for presidential candidates. In an effort to support transparency, it is good practice that such financial reports be publicly available on the Internet in a timely manner. The IEC should also provide suitable facilities for public examination of reports and permit copying/photocopying at a reasonable cost and in a convenient manner.

To be effective, the IEC must have the authority to review financial reports and records. This role is absolutely necessary in monitoring compliance and detecting violations. However, due to time and resource constraints, it is likely that only a limited number of candidates' financial reports can be properly audited. Random checks for accuracy in financial reports, in particular, can be a powerful deterrent against violations. This raises the question of how a report should be selected for review or audit. The IEC can sample reports via random audits and/or conduct audits for cause. If audit targets are to be determined for cause, a set of specific criteria that triggers audits should be developed and specified in the RCF in order to eliminate bias against any particular candidate. Of course, when determining the breadth and depth of these audits, the IEC's financial and human resources must be taken into account. It is suggested that IEC officials travel to Mexico to be trained by the Mexican Federal Electoral Institute on appropriate audit and prosecution processes.

7) The RCF should Ensure that Contribution Limits Apply to Candidates' Personal Funding Sources, and Political Party Contributions and that Administrative Resources are Equally Available to all Candidates.

Contributions to their own campaigns by candidates are often perceived to be free from the negative impact of possible corruption or undue influence. However, the source of these personal contributions may in fact be corrupt practices and/or may be used to improperly influence government officials, the media and other independent bodies that have a role to play in the electoral process. Therefore, campaign finance regulations may limit and require disclosure of such personal contributions during the campaign period. It is also appropriate to require that candidates file a public disclosure of assets and liabilities. However, errors in disclosure reports should not be used as a basis for denial of candidacy. In addition, regulatory provisions should allow for political party contributions to support their candidates, with appropriate reporting requirements.

Moreover, Article 4, Section 3 of the draft RCF states that: “No government department can contribute to a certain candidate's campaign or provide him/her with the public resources or use these resources unless equal conditions and facilities have been made available for all candidates.” This provision of the RCF should be extended to prohibit the use of funds gained through illegal activities (as per Article 63, Section 15 of the Electoral Law); contributions from public companies; disguised contributions; and requirements that public employees (civil servants) make payments to particular political parties. These practices should be prohibited as abuses of state resources.

Finally, the IEC and ECC, working in coordination with the Ministry of Justice, must design an effective mechanism to prosecute government officials who abuse state resources to support particular parties or candidates. Government officials should be aware that, if they violate the law, they will be prosecuted and punished under relevant penal codes.

8) The Draft RCF should Seek to Strengthen Compliance with IEC Regulations by Requiring Regular Training of Candidate Financial Agents on Reporting Procedures.

The draft RCF regulations should require financial representatives of all candidates to participate in IEC training on financial reporting procedures. The IEC has a positive history of organizing trainings and consultations for financial agents of presidential candidates (similar training was conducted in the previous election(s)). There are at least three reasons for institutionalizing this training program: to decrease the number of minor offenses resulting from a lack of experience and misunderstanding of the law and regulations; to promote desirable behavior and approaches by candidates (educating candidates about their role in the process and helping them interpret their place within the general provisions of the framework); and to promote transparency and impartiality of the IEC's own actions. The IEC should also denote attention to the development of guidelines and training materials to be used in these trainings. Thus, candidate training, public education and awareness campaigns are particularly critical elements of any serious enforcement strategy.

9) Scale-Up Citizen and Civil Society Organization Monitoring Activities.

The IEC and domestic campaign monitors should widen the scope of their observations to monitor pre-campaigning and other campaign violations. The IEC needs to encourage the involvement of monitoring and watchdog organizations from civil society to better monitor candidates and parties.

After Election Day, monitoring should continue as the ECC receives cases from the IEC regarding candidates who violated campaign finance disclosure provisions. The ECC must review and adjudicate these alleged violations, and citizen groups should monitor and report on this process until they are fully adjudicated and resolved.

### 4. Voter Registration

### Impact Score: 7.6

### Vulnerability Score: 7.6

a. Major Weaknesses/Explanation of Ratings

### Voter Registration Methodology (Subcategory Weight: 60%)

### Impact Score: 8.0

### Vulnerability Score: 8.0

The voter registration system in Afghanistan is broken and cannot be fixed in time for the 2014 election. In fact, Afghanistan has never had a workable voter registration system; the process introduced in 2003 had such grave methodological problems that the system could never (even in theory) have generated a clean voter registry with voters allocated to unique polling stations. As the IEC has continued to build on this flawed system, subsequent voter registration drives have further compounded the problem while churning out new voter registration cards with almost no security features or ability to tie voters to a unique polling station.

Recently, the Government of Afghanistan (GoA) ordered the IEC to replicate the 2005 and 2010 top-up model, which will formally enable first-time voters to register, returnees to take part in the poll and offer people who lost their voter registration cards an opportunity to obtain a replacement card. This voter registration program will add an additional 4 million cards to the approximately 17 million already distributed.⁴³ However, it will not improve the quality or accuracy of the voter registry. In fact, this upcoming voter registration drive will actually be counterproductive, further fueling the argument that the integrity of elections in Afghanistan is so compromised that acceptable elections are not feasible. The more than 21 million voter registration cards that will be in circulation after this latest drive will vastly exceed the estimated size of the electorate (approximately 12 to 13 million), providing ample fodder for spoilers. Undoubtedly, voter registration cards will constitute a very real and significant threat to the integrity of the Afghan elections by creating the appearance of impropriety. The IEC will face formidable credibility challenges in the eyes of the electorate and other stakeholders. Additionally, the fact that voter registration lists are not used in polling stations further facilitates fraud by individuals holding more than one voter registration card. Hence, the vulnerability for fraud due to a non-functional voter registration system is very high in Afghanistan. It is important to note, however, that high fraud vulnerability does not automatically translate into actual fraud.

### Multiple Voting (Subcategory Weight: 40%)

### Impact Score: 7.0

### Vulnerability Score: 7.0

Based on previous analysis of the voter registration processes and methodologies used since 2004, several potential fraud categories can be distilled. The more prominent and frequently mentioned fraud risks associated with the voter registration deficiency are:
1) Eligible voters voting more than once;
2) Non-registered voters;
3) Underage voting;
4) Proxy voting
5) Family voting

The problems of underage voting and so-called “family voting” are not directly linked to the poor voter registration methodology. Voting by teenagers and families should be prevented by presiding officers at polling stations, as neither practice is permitted by the legal framework or polling procedures. In other words, these vulnerabilities can be addressed even under the existing conditions as they are not directly related to voter registration, but rather to how polling stations are operated. These are training, enforcement and voter education-related issues.

Given the proliferation of voter registration cards and the ease by which Afghans can obtain multiple, genuine cards for free, the incentive to purchase fake voter registration cards is probably relatively limited. However, whether an Afghan is holding several official IEC voter registration cards, or a mix of real and counterfeit cards, is largely immaterial, as the system has no mechanism to distinguish between genuine and fake versions. Poll workers and presiding officers are not, for instance, trained on how to differentiate between the two types of cards.

Proxy voting, eligible individuals voting more than once and non-registered Afghans voting are largely variations on the same vulnerability: multiple voting. The main concern, however, is the extent to which a significant number of individuals are able to vote multiple times on Election Day and thereby capitalize on the dysfunctional voter registration system to affect the outcome of the election.

Afghans who fulfill the eligibility criteria basically face no obstacles or challenges to registering more than once, as the only safety mechanism currently in use against multiple voter registration is indelible ink. During 2004 and 2005 registration drives, the ink was not even part of the registration methodology, rendering the process extremely vulnerable to abuse by eligible voters. The introduction of indelible ink during more recent registration drives was, to a certain extent, a reasonably effective local deterrence and detection mechanism against voter registration fraud, as it prevented people from registering more than once during the specific registration drive in that district. However, as the voter registration methodology used has been a prolonged nationwide exercise spanning many months, the indelible ink inevitably wears off, enabling eligible voters to obtain multiple registration cards. As mentioned above, the upcoming registration drive will suffer from the very same strategic flaw.

However, the main question here is not whether a substantial number of eligible voters own multiple registration cards, but if they are able to vote more than once. The IEC has been using election-specific hole punch tools to mark used cards. Unfortunately, in previous election(s) the hole punches proved to be of uneven quality and failed after limited usage on Election Day in various polling stations across the country. Regardless, even if the hole punch tools had worked for the duration of the day, voters could still have voted in multiple polling stations by simply using a different registration card.

Indelible ink has de facto become the only deterrent against multiple voting in Afghanistan, as polling stations lack unique voter lists. Unfortunately, in spite of the procurement of ink of the highest quality and with specifications in line with international best practice, the IEC continues to struggle to instill confidence in stakeholders about its effectiveness. This issue stems from mistakes made by the JEMB Secretariat during the 2004 presidential election, when poll workers sometimes mistook regular marker pens for the marker pen-style indelible ink dispenser and as a result voters were able to remove the ink.

It is worth noting that in cases where high-quality ink is properly stored, applied and allowed to dry on the voter's finger, the indelible ink actually represents a generally sufficient deterrence against multiple voting. It is by no means foolproof, but certainly plays a significant role in reducing fraud on Election Day in many countries. However, as long as the IEC continues to pay relatively limited attention to restoring election stakeholders' confidence in the usage of indelible ink, one of the best safeguards against multiple voting in Afghanistan will remain ineffective. In previous election(s), the IEC only paid scant attention to restoring the public's confidence in the ink.

Another important factor to consider is the safety of the voters. A significant reason why eligible voters abstain from participating in elections is a concern for their personal safety and security. One concern is the risk of attacks directed at polling stations, but another factor of significant importance is the risk of retribution against voters after Election Day. The most noticeable proof of participation in the election is the purple, inked finger. In other parts of the world where voters fear retribution for taking part in the election, invisible ink has been used instead of indelible ink. Invisible ink only becomes evident under a UV lamp, which polling stations must have in order to spot individuals who have already voted. It is plausible to assume that some voters who fear for their security would be more likely to take part in an election if the IEC uses invisible rather than indelible ink. This is especially true for the so-called “Pashtunelt,” here more than three-quarters of the population surveyed express fear of voting in the national election.

However, several additional factors need to be considered before retiring the IEC's current ink solution. Even though improvements have been made to the UV-lamps required to screen voters at the polling stations, the lamps remain somewhat fragile and add additional costs to an already expensive electoral process. Furthermore, introducing a new and more sophisticated ink solution would require additional poll worker training. It is also important to note that invisible ink does not contain silver-nitrate and thereby can more easily be washed off.

The main challenge to the invisible ink's effectiveness is the action required by the IEC to convince the electorate to participate in the elections in spite of their security concerns. The invisible ink would only work as a confidence-building mechanism if voters are aware that it will be used on Election Day. Communicating this new feature to a large number of prospective voters takes time and resources, and also provides potential spoilers an opportunity to obtain UV lamps and thereby undermine the entire effort. These lamps are available in Pakistan and can therefore be quickly transported to Afghanistan and used in public relations campaigns by anti-government elements.

These risks and additional costs could potentially be contained if invisible ink were only introduced in the most volatile provinces and made public close to Election Day. Although this would require a dedicated under-the-radar information campaign for affected provinces, additional inserts in affected poll worker manuals and a more complex procurement and packing effort for polling station kits, it is still feasible. Importantly, however, introducing invisible ink that is washable could be misconstrued as facilitating fraud in the Pashtun belt. In addition, varying the use of invisible and indelible ink in different parts of Afghanistan would violate one of the most fundamental principles of election administration uniformity. Irrespective of where a vote is being cast, the same process needs to be followed in order to avoid politicizing the exercise.

In spite of all the criticism raised against the voter registration system and the significant risk of fraud by voters abusing the system by voting multiple times, the largest domestic observer group found very limited proof of multiple voting during the previous election(s). The reasons could be numerous. For example, in rural areas, moving between villages is costly and, given the rudimentary infrastructure, also takes a significant amount of time. Queuing and transportation to polling stations also reduce the number of hours available to individuals to vote multiple times. Furthermore, due to the social cohesiveness of local communities, it is sometimes difficult for strangers to appear at a polling station to cast a vote without causing suspicion and being questioned. However, one special form of multiple—voting is prevalent in a large number of provinces in Afghanistan: proxy voting by men in omen's polling stations.

The prevailing challenge for combating proxy voting is the cultural barrier against the participation of women. Often women are only able to interact with other women, requiring the IEC to recruit women to work as civic educators, members of voter registration teams, security officers charged with frisking women waiting in line to vote and poll workers. At every step of the process, the IEC faces enormous recruiting challenges. The past decade has undoubtedly generated a pool of young, literate women from which the IEC could recruit workers. However, cultural barriers are still formidable, effectively barring women from casting their votes and facilitating fraud through proxy voting. Female polling stations are sometimes staffed by men who represent the patriarchal system and regard it as an acceptable practice for men to vote on behalf of the female members of their households. When that is the case, indelible ink will not be an effective fraud deterrence mechanism.

### Recommendations

A clean and complete voter registry, generating unique polling station lists, would be an effective tool against multiple voting on Election Day. It is important to stress, however, that the main fraud vulnerabilities in the Afghan election process are not directly linked to the dysfunctional voter register, but rather to the IEC's inability to recruit and train poll workers who will follow polling and counting procedures across the country.

Still, the faulty and widely abused voter registration system is detrimental to the credibility of the overall electoral process and must be tackled on multiple fronts. It should be addressed well in advance of Election Day.

1) Conduct Outreach to Regain Public Confidence in the Indelible Ink Mechanism.

The first and best opportunity to regain the public's confidence in the indelible ink mechanism is during the upcoming voter registration drive. The IEC should educate and include political parties, civil society, media representatives and traditional and religious leaders throughout the process. Representatives from these groups should form an integral part of the entity discussing the type of ink to procure, the applicator to be used and the application method. Members of this group should be encouraged to take ownership of the process, and participate in visits to the factory producing the ink. Resources should be allocated to conduct independent testing at offsite laboratories to ensure the ink procured meets international specifications. Once procured, it is not sufficient for the ink to be tested on the finger of the Special Representative of the Secretary General of the UN (SRSG) at a press conference one week before Election Day; instead, ink application should be demonstrated for rural communities, at least on a district level. Displays of the ink's efficacy in every district will help the IEC to regain public trust in one of the most important safeguards against multiple voting in Afghanistan. However, the IEC should not represent the indelible ink mechanism as a foolproof system. The use of the ink is an important component of a larger strategy to strengthen and improve the integrity of the election process.

2) Use Available Data to Determine Appropriate Provision of Ballots to Polling Stations and Processes for Supplying Additional Ballots where Needed on Election Day.

In previous election (2), the IEC decided to reduce the number of ballot papers in each polling station by providing 600 ballots and disallowing polling stations from borrowing additional ballots from nearby locations. The new process required that the provincial office, after receiving approval from IEC headquarters, dispatch a new polling station team to establish a new polling station at the same location. According to FEFA, on Election Day, when polling stations reported a shortage of ballot papers, the IEC frequently struggled to react swiftly enough. In other cases, polling stations that should most likely have received fewer than 600 ballots were entirely disqualified for fraudulent use of excess ballots.

The challenge of providing a sufficient number of ballot papers where needed while reducing the abuse at other locations is an extremely difficult problem to resolve without a reasonably accurate voter registry. With improved command and control capability and use of a more sophisticated Election Day reporting mechanism (see counting category for details), the IEC can better track turnout patterns at polling stations and identify anomalies early in the process. The IEC also has turnout data from four previous elections and, although the data is far from perfect, they should be able to analyze it and distinguish two categories of polling stations: polling stations where turnout traditionally has been low and polling stations with a tradition of higher turnout numbers. It may not be necessary to supply even the first category of polling stations with 600 ballots; 400 may be sufficient.

The remaining ballots will be kept by the polling center manager who will be authorized to issue additional ballots only with the approval of the provincial elections officer, who must first verify recent turnout numbers with the IEC headquarters—the office charged with tracking turnout numbers before authorizing the release. The presiding officer and polling center manager must sign a specific form justifying these additional ballots. This document must then be included in the tamper-evident bag with the results form for scrutiny at a higher IEC level. Although it is far from an ideal system, experience has shown that introducing administrative paper trails reduces fraud, as it gives officials under duress an opportunity to explain to the orchestrators of the fraud why s/he cannot accommodate their demands. However, this mechanism will only be effective if it is emphasized repeatedly during training and later actually enforced. In addition, in genuine cases where polling stations are running out of ballot papers, the solution is actually implementable.

3) Consider More Flexible Hours at Female Polling Stations to Reduce Proxy Voting.

In less conservative areas of Afghanistan, women are more likely to be allowed to work as polling officials if they are able to return to their homes before dark. Policies for female polling station hours should take this issue into account. By introducing some flexibility in the hours, it is more likely that women will be able to operate the polling stations. This should encourage more women to come out to vote. Anecdotal evidence has also shown that where there are voters waiting in line, the risk of abuse could potentially be reduced as the number of witnesses is higher and thereby the risk for perpetrators increases. However, given widespread impunity in Afghanistan and the low standing of women in the court system, this mitigating factor's potential is probably only nominal.

4) Engage with Relevant Authorities to Pursue Criminal Violations.

To ensure the credibility of the election process—both in principle and in the eyes of the public—the IEC needs to engage with the Ministry of Interior and secure assurances from them and the prosecuting authorities that they will make voter registration and electoral fraud a priority. The first step for the relevant authorities would be to arrest and prosecute owners of more than one voter registration card or of illegal election material.

### 5. Role of Security Forces

### Impact Score: 7.6

### Vulnerability Score: 7.2

a. Major Weaknesses/Explanation of Ratings

During this assessment mission, interviewees pointed out that as with other Afghan agencies, integrity and election-related violations were observed among security forces. During the previous election(s), observers noted direct involvement of security forces in the manipulation of polling operations and cooperation with local power brokers.

### Professionalism of Security Forces (Subcategory Weight: 40%)

### Impact Score: 8.0

### Vulnerability Score: 7.0

The performance of security personnel during the previous election(s) was mixed. While observer groups reported that ANSF personnel succeeded in mitigating voter fraud in some places, they also witnessed attempts by ANSF to manipulate polling station closures either before Election Day or by force on Election Day. Other observers noted ANSF involvement with local power brokers. For a more detailed discussion on this subject, please refer to the role of security forces category in the malpractice section of this report.

### Election-Specific Training (Subcategory Weight: 10%)

### Impact Score: 4.0

### Vulnerability Score: 4.0

The assessment team learned from interlocutors that security forces, in some cases, played a positive role in fraud mitigation. However, specific examples were not provided. According to NDI, in some cases, polling officials and security forces reacted quickly to prevent illegal voting and arrested those using fake ID cards. NDI further says it would be difficult to determine how widespread and successful such interventions were.⁵² Increased training would likely only be useful for fraud mitigation if greater accountability and professionalism were first instilled in the security forces with election responsibilities. For this reason, this subcategory has been scored as less vulnerable and impactful than the other two subcategories making up the overall category. (For more information, please refer to the role of security forces category in the malpractice section of this report).

### Accountability (Subcategory Weight: 50%)

### Impact Score: 8.0

### Vulnerability Score: 8.0

While public confidence in the ANSF is high overall, the prevalence of corrupt officials at all levels of government present challenges to improving both the performance and perception of the ANA and ANP.⁵³ As discussed in the role of security forces category in the malpractice section of this document, mechanisms for effective remedies were not employed in a transparent manner to address violations by security forces. Provincial Reconstruction Team (PRT) officials reported that ANSF officers had no recollection of punitive actions taken against officers accused of influencing the elections. Likewise, many had no recollection of complaints.

### Recommendations

1) Hold Security Forces Accountable to Codes of Conduct and Relevant Regulations and Laws.

Just as civilian electoral stakeholders such as election officials are held accountable for their adherence to a code of conduct and regulations, security forces should be held to a similar standard. The rotation of security forces away from their home areas and the maintenance of a roster of individuals facing complaints would also go a long way in ensuring accountability. A clear and unambiguous commitment in words and actions from the top leadership of security forces would send a strong signal to the forces under their command, as well as to Afghans at large, that the upper echelon of the armed forces is serious about addressing the shortcomings identified above.

### 6. Recruitment

### Impact Score: 6.0

### Vulnerability Score: 6.0

a. Major Weaknesses/Explanation of Ratings

As detailed in the recruitment category in the malpractice section of this report, competent, neutral, professional and enthusiastic poll workers form the backbone of Election Day operations. In the absence of a large nationwide civil service, the IEC must draw on an extensive cadre of temporary staff for each election. This is one of the largest recruitment drives in Afghanistan. Nepotism and corruption played a significant role in previous recruitment processes in Afghanistan, and interlocutors in practically every meeting the assessment team held highlighted the role of DFCs in recruitment as a major factor in both malpractice and fraud. Interlocutors at meetings outside of Kabul especially highlighted the candidate DFC nexus, which seemed to be a well-known cause of fraud. This category section focuses on fraud arising out of a compromised recruitment process.

### District and Subdistrict Poll Workers (Subcategory Weight: 80%)

### Impact Score: 7.0

### Vulnerability Score: 7.0

In the assessment team's meetings with stakeholders in Afghanistan, conversations highlighted widespread allegations of fraud committed by polling station staff and DCFs in previous elections, both as a result of intimidation and bribery. Interlocutors detailed how candidates and their supporters who wished to commit fraud began influencing the recruitment process. While the solicitation for applications for field positions seems to be quite open, the selection process itself appears to have been rather opaque. Many interviewees, including former DFCs, mentioned candidate interference in the hiring process, with large sums of money changing hands. The phrase “purchasing DFCs” as frequently mentioned. One former DFC said that he noticed some of his colleagues were called by their candidate patrons so often on Election Day that it became impossible for them to conduct their duties.

In addition, the absence of female staff during registration and on Election Day likely has an impact on female voter turnout, which can be exploited by stakeholders to commit fraud. For a detailed description of the issues related to the recruitment of district and subdistrict poll workers, please refer to the recruitment category in the malpractice section of this report.

### IEC (Subcategory Weight: 20%)

### Impact Score: 2.0

### Vulnerability Score: 2.0

The general perception of the permanent staff of the IEC is that they are not highly vulnerable to fraud. However, the neutrality of the large number of tally center staff was definitely questioned by various stakeholders in our meetings. Based on these findings, this subcategory has been accorded a relatively low impact and vulnerability score.

### Recommendations

Several of the following recommendations are also featured in the recruitment category in the malpractice section of this report, as they are relevant for deterring, detecting and mitigating both fraud and malpractice.

1) Improve Transparency of Recruitment Policies and Practices.

Strict recruitment policies and procedures should be developed, publicized widely and adhered to, including the establishment of an independent monitoring program for the recruitment process that directly provides reports to the Commissioners and the Chief Electoral Officer (CEO). The IEC should also invite election observer groups to observe the recruitment process. The names of selected DFC and polling center manager candidates should be announced publicly prior to signing their contracts, giving other stakeholders an opportunity to provide feedback to the IEC if they have major concerns about their neutrality or competence.

2) Increase Performance Accountability for DFCs and Poll Workers.

The IEC should implement a performance evaluation process for DFCs and poll workers that allows it to blacklist problematic staff and find ways to identify them clearly to prevent inadvertent rehiring.

3) Improve and Enforce Codes of Conduct for all Election Staff.

Codes of conduct should become increasingly complex and require a higher level of duty of care from poll workers to the Commission level. Some interlocutors recommended that all election officials should be required to take an oath on the Qur'an and the constitution and sign the code of conduct in public ceremonies. Strict penalties for violation should be put in place and enforced.

4) Rotate DFC Placements.

To ensure neutrality and reduce opportunities to commit fraud, the IEC should rotate placement of DFCs to different provinces (or at least different districts) from their hiring location/residence.

### V. Malpractice Assessment

Malpractice is defined as “a breach by an election professional of his or her relevant duty of care, resulting from carelessness or neglect.” Specifically, malpractice involves misconduct and mistakes committed by poll workers, other ad hoc election personnel and election officials, usually due to a lack of knowledge, skill or diligence. As noted in a 2011 IFES white paper, “When election professionals are negligent, they have committed malpractice, not fraud.” As the definition states, malpractice involves the breach of a duty of care, a concept that “is sufficiently nuanced to distinguish among election workers at different levels and with varying levels of education and training, such that the commissioner of an EMB would have a much different duty of care requirement than a poll worker appointed on an ad hoc basis. Duty of care is a concept familiar to many professions, especially those governed by a professional association (such as doctors). It has not been frequently attributed to election professionals, although there does exist a growing body of consensus about what constitutes appropriate professional behavior for election officials.”

The duty of care concept, and accordingly the finding of malpractice, can be derived from EMB establishing legislation. It should be part of the codes of conduct and training and professional development programs provided to all election officials (including permanent and ad hoc workers).

The assessment team determined that the following ten (10) electoral process categories in Afghanistan are most vulnerable to malpractice. They are scored in FIG. 16 according to the guidelines described in the Methodology section of this report:
1) Training and capacity building
2) Aggregation and certification of final results
3) Institutional framework
4) Adjudication of grievances
5) Role of security forces
6) Observation and oversight
7) Counting
8) Infrastructure and planning
9) Recruitment
10) Public information and voter education

Although the scoring and narrative assessments herein are focused mainly on malpractice and duty of care of election officials and security forces, many of the problems identified may also have implications for fraud or provide openings for other electoral stakeholders to manipulate the electoral process. This is noted where relevant.

### Impact Score: 9.75

### Vulnerability Score: 7.85

a. Major Weaknesses/Explanation of Ratings

The ability of an election commission to deliver a credible election is directly linked to how well its personnel at the central, regional and polling station level understand and discharge their duties. Strong training and capacity building programs must be at the center of efforts to deter or mitigate electoral malpractice. The impact of any weakness in this area has been reflected in many of the categories highlighted in this report, including voter education, election planning and operations, counting, aggregation of results, security and adjudication of grievances.

At the headquarters level, the IEC has a strong training division that in 2010 used detailed plans to function within relevant time and budget constraints to train a cadre of over 100,000 poll workers. While the gap between the training plan and performance could be attributed to the capacity of trainees, especially at the lower levels, and a recruitment process heavily influenced by nepotism, it was evident from the data collected and analyzed by the assessment team that the quality of training, especially as it was delivered at the lowest tiers, led to a significant amount of malpractice. Insufficient command and control of poll worker trainings by IEC provincial offices added to the substandard training level and further contributed to malpractice. This category specifically focuses on the IEC. Training of voter educators, security forces, complaints investigators, observers, candidate agents and media are also extremely important and have been included in their respective categories.

### Mandate and Capacity of the EMB (Subcategory Weight: 50%)

### Impact Score: 10.0

### Vulnerability Score: 8.0

IEC training capacity at the headquarters level is strong. However, for the reasons presented above the quality of cascade training decreases as it progresses down the hierarchy to the polling station level. Thus, vulnerability and possible impact of malpractice issues relative to EMB training capacity are very high.

The underlying purpose of capacity building is to assist beneficiaries/partners to take control and ownership over their mandate; better perform their responsibilities; and sustain activities, outcomes or institutions. In the case of the IEC, this translates to:
1) Strategic planning
2) Transparent decision making processes
3) Consultative mechanisms with a range of electoral stakeholders
4) Institutional structural development or change to reflect legal and constitutional requirements
5) Substantial changes to electoral laws and regulations and funding processes
6) Human development (skills, education, experience) of staff
7) Acquisition of materials and equipment to do the job more efficiently
8) A strong sense of purpose and vision through exposure to similar organizations and professional associations
9) The development of systems and processes to provide for institutional sustainability despite individual staff turnover
10) Opportunities to pursue academic degree programs
11) Study tours and networking with EMBs and associations of election professionals
12) Infrastructure and commodities support

Due to intense election activity and the need to focus on election preparations and implementation—as well as changes to the timing of elections that extended the election periods and reduced the interim periods—IEC and its international partners have been challenged to prioritize long-term institutional development and capacity building. In addition, staff turnover at the IEC at national and provincial levels contributes to the loss of valuable technical and institutional knowledge.

Horizontal and vertical internal communication within the IEC structure is essential to effective and efficient functioning at national and regional levels and—when combined with training—to ensure consistent standards of management and operations. The use of working groups dedicated to institution-wide issues has proven an effective way to improve communication and coordination across departments along with participatory workshops and staff exchanges.

Mentoring and on-the-job training proved to be particularly effective to build individual capacity particularly during peak election periods when participation in more formal training programs was difficult. These approaches also helped facilitate the retention and application of knowledge and skills learned through training.

Even so, ongoing training is required to increase individual and institutional capabilities. Routine exercises to identify best practices and lessons learned as well as the institutionalization of monitoring and evaluations systems are necessary to apply learning within the institution and to improve performance with respect to IEC operations and election management and administration. Monitoring and evaluation efforts linked to the IEC's Strategic Plan 2011-2015 and its Capacity Building Plan 2011-2015 will be key to tracking the implementation of those plans and the achievement of related institutional benchmarks.

### Assessment of Training Needs (Subcategory Weight: 5%)

### Impact Score: 5.0

### Vulnerability Score: 5.0

The IEC conducts an assessment of training needs before each election and has also conducted lessons-learned workshops for its staff at national and provincial levels. These findings have fed into subsequent training plans. While the quality of training program and material needs assessments per se is not a major weakness, a process to evaluate the actual implementation of the training program and performance of poll workers and officials at the tally center relative to their training might yield more specific/targeted findings. Currently, the evaluation of training outcomes is mainly anecdotal.

### Training Programs (Subcategory Weight: 45%)

### Impact Score: 10.0

### Vulnerability Score: 8.0

While it is sustainable and well-regarded for its ability to train a large number of people in a relatively short time, cascade training has its drawbacks. Most importantly, some time for absorption is required between being trained and conducting training for others. In the highly condensed election calendar, this becomes an issue. There is also less control over training quality and consistency. The regular and effective monitoring required to ensure that the correct messages are passed on in effective ways at each level of the organizational hierarchy may sometimes be beyond an EMB's capacity, which is a major risk. Thus, this subcategory proved to be extremely vulnerable to malpractice and to have a high impact on elections. In particular, as poll workers are the primary face of the IEC to most voters, the quality of training programs has had a direct impact on voter perceptions of electoral integrity.

As part of the cascade training program, the IEC conducted a five-day training in Kabul for training officers from provinces, who then trained district field coordinators (DFCs) at four-day trainings. While there was direct communication between focal points at headquarters and the training officers at the provincial level, IEC officials noted security challenges that prevented direct supervision of these trainings by non-locals.

The DFCs then provided training for one week to polling station managers, although the IEC would have preferred allocating budgetary resources, had they been available, to directly train the approximately 7,000 polling center managers at the district level. Poll workers are usually hired about four days in advance of Election Day and they receive one day of training from polling center managers. Poll workers include registration officers, ink managers and queue controllers. As one election worker in Khost noted, “We assign our trainers to go to Kabul to receive elections training for one week. Then the trainers train DFCs in Khost for four days and the DFCs train polling station officials. Right now we don't have away to monitor and evaluate DFCs, only if we receive complaints from voters and they have proof, then DFCs will be removed.”

### Recommendations

1) Strengthen the IEC's Cascade Training Program.

It is imperative to strengthen the IEC's cascade training program by enhancing its quality, methodology and consistency, and most importantly, by providing resources to the training department to supervise the training. The IEC should also procure an independent evaluation of every stage of the cascade training and, at a minimum, independent pre- and post-evaluation of trainees. Recruitment of more capable trainers, especially educated youth, would increase the overall caliber of trainees exponentially. In addition, the IEC should recruit and train more poll workers and DFCs than are actually needed, and select only those candidates who pass final tests following the trainings. A 10 percent overage is increasingly being used by successful EMBs elsewhere in the world.

2) Develop More Targeted Trainings for Various Levels of Officials.

As observed during the previous election(s), some election officials lacked sufficient information or understanding to carry out their responsibilities. A more robust and comprehensive training program for staff, tailored to specific responsibilities, will mitigate this issue in future elections. Training curricula and material should be customized according to appropriate educational and experiential qualifications, election process responsibilities and type of election official. In addition, while the current methodology is interactive, IEC trainers noted that more scenario-based training/role plays could be incorporated, especially on issues like handling intimidation at the polling station level. Practical training on counting, tallying and filling out necessary forms should also be further reinforced.

2) Use Poll Worker Training Programs as a Public Information Tool the IEC could Offer Specific Sections of Poll Worker Training Manuals and Materials on its Website to Increase Transparency and Serve as an Additional Public Information and Voter Education Tool.

3) Focus on Long-Term Capacity Building Efforts.

The IEC should develop and implement long-term capacity building programs with the support of its technical assistance providers. Building relationships with international and regional training centers would be extremely beneficial over the long-term.

### 2. Institutional Framework

### Impact Score: 9.15

### Vulnerability Score: 7.70

a. Major Weaknesses/Explanation of Ratings

The IEC's institutional framework presents a mixed picture. Its organizational structure gives it significant room for independence and a mandate facilitating impartial decision making. However, the President's appointment of all IEC policy makers and the CEO effectively undermines the organization's independence. Furthermore, the GoA's tradition of regarding the most senior IEC officials with prominent government offices undercuts IEC impartiality in the eyes of many Afghan electoral stakeholders. Although this is not fraud, as per the definition used in this assessment, this practice is highly questionable and sometimes directly violates the rules governing the IEC. Accordingly, this represents a significant breach in the duty of care of the senior electoral officials accepting such positions and constitutes malpractice.

### EMB Model (Subcategory Weight: 5%)

### Impact Score: 3.0

### Vulnerability Score: 3.0

Three different models of election authority have evolved in countries organizing multi-party elections: independent, governmental and mixed.

The independent model is characterized by an EMB that plans and implements elections independently from the executive branch of government and manages its own budget. The governmental model, on the other hand, is typified by elections organized by the executive branch or a ministry, often the Ministry of Interior. The election administration is either directly led by a minister or a senior civil servant and budget management falls within that ministry. The mixed model is a hybrid of the previous two. Often a commission-style component exists that is responsible for policy decisions and supervision of the electoral process, while a ministry actually implements the election.

In Afghanistan, the authorities established an independent election authority, the IEC. Both the 2004 Afghanistan Constitution and 2010 Electoral Law reference an independent entity charged with planning and implementing elections in Afghanistan that should independently exercise its duties. The Electoral Law confirms that “state officials, employees of government institutions/ . . . /shall not interfere in electoral affairs either directly or indirectly.”⁵⁸ The EMB model chosen in Afghanistan is largely in line with international trends; that is, it follows the leading structure chosen by countries striving to establish an EMB that is independent of the government of the day. Where this objective is achieved, the vulnerability for malpractice, or outright fraud by senior or junior EMB officials, is low.

### Organizational Structure and Staffing (Subcategory Weight: 25%)

### Impact Score: 10.0

### Vulnerability Score: 9.0

The IEC has established a relatively substantial organization at its headquarters in Kabul. The policymaking entity is led by the Chairman of the IEC, his deputy and seven other members. The Board of Commissioners collectively makes policy decisions and focuses on issues of overriding importance to the IEC's mandate. There are also a number of subcommittees that are led by a Commissioner and the relevant head of department from the Secretariat. These subcommittees facilitate decision making within their area of responsibility by holding preparatory discussions and answering questions anticipated from the Board of Commissioners.

However, the main challenge to the IEC's independence, perceived or real, relates to who the leadership of the IEC is appointed. In Afghanistan, the executive branch's influence over the appointment process is extensive, as the President not only appoints all Commissioners but also the CEO, which is unusual for an independent EMB. The frequency with which senior EMB officials move from the EMB to prominent government positions following an election further undermines the IEC's independence in the eyes of many Afghan election stakeholders. This common occurrence directly violates a presidential decree that outlines the structure and working procedure of the IEC: “At the end of their tenure, members of the Independent Election Commission, while retaining their material rights, cannot, for a period of one year, be appointed to top official positions, with the exception of academic and research ones.”⁶⁰

The IEC Secretariat is led by the CEO and two deputies (operational and administrative). The Secretariat's organizational structure has largely remained the same since 2004 and covers all the main tasks making up its official mandate. In addition to its nine departments, various cross-departmental taskforces are also established when deemed necessary, such as one for voter registration preparations.

Given the size of the country and its challenging infrastructure, the IEC also has permanent provincial offices. The capacity and infrastructure resources available at the provincial offices, however, vary significantly. Much of the capacity building efforts have, over the years, unfortunately largely targeted staff of the Secretariat in Kabul and not provincial officers—although most of the actual preparations and implementation for electoral processes are conducted at subprovincial levels. As a result, a worryingly large number of provincial offices and their officers struggle to perform their duties in an impartial and professional manner. This has proven particularly acute when it comes to recruitment and supervision of DFCs, as well as recruitment and training of poll workers. Given the extent of malpractice and fraud associated with these two categories of election officials, capacity building programs must pay significantly more attention to provincial officers and their requirements and needs.

### Decision Making Model (Subcategory Weight: 10%)

### Impact Score: 8.0

### Vulnerability Score: 8.0

According to the presidential decree that outlines the structure and procedures of the IEC, decisions are to be made by a two-thirds majority of its members. However, according to several sources within the IEC, during the 2010 elections the IEC made several critical decisions with only a few Commissioners present. Other Commissioners later signed the decisions as if they had been present.

However, in recent years, the IEC's decision making model has been challenged on a much more fundamental level by the executive branch. On a couple of occasions, the IEC's constitutional mandate to organize and execute elections as it sees fit under existing laws has effectively been undermined. During the aftermath of the previous election(s), investigations of the electoral results were conducted by the Attorney General's office and subsequently by a special court, appointed via a presidential decree. These investigations amounted to a de facto review of the work of both the IEC and the ECC. The legality of the special court was questioned by both national and international election observation missions, as no such institution was envisaged in the legal framework governing elections and the presidential decree establishing the special court was never published.

More recently, the IEC's independence has been tested and found wanting, as its proposed solution to voter registration problems was blocked by the Cabinet of Ministers. None of the previous voter registration exercises conducted prior to the elections in 2004, 2005, 2009 or 2010 required the approval of the Cabinet, as this decision should rest clearly within the purview of the IEC. However, the Cabinet of Ministers has now effectively decided how the IEC should register voters for the 2014 election cycle, there by undermining the IEC's independence.

### Reliance on State Institutions (Subcategory Weight: 15%)

### Impact Score: 8.0

### Vulnerability Score: 6.0

In spite of its relatively well-established organizational infrastructure, the IEC must rely on other state institutions to fulfill core functions of its mandate, in particular all security-related aspects. The IEC's reliance on governmental institutions is the norm from a comparative perspective, rather than an exception, as most countries cannot afford to have an EMB with nationwide logistical and staffing structure on stand-by just for an electoral event every fourth or fifth year. However, the IEC has gone to extraordinary lengths to prove its independence when it comes to activities normally coordinated with ministries in other countries, such as logistics and recruitment. Leading up to the previous election(s), the IEC also improved its relationship with Afghan security forces and provided significantly more leadership than in previous years, at least in identifying and deciding which polling centers to open. Having said that, the IEC remains largely in the hands of the Afghan security forces when it comes to vetting candidates and almost all security assessments, including point and area security. These forces are widely perceived to be political instruments of the executive branch and to serve with limited esprit de corps and professionalism. As a result, Afghan forces have been implicated in electoral malpractice and fraud in the previous election(s), with impunity. Given the IEC's heavy reliance on Afghan security forces, this has severely impacted its independence.

The IEC's large budget has made it possible for the organization to procure and rent most of the vehicles, and even fixed-wing airplanes, required to perform national duties. In most other countries, an EMB would rely on transportation capabilities from various ministries. The IEC also decided to embark upon its own recruitment drive of more than 85,000 polling officials, rather than relying on a cadre of teachers and civil servants from the Ministry of Health and similar ministries or departments, as would often be the case elsewhere.

The major improvement in terms of the IEC's dependency on state institutions can be found in the IEC's polling center review process. In previous election(s), the IEC leadership largely deferred to Afghan security forces and allowed those institutions to dictate which polling centers were deemed safe. As a result, many so-called “ghost polling stations” generated results even though they never opened. In previous election(s), the IEC as much more firmly in the lead and as a result the ghost polling station problem was largely contained. However, the security situation in Afghanistan remains extremely problematic and the IEC will continue to be very dependent on a good working relationship with Afghan security forces for risk assessments, point and area security and logistical support (for more information, see the role of security Forces category).

The IEC chairmanship of the Vetting Commission, responsible for verifying that candidates do not command or belong to illegal armed groups, put the IEC in an awkward position as it was forced to jointly make decisions on candidate eligibility with the Ministry of Defense, Ministry of Interior and the National Directorate of Security. The previous election(s) vetting process, unfortunately, proved opaque and concerns were expressed over the lack of due process.

### Public Perceptions (Subcategory Weight: 25%)

### Impact Score: 10.0

### Vulnerability Score: 8.0

The electorate's trust in the IEC took a beating in previous election(s). The highly problematic electoral process, acrimonious public discourse surrounding candidate nomination and election results contributed to the IEC's low standing among Afghan citizens. The executive ranch's appointment of the IEC Chairman and CEO to prominent government positions soon after the 2009 election probably further compounded the Afghan perception that the IEC is less than independent from the government of the day and therefore a less credible institution.

With the appointments of a new Chairman and a new CEO, renewed emphasis on a credible process and a more professional IEC, the Commission managed to regain some of the credibility it lost during the previous election(s). Unfortunately, much of its work to reduce electoral malpractice and combat fraud went unnoticed by Afghan stakeholders, as the IEC failed to communicate its actions to stem these problems during the 2010 electoral cycle (as detailed below).

### Management of Malpractice and Fraud (Subcategory Weight: 20%)

### Impact Score: 10.0

### Vulnerability Score: 8.0

Although the 2004 and 2005 electoral processes were by no means immune to malpractice or fraud, neither issue as on top of the IEC's agenda prior to the 2009 elections, and especially not electoral malpractice. Having said that, the IEC was not oblivious to these risks and several actions were taken to deter and detect fraud:
1) High quality electoral commodities were procured to reduce risk of counterfeiting
2) Changes were made to the recruitment process of polling officials
3) Indelible ink was used to avoid multiple-voting
4) Tamper-evident bags were procured to minimize alterations to results forms while in transit
5) Improvements were made to control procedures during tabulation of results
6) Efforts were made to establish a timely and effective dispute resolution mechanism at the ECC

These efforts proved woefully inadequate to counter the actual level and types of electoral malpractice and fraud. The IEC, its technical assistance providers and national and international stakeholders were determined not to underestimate these vulnerabilities and repeat their mistake in previous election(s). As a result, combating electoral fraud became as important an objective as ensuring security.

The IEC leadership and top technical assistance advisers dedicated significant amounts of time and resources to developing a broad range of improvements and tools to deter fraud and malpractice. The following main interventions were developed and introduced in previous election(s):
1) Procurement of high-quality election materials
2) Revised procedures (particularly at the National Tally Center)
3) Implemented additional controls for the recruitment processes of electoral staff
4) Placed stringent controls on movement and use of sensitive materials
5) Established and finalized a list of polling centers 30 days before Election

Day to reduce the risk of ghost polling stations
6) Undertook extensive review of suspected fraud attempts (particularly at the National Tally Center)

The IEC genuinely strived to overcome the malpractice and fraud challenges it faced in previous election(s). Extraordinary efforts were made to develop the aforementioned mechanisms and tools. Still, these actions proved insufficient as, once again, more than one million ballots were declared fraudulent by the IEC. As noted elsewhere in this report, one of the major omissions of the IEC was its inability to distinguish electoral malpractice from fraud, which in turn undermined its ability to properly investigate problems identified during the tabulation of results at the National Tally Center.

The main shortcoming in the IEC's malpractice and fraud strategy leading up to the previous election(s) as its lack of an integrated malpractice and fraud control plan. Instead of a comprehensive assessment of possible vulnerabilities based on input from IEC officials at various organizational levels, civil society, political parties and security entities, only a select few individuals were charged with identifying risks and solutions. Although an impressive number of changes and improvements were achieved, several were Kabul-centric, focused on the IEC and functioned more as stand-alone activities than as components of an integrated plan. Furthermore, only limited attention was paid to proactively deter malpractice and fraud early on in the electoral process. On a similar note, the IEC failed to proactively engage the Afghan electorate and other key stakeholders in combating fraud and keeping them informed about actions taken to combat vulnerabilities. As a result, the IEC never stood a chance of overcoming the public perception deficit from the previous election(s).

### Recommendations

1) Develop a Malpractice and Fraud Control Plan.

After a thorough review of the IFES Electoral Integrity Assessment report, the IEC should develop a malpractice and fraud control plan that includes improved detection, mitigation and deterrence mechanisms. Even if significant improvements are made to combat malpractice and fraud, the IEC must also overcome the perception of uncontrolled fraud among stakeholders that could undermine any genuine progress. The control plan development should include input from IEC Commissioners and the CEO, as well as heads of departments and members of provincial offices. In addition, the IEC must also include representatives from civil society organizations, political parties and other relevant Afghan institutions such as the Ministry of Interior. A more inclusive and transparent approach will generate more effective countermeasures, encourage ownership and proper implementation of control plan features by relevant departments and IEC offices and will serve as an actual fraud deterrent during the election process. International donors should provide sufficient funding and other resources to ensure the successful development and implementation of an IEC fraud and malpractice control plan.

2) Make the Gender Unit a Permanent Part of the IEC.

The Gender Unit at the IEC, with full support from the Commissioners, CEO, senior management team and the international community, should increase the willingness, capacity and skills of other departments to include women and women's issues appropriately. It plays a crucial role in providing input to improve electoral processes. In particular, it serves to overcome gender-related malpractice and fraud resulting from the insufficient presence and participation of women as election workers. Yet, the full Gender Unit staff is not part of the IEC structure. Its existence as a permanent part of the IEC should be institutionalized and adequately funded by the national budget.

3) Create a Gender Consultative Group.

In addition to the Gender Unit, the IEC should create a gender consultative group composed of senior figures in Afghan civil society and religious leaders, with the dual aims of seeking advice and increasing buy-in for the work of the IEC on women's political participation.

### 3. Counting

### Impact Score: 8.05

### Vulnerability Score: 6.70

a. Major Weaknesses/Explanation of Ratings

### Counting Process (Subcategory Weight: 30%)

### Impact Score: 10.0

### Vulnerability Score: 7.0

The count process proved highly problematic in previous election(s). According to most analyses and the IEC's own actions, counting was marred by fraud. As a result, the Commission excluded 1.3 million votes from the final count. However, the allegations of fraud were only partially accurate; a significant number of errors were made by polling officials who did not intentionally try to distort the election results. These under-qualified officials made genuine mistakes and errors; their lack of qualifications was sometimes further compounded by the substandard trainings offered by DFCs. Hence, the count was often erroneous and results forms incorrectly completed because of poor understanding of the procedures. This is most unfortunate and had a detrimental effect on the integrity of the election. However, this issue should be characterized as electoral malpractice, and not fraud.

### Results Form (Subcategory Weight: 50%)

### Impact Score: 10.0

### Vulnerability Score: 9.0

Just as the count displayed a host of shortcomings in previous election(s), the same holds true for the completion of the results forms. In some instances, poor completion of results forms can be attributed to staff struggling to understand the task at hand, due to low levels of literacy and numeracy. In addition, the poll worker training offered by DFCs was also sometimes insufficient to teach the necessary skills to understand and complete forms correctly. In some cases, incorrect or incomplete results forms arrived at the National Tally Center because polling center managers failed to check the forms for inconsistencies before adding them to the tamper-evident bag for onward transportation. This indicates a problem with the recruitment and training of poll workers, as well as of polling center managers.

### External Monitoring (Subcategory Weight: 10%)

### Impact Score: 6.0

### Vulnerability Score: 6.0

Given the security situation and reduced ability of security forces to secure polling centers after dark, fewer observers and agents were present during the count than during voting. Consequently, the capacity of external monitors was reduced. In addition, the effectiveness of external monitoring was also diminished. As observers and agents were less well versed in counting procedures than in voting operations, they struggled with the same challenges as poll workers during the counting stage. The presence of female observers and agents in polling centers during the count was particularly limited.

### Transmission of Results (Subcategory Weight: 10%)

### Impact Score: 5.0

### Vulnerability Score: 5.0

In order to enhance its control capabilities, the IEC introduced a new reporting system for the previous Election Day. The system was designed to generate turnout numbers at noon and at the close of polling, among other functionalities. As was described earlier, the requested data was phoned in by polling center managers to DFCs, who conveyed the same information to their respective provincial office for data-entry into web-based software. Unfortunately, the system proved unreliable as the IEC initially announced a voter turnout of approximately 4.2 million votes and later published an interim result based on 5.6 million ballots.

The communication of numbers over crackly phone lines by two non-professionals is a process that is especially prone to error, which is why security forces spend a significant amount of time training operators to use special communication techniques. The reporting system used by the IEC in 2010 included two such human-to-human transmission links (polling center manager to DFC; DFC to provincial offices). In addition, the turnout data was only entered once by data-entry operators at the provincial level, without any validation mechanism in place, thereby further increasing error risks. Due to these systemic weaknesses, the credibility of the data conveyed using this Election Day reporting system was effectively undermined and thereby prevented the IEC from using it as either a deterrent or detection mechanism for malpractice or fraud. Proper control and reporting mechanisms for the Election Day count are of fundamental importance to all EMBs. Accordingly, the IEC needs to revisit and improve its reporting system to ensure it receives timely and reliable data that can be integrated into its election results management system. This will strengthen the IEC's ability to identify malpractice and fraud vulnerabilities.

### Recommendations

Please refer to the recommendations included previously in the fraud section of this report.

### 4. Role of Security Forces

### Impact Score: 8.0

### Vulnerability Score: 7.6

a. Major Weaknesses/Explanation of Ratings

Security forces have played a significant role in securing the electoral process in Afghanistan, often in the face of great threats to their own lives. As well-intentioned as they were, in many cases, the lack of election-related training and preparedness has prevented them from discharging their duties to the fullest extent possible in the highly fragile security environment. This category, based on observer reports and in-person discussions with security forces and other stakeholders, addresses this vulnerability and its potential impact on elections.

### Professionalism of Security Forces (Subcategory Weight: 30%)

### Impact Score: 8.0

### Vulnerability Score: 8.0

The 2010 Wolesi Jirga elections benefited from increased coordination between and among the ANSF, the International Security Assistance Force (ISAF) and the IEC. Months before Election Day, the Ministry of Defense, Ministry of Interior and the National Directorate of Security (NDS) conducted a security assessment of 6,835 potential polling center locations. In parallel, ISAF forces conducted an independent assessment of polling sites. Per the findings of these assessments, security forces recommended that the IEC not open 797 of the potential polling centers. The IEC also conducted its own assessment, after which it decided to not open an additional 141 centers. After additional consultative processes, which included international security forces and Afghan provincial officials, the IEC released a final list of 5,897 polling centers scheduled to open on a previous Election Day.

Observer groups and stakeholders praised this extensive collaboration between the IEC and security forces. The early start of their collaborative assessments and the lead role the IEC played in making the final determination presented an improvement over the previous election(s).

On Election Day, ANSF were deployed into protective rings surrounding polling centers to offer point security. ANP personnel comprised the first ring, with officers stationed in the immediate vicinity of polling centers and 50,000 additional officers guarding the centers themselves. Approximately 63,000 Afghan National Army (ANA) troops formed an outer perimeter around polling areas, with a third tier of quick response forces beyond that. NDS provided all layers of security intelligence of armed opposition group activity. These layers of security were put in place to mitigate security incidents without international assistance.

Despite these improvements, observer groups reported widespread incidents of intimidation, kidnapping and violent assaults against candidates and their staff, IEC personnel and civilians. Electoral violence in previous election(s) increased nearly 20 percent. More robust mechanisms to evaluate the security needs of candidates and where to deploy forces could have reduced the violence perpetrated by armed opposition groups in the campaign period.⁷⁸ Adequate security to enable safe electoral participation of women was not provided, and observers noted that female participation was diminished due to the lack of female officials and many incidents of violence. There was widespread intimidation, harassment and attacks on women. All these factors highlight the importance of increasing the professionalism and competency of ANSF to be able to secure the electoral process.

### Election-Specific Training (Subcategory Weight: 40%)

### Impact Score: 8.0

### Vulnerability Score: 7.0

For the previous election(s), EUPOL, in coordination with staff from the UNDP's Enhancing Legal and Electoral Capacity for Tomorrow project (UNDP ELECT) and the Afghan Ministry of Interior, conducted electoral security cascade trainings for ANP personnel. The three-stage cascade model employed by EUPOL focused on the roles and responsibilities of the ANP and other stakeholders during the campaign, polling and counting and tallying processes. The training targeted 35,000 police officers across Afghanistan in previous election(s), and EUPOL also printed 40,000 training booklets detailing security procedure and proper conduct for Election Day. The cascade program reached only 10,000 police officers in the previous election(s), and observers noted that provincial police officials in several provinces were even unaware of the training program in previous election(s), clearly indicating problems with implementation of the election-focused training program for ANP personnel.

The majority of ANA and ANP officers consulted during this assessment confirmed this shortcoming as they reported no awareness of dedicated electoral security training in provinces. None of the PRTs consulted reported any planned electoral security trainings for their local ANA and ANP departments.

Approximately 500 security incidents occurred on Election Day of previous election(s), an increase from 304, and ANSF were reportedly unprepared for the increased levels of violence, especially in the north and northeast parts of the country. That said, according to observers, ANSF forces were able to resolve some violent incidents with minimal impact on the administration of the elections.

### Accountability (Subcategory Weight: 30%)

### Impact Score: 8.0

### Vulnerability Score: 8.0

Given the training gaps, some electoral malpractice is to be expected among security forces, as it was from civilian election stakeholders. During the 2010 elections, observers noted that effective remedies were not employed in a transparent manner to address malpractice of security actors. PRT officials with whom the team consulted also reported that ANSF officers had no recollection of punitive actions taken against officers for malpractice. Likewise, many had no recollection of complaints.

### Recommendations

1) Provide Training on the Electoral Cycle to ANSF.

Training on the electoral cycle, with a focus on the main points of vulnerability, should be provided to the ANSF. Two broad categories of training programs should be considered. Senior officers will require more strategic election-related training on how to conduct election security assessments and preparations at the provincial level and above. The second type of training should be targeted to lower-tier security forces responsible for securing polling centers and counting facilities and who are taking part in convoys escorting sensitive election material and staff.

2) Promote Accountability of Security Forces.

Just as civilian electoral stakeholders are held accountable for their adherence to a code of conduct and regulations, security forces should be held to a similar standard. A public information campaign focusing on electoral security should be conducted that includes the roles and responsibilities of security forces.

3) Provide Targeted Trainings on the Protection of Women.

Female officials, candidates, polling staff, civic educators, journalists, adjudicators and voters must receive adequate protection. It is important that security forces receive targeted training on providing this protection in a proactive and professional manner.

### 5. Recruitment

### Impact Score: 7.9

### Vulnerability Score: 6.5

a. Major Weaknesses/Explanation of Ratings

Competent, neutral, professional and enthusiastic poll workers form the backbone of Election Day operations. Poll workers in the more established democracies of South Asia are usually recruited from within the civil service, including personnel such as public school teachers. In the absence of a large nationwide civil service, the IEC must draw on an extensive cadre of temporary staff for each election. This is one of the largest recruitment drives in Afghanistan. According to the IEC, 160,000 poll workers were hired in 2009, and 120,000 were hired in 2010. Although 6,000 poll workers from 2009 who faced allegations of misconduct were not re-hired in 2010, true quality control is impossible at this scale without a performance evaluation database. Nepotism and corruption played a significant role in previous recruitment processes in Afghanistan, and interlocutors in practically every meeting with the assessment team highlighted the role of DFCs in recruitment as a major factor in both malpractice and fraud. This section focuses on malpractice arising out of a compromised recruitment process (fraud-related recruitment issues were covered previously in this report).

### District and Subdistrict Poll Workers (Subcategory Weight: 80%)

### Impact Score: 8.5

### Vulnerability Score: 7.5

As staff salaries and related costs are frequently the largest line item in an election administration budget, incremental savings in these areas can have a sizeable impact on available financial resources. However, cost savings should not be pursued at the expense of effective service delivery. In many cases, polling and other electoral officials provide the main interface between voters and the EMB. Accordingly, credibility of these staff should be prioritized. As noted by the ACE Project, “the basis of staffing plans must be cost effective service delivery, rather than merely low-cost service delivery.”

Interviews during the assessment confirmed that DFC positions were openly advertised for both the previous election(s). According to one respondent, “our central IEC office ordered the provincial IEC to assign DFCs and then the provincial IEC announced vacancies. During the test for the positions, IEC checked the DFCs background to make sure that their families aren't running candidates. They also checked for experience and made them promise that they could be impartial.”

Poll workers were hired from the districts in which they resided, while often DFCs were located outside their home district to ensure independence in the process. The assessment team was also told that in some provinces, NDI, UNAMA and FEFA observed the hiring process. Interlocutors also noted that poll worker hiring was constrained by the lack of a competent applicant pool and that the security situation was a deterrent to effective recruitment. As a result, the IEC was forced to hire applicants who may not have been the best candidates for the positions. While this may have been true for poll worker recruitment to some extent, DFC hiring was conducted four to five months before Election Day and it is unlikely that competent candidates were not available at the district level.

Staff from the IEC Gender Unit additionally pointed out that it is extremely difficult to hire female poll workers when the scopes of work for these positions include travel. Although the IEC paid for mahrams (male family member) to travel with female poll workers, this was not generally advertised. Should this trend continue, the absence of female staff during registration and on Election Day could have a significant impact on female voter turnout in the next election.

### IEC (Subcategory Weight: 20%)

### Impact Score: 5.5

### Vulnerability Score: 2.5

In previous election(s), the authority and responsibility for conducting elections in Afghanistan was transferred from the JEMB to the IEC, a fully Afghan-run institution. The IEC's structure features a Board of Commissioners (all currently appointed by the President) at the top of the hierarchy. The IEC Secretariat is led by a CEO, who reports to the Board of Commissioners and is supported by two deputies. Ten (10) departments are responsible for implementing the various functions and activities of the IEC. The Commission also maintains a field presence comprised of 34 offices at the provincial level.

Ensuring the application of human resource principles and standards, such as recruitment based on relevant knowledge, experience and skills sets, is central to building a capable and credible institution and contributes to the independence of the Commission. A variety of stakeholders interviewed during the assessment mission mentioned recruitment of the provincial, district and polling station staff as a significant point of entry for both fraud and malpractice. Nepotism, political pressures and interference in hiring, the absence of an effective interview process and competency of the hiring managers were all cited as reasons. The role of the DFC in the recruitment of lower-level staff was particularly criticized.

Continued focus on building the capacity and professionalism of staff at the provincial level will be critical to improving management and administration of elections; compliance with legal and regulatory requirements; IEC policies and procedures; and professional and ethical standards.

Overall, it was not felt that the permanent staff of the IEC was vulnerable to malpractice to a great extent. However, competency of the large number of tally center staff was definitely questioned by various stakeholders in meetings. This is not entirely a recruitment issue, as training also plays a major role in this respect. This is explored further in the training category.

### Recommendations

1) Widen the Pool of Competent Recruits for Poll Worker Positions.

To increase the pool of competent poll workers, university students and students in their last year of secondary school should be considered. In many cases, students will be willing to travel beyond their hometowns. The IEC should consider establishing memoranda of understanding (MOU) with a variety of government institutions, including the Ministry of Education and the Ministry of Public Health, to facilitate recruitment of civil servants. This will ensure sustainability of recruitment efforts in the future.

To increase the recruitment of women, the IEC should work closely with the Ministry of Women's Affairs, nongovernmental organizations, universities and schools. A commitment to increasing the number of female permanent staff (as distinct from temporary election staff) and Commissioners is also needed. The IEC Gender Unit should also be transferred to the tashkeel (official organogram detailing staffing positions and levels), rather than staffing the unit with non-permanent workers.

2) Improve Transparency of Recruitment Policies and Practices.

Strict recruitment policies and procedures should be developed, publicized widely and enforced, including the establishment of an independent recruitment monitoring program in which reports are provided directly to the Commissioners and CEO. The IEC should also invite observer groups to witness the recruitment process. IEC officials have also recommended that relevant departmental staff should serve on the selection panel to ensure that the necessary skill sets are well known to the hiring team.

3) Increase Performance Accountability for DFCs and Poll Workers

To prevent inadvertent rehiring, the IEC should implement a performance evaluation process for DFCs and poll workers that enables them to identify and blacklist problematic staff.

4) Improve and Enforce Codes of Conduct for all Election Staff.

Codes of conduct should become increasingly complex and require a higher level of duty of care from poll workers up to the Commission level. Some interlocutors recommend that all election officials should be required to take an oath on the Qur'an and the constitution and sign a code of conduct in public ceremonies. Strict penalties for violation should be put in place and enforced.

6. Aggregation and Certification of Final Results

### Impact Score: 7.7

### Vulnerability Score: 7.0

a. Major Weaknesses/Explanation of Ratings

### Reconciliation and Certification of Final Results (Subcategory Weight: 70%)

### Impact Score: 8.0

### Vulnerability Score: 7.0

One of the greatest opportunities to manipulate election results occurs during the aggregation and certification stage of the process. To ensure acceptance of the results, the aggregation and certification process must be transparent; experienced teams of international and domestic observers should be given access; candidates and political parties should keep their own records; and clear explanations must be given by the EMB for variances between publicly available precinct records and final results. In Afghanistan, Articles 56, 58 and 66 of the 2010 Electoral Law specify that the IEC has the responsibility to count the vote, certify the election results and adopt regulation to implement the law. For the 2010 elections, within the framework established by the IEC, original counts were conducted at the polling station level and the aggregation process was completed at the National Tally Center in Kabul. As stated in the counting category of this report, the count process is clearly regulated and outlined in the IEC's Regulations on Counting and its Polling and Counting Manual. The process contains several standard security features to ensure a correct and transparent counting process, including observers and agent observation of the opening of ballot boxes, reconciliation and counting of ballot papers.

With that said, a great deal of fraud and malpractice occurred at the polling station level in previous election(s) and, as the assessment team has learned from interviews with IEC members and observers, there were numerous administrative errors at the National Tally Center as well. On the positive side, results data were entered into a database based on a standard double-blind data entry system to ensure accuracy of the aggregation system. However, the results forms contained both administrative errors and evidence of fraud. Those forms that met investigation triggers were placed into two categories: (i) tally forms suspected of being fraudulent, which were further investigated by IEC officials who made the decision to include or not include the tally in the final results; and (ii) those forms that clearly contradicted set thresholds, such as votes cast in excess of the 600 ballots provided to a polling station and those that were deemed “obviously fraudulent.” Based on these triggers, investigations and subsequent findings, forms deemed to be fraudulent were thrown out entirely.

Many stakeholders interviewed during IFES' assessment indicated, however, that these tally sheet investigations were not based on international best practices. In fact, international observation reports and many Afghan stakeholders indicated that triggers were used, in some cases, as conclusive evidence in and of themselves. The proper approach would have been to use these triggers as only the first step in an investigation process. The triggers would provide the corroborating evidence needed to meet the clear and convincing evidence standard as established by the ECC to find fraud and justifiably invalidate ballots. As mentioned during interviews, even when rigorous investigations were conducted and corroborating evidence was found, neither the investigation process nor the decisions it generated were known or fully understood by relevant stakeholders. Furthermore, stakeholders did not receive clear explanations of how issues of administrative error and those of clear fraud were resolved differently. This lack of transparency, whether real or perceived, led to speculation and further doubt about the entire system. Finally, the need to expedite decisions, coupled with insufficient time, resources and access to relevant information needed to properly investigate electoral claims, clearly helped produce decisions that many stakeholders believed were based on inadequate and uncorroborated evidence.

With these issues in mind, as the IEC has the authority to design and implement the aggregation process, investigate fraud and invalidate ballots without a great deal of oversight, the vulnerability score for this subcategory is high and the impact score is very high. Failings in the determination of final results contributed to both perceived and actual malpractice in the 2010 elections.

### Timetable and Public Acceptance of Election Results (Subcategory Weight: 30%)

### Impact Score: 7.0

### Vulnerability Score: 7.0

According to Article 58 of the Electoral Law and Articles 4 and 5 of the Regulation on Certification of Election Results, the IEC has the authority to certify results; however, within this legal framework, there is no specific timetable for certification. Interestingly, the timetable itself was not raised as a serious issue by interlocutors in Kabul nor in observation or technical reports. However, it is important to keep in mind that elections are extremely time-sensitive political events, and the timely announcement of results and resolution of complaints is vital for building confidence and legitimacy in the overall electoral process and resulting government.

With that said, while aggregating results, the IEC did pursue a proactive process of announcing developments. The IEC released partial results for various provinces and posted results on its website throughout the process. For example, the first preliminary results for the elections were announced by the IEC. The ECC also announced decisions regarding its progress in adjudicating all complaints and the IEC continued to give updates until it certified final results. The process of making these announcements was a positive, much-needed development that added transparency to the process.

However, the “final” results announced did not include results for Ghazni Province and this further contributed to undermining the credibility of the election. Results from Ghazni, according to the IEC, were delayed due to the high number of closed polling stations and invalidated votes, which required additional investigation. Therefore, the IEC did not announce actual, final, certified results for Ghazni until later.

Stakeholders interviewed believe that this delay was due to pressure being applied to the IEC to annul the results and hold a new election in Ghazni. Even if the explanations given were valid, the delay provided additional fodder for potential spoilers to allege bias in the election process and undermined public acceptance of election results.

### Recommendations

1) Establish Proper Investigation Processes for the IEC.

In the previous election(s), the IEC was overwhelmed by the shear number of cases of fraud and irregularities under investigation. The system partially collapsed under this pressure, forcing the IEC to exclude from the count an unnecessarily large number of polling stations. To address this issue, the IEC must allocate a sufficient amount of resources to the count, aggregation and investigation processes. In addition to supplemental funding, a team of IEC investigators must be identified and trained on a core set of standards and principles for election investigations, including expectations for the conduct of investigators. Guidelines must also be established to ensure that the work environment is conducive to thorough and effective investigations. Specifically, investigators must act with: integrity (incorruptibility); objectivity (impartiality in carrying out duties, non-partisanship); competence; fairness (vigorous, balanced and fair gathering and interpretation of the evidence); and accountability (accurate record-keeping in accordance with the law).

Furthermore, to ensure that evidence collected meets the required legal standards, investigators should also be trained on how to disclose conflicts of interest in a timely manner; make every effort to substantiate facts/evidence (findings based on substantiated facts, not hearsay, assumptions or suppositions); and keep accurate records.

Finally, an effective investigation process will ensure: functional or non-retaliatory immunity is in place and respected; systems of accountability for investigators are instituted (such as performance reviews and appropriate oversight); maintenance and retention of documentation; the best possible practices are followed in maintaining proper chain of evidence; investigators are capable of conducting professional analysis of evidence (investigators should be able to examine and analyze all evidence, both inculpatory and exculpatory, and make disinterested recommendations); the consideration of the timeliness of implementing remedies when making recommendations; and that there are actions available and used when appropriate against complainants who act in bad faith or with malicious or negligent disregard of the facts (without producing a chilling effect on legitimate claimants).

2) Carefully Weigh Introduction of Provincial Count Centers to Counting Process.

3) Improve Recruitment and Training of Election Officials to Ensure that Aggregation and Final Results Determination Processes are Conducted Properly and without Errors.

4) Improve the IEC Communications Strategy Regarding the Release of Partial and Final Results.

In addition to meeting the IEC's obligation to communicate results to the electorate, the Commission should develop a proactive communications strategy that will assist them in addressing charges of fraud, malpractice and delay during the aggregation process. The IEC should also describe publicly and directly to political parties and candidates—before the election—the investigation process they will follow once fraud triggers are tripped during aggregation.

5) Reform Article 58 of the Electoral Law for the Correction of Errors.

Article 58 law should be reformed to allow for the correction of errors and the possibility of finding a violation if, after the certification of the final results, new and unmistakable evidence shows by a clear and convincing standard that violations did occur.

### 7. Adjudication of Grievances

### Impact Score: 7.67

### Vulnerability Score: 6.43

a. Major Weaknesses/Explanation of Ratings

Over the past three election cycles, the ECC has functioned as an independent electoral institution that adjudicates all challenges and complaints related to the electoral process. The ECC was first constituted for the 2005 Wolesi Jirga and provincial council elections. It was re-constituted for presidential and provincial council elections. In the previous election(s), the legal mandate of the ECC was defined in Articles 36 and 52-54 of the 2005 Electoral Law. Within this framework, the ECC is separate from and independent of the IEC and all other government agencies of Afghanistan.

In the previous election(s), the ECC was comprised of five members: one Afghan appointed by the Supreme Court; one Afghan appointed by the Afghanistan Independent Human Rights Commission (AIHRC); and three internationals appointed by the SRSG. The ECC's mandate extended from the candidate nomination process to the final adjudication of complaints. The ECC adjudicated three main types of challenges, relating to candidate eligibility, electoral campaigns and polling and counting irregularities. Any person or organization with a legitimate interest in the electoral process could file a complaint.

The previous Wolesi Jirga election(s) were not administered solely on the basis of the legal framework discussed above. Article 79 of the 2010 Electoral Law established a new electoral framework that was initiated through a process that did not seek consultation from relevant stakeholders. In a nearly unanimous vote, the Wolesi Jirga rejected this decree. However, the Meshrano Jirga refused to debate the decree and, in the absence of a rejection from both houses, the decree was recognized as the official Electoral Law for the previous elections. This decree specifically authorized the President to appoint all ECC Commissioners. Importantly, under pressure from the international community, President Karzai reversed his previous position against international Commissioners and agreed to accept two recommended Commissioners from the SRSG. As in 2005 and 2009, any person or organization that had a legitimate interest in the electoral process had the right to file a complaint.

### Right of Redress (Subcategory Weight: 5%)

### Impact Score: 1.0

### Vulnerability Score: 1.0

A right of redress should be available to permit wronged parties to challenge the outcome of an election. As indicated above, citizens have the right of redress in Afghanistan under the law. During the 2010 parliamentary elections, citizens could file complaints to the ECC within three days of the occurrence or knowledge of the violation. Importantly, President Karzai's 2010 Electoral La Decree provided original jurisdiction over complaints and appeals to provincial election complaints commissions (PECCs). If a claimant did not agree with the PECC ruling, they could appeal to the ECC. Finally, as the standing requirements to file an action with the ECC or PECC were so low, the right of redress was readily available to all stakeholders and not necessarily vulnerable to malpractice. Nor was it likely that any obstacle to the right of redress would impact the election. Of course, one vulnerability associated with such a low standing requirement is that parties and candidates could theoretically use this liberal standing requirement as an avenue to file numerous frivolous complaints and overwhelm the process. Stakeholders in Afghanistan did not, however, mention frivolous complaints as a major issue.

### Clear Standards (Subcategory Weight: 25%)

### Impact Score: 9.0

### Vulnerability Score: 8.0

The mechanisms used to challenge an election outcome should be established and defined well in advance of Election Day, and not on an ad hoc basis. Each new iteration of the ECC has expended a great deal of effort developing and instituting necessary processes and procedures. However, compressed timelines in the electoral cycle diminish the effectiveness and clarity of ECC efforts in this area. Each ECC has only 120 days to set up an entire government institution (procuring equipment, arranging office space, and hiring and training staff) and to establish standards and procedures within a completely new electoral framework. This chaotic start-up process engenders an overall inability to properly institute all of the needed standards and procedures. This has, in practice, been a substantial weakness within the system.

More specifically, as these standards are being developed so close to the election, the ECC is forced to focus on training its own newly-hired staff and appointed PECC members and not a wider audience, such as other stakeholders and party agents. The establishment of an entirely new procedural framework and hiring and training of new staff on this framework, all within 120 days, makes this process highly vulnerable to malpractice. As with the perception of partiality among ECC/PECC members described below, this issue undermined the credibility of the process in the eyes of relevant stakeholders. It also lowered the quality of their rulings in general and led to malpractice.

### Impartial and Informed Arbiter (Subcategory Weight: 22%)

### Impact Score: 9.0

### Vulnerability Score: 9.0

Officials charged with adjudicating election complaints should be insulated from outside political pressures in selection and training processes and in the performance of official duties. If this standard is not respected, the credibility of the process will be undermined in the eyes of stakeholders and the quality of the rulings may be unsatisfactory. Unfortunately, the previous election(s) process in Afghanistan did not meet this standard. Due to the appointment process (see below) and the short time period during which the ECC must be established, this subcategory is highly vulnerable to problems associated with malpractice and the impact on the entire election is exceedingly high.

President Karzai's 2010 Electoral La Decree specifically authorized the President to appoint all ECC Commissioners. Under pressure from the international community, President Karzai partially reversed this position and agreed to accept two recommendations for Commissioners from the SRSG. Even with this concession, the perception of impartiality was greatly damaged. That is, as the appointment process was not transparent or inclusive, it eroded the perception of the ECC as an independent and impartial body. For many, this also resulted in the perception that the entire complaints and appeals process was biased or even duplicitous.

Complicating this issue, the Electoral Law Decree provided original jurisdiction over complaints and appeals to the PECCs. The ECC Commissioners interviewed and selected the PECC Commissioners who were later formally appointed by President Karzai. Generally speaking, the shift in jurisdiction had several beneficial effects. First, it further shifted responsibility for the complaints and adjudications process from the international community to Afghan election bodies. With no international representation at the PECCs, Afghan PECC Commissioners became influential actors in the process. Second, in the event an investigation became necessary, the PECCs were in a better position to conduct them at the provincial level than their counterparts at the ECC (see investigations recommendation below). Third, giving jurisdiction to the PECCs added two additional layers of appeal: first, the formal appellate process; and second, an informal review of every PECC decision by the ECC.

However, due to the short timeline allotted for the ECC to hire and train PECC Commissioners, the lack of qualified candidates, and the lack of real oversight of the process due to limited resources and the complicated security environment, the actual performance of the PECCs was weak. This amounted to an inconsistent application of the law and poorly drafted decisions in some cases; in others, decisions were never released at all. Interlocutors who worked in the ECC believed that these problems resulted from malpractice, not fraud; that is, errors stemmed more from the lack of preparation time and training than from corruption. Security and lack of access to credible evidence and witnesses were also important factors in the delays and other problems encountered by the PECCs.

Another factor that distinguished the previous election(s) complaints and appeals process from previous cycles was the narrow jurisdiction claimed by the ECC, which declared that its jurisdiction was limited to offenses enumerated in Article 63 of the 2010 Electoral Law. The ECC interpreted this to mean that it had no jurisdiction over IEC decisions to close polling centers or to disqualify candidates. This decision gave more discretion to the IEC, and while it reduced the workload of the ECC, it also meant that the IEC decisions could not be reviewed. Many candidates publicly complained that the IEC was ineffective, if not compromised, and that as candidates they had no forum to seek review of IEC decisions.

The temporary nature of the ECC is the key factor undermining the delivery of consistent and well-documented decisions in election cases. Many members of the ECC and PECCs complained to the assessment team about the lack of time to establish offices, recruit and train staff and begin operations, all of which had to take place within 120 days of Election Day.

Finally, in the previous election(s), the ECC also faced continuous pressure from outside actors. There were repeated accusations raised by the Attorney General against the ECC, challenging the complaints body's integrity and professionalism. These accusations and a general perception that the ECC's investigations and decisions lacked transparency undermined the legitimacy of and trust in the ECC and the entire electoral process.

### Expedited Decisions (Subcategory Weight: 15%)

### Impact Score: 9.0

### Vulnerability Score: 6.0

The electoral complaints adjudication system should resolve election complaints in a timely manner, but the need for promptness must be balanced with the fair and proper administration of justice. During the previous election period, the ECC and PECCs received a total of 5,856 complaints of varying degrees of severity. After Election Day, the ECC made several decisions regarding the invalidation of results. These invalidations could be appealed within three days of the announcement of invalidation. In addition, the ECC announced that it had conducted an audit of 500 randomly selected ballot boxes from all 34 provinces to verify the accuracy of the count. During the assessment interviews, the timeliness of these ECC decisions was not considered to be as important as the appointment process of the ECC/PECCs Commissioners or the absence of clear standards and procedures.

However, the tension between the need to expedite decisions and the lack of time, resources and access to credible evidence and witnesses to properly investigate electoral claims was a clear factor in producing decisions that many believed were not based on adequate and corroborated evidence. For example, there were triggers established to signal when the IEC/ECC should investigate the legitimacy of ballots in a particular ballot box.¹⁰⁰ Many stakeholders who were interviewed indicated that these triggers were used, in some cases, as conclusive evidence rather than as the first step in the investigation process that would provide corroborating evidence to meet the evidence standard established by the ECC. It is important to note that, even if extensive investigations were conducted and corroborating evidence was found, the decision making process remained a mystery to stakeholders. This lack of transparency led to further doubts about the system as a whole. When you consider this factor alongside the absence of clear standards (as understood by PECC members and electoral stakeholders) and the perception of a partial arbiter, it amounts to a serious erosion of credibility in the ECC/PECCs. Therefore, although the weighted average and vulnerability score for this factor are relatively low, the potential impact is very high and this was evidenced by both perceived and actual malpractice in the previous election(s).

### Meaningful Remedies (Subcategory Weight: 15%)

### Impact Score: 4.0

### Vulnerability Score: 4.0

In order to make the complaints adjudication process meaningful, the arbiter must be able to grant the complaining party a remedy. There should be rules in place governing the nature of this remedy. In the previous election(s), the ECC imposed sanctions when it disqualified candidates and sanctioned IEC officials for their involvement in fraud or violence. The ECC also conducted an audit of 500 randomly selected ballot boxes from all 34 provinces to verify the accuracy of the count. In this sense, there are rules in place that govern remedies and the ECC did use the tools it had available to sanction candidates and IEC officials. Therefore, as the ECC instituted remedies, the vulnerability and impact of fraud or malpractice in this category is fairly low and the weighted average reflects the same.

With that said, however, the system should establish meaningful remedies and, in addition to righting the wrong at hand, it should deter future malpractice and fraud. The remedies process, as it currently stands, is not sufficient in this regard. To be meaningful, remedies must be applied to all perpetrators of fraud and malpractice, including the police, security forces and candidates. In any reform process that takes place in Afghanistan, this deficiency must be addressed (see recommendations below).

### Education and Training (Subcategory Weight: 18%)

### Impact Score: 8.0

### Vulnerability Score: 5.0

In order for a complaints adjudication system to be implemented properly, stakeholders should be taught how to make use of it. This includes the necessary procedures to file a complaint as well as relevant standing requirements. Voter education and training of stakeholders were not cited as a source of fraud within the Afghan system, but deficiencies in these areas could leave the system vulnerable to malpractice. The lack of adequate training and voter education on the complaints process (as highlighted above) could potentially result in a high impact on how officials conduct their duties, how parties and candidates interact with the system, how the media covers the process and how citizens perceive its effectiveness. Therefore, this subcategory was weighted more highly than some of the other subcategories. The vulnerability score was average relative to other vulnerabilities within the system and the prospective impact was relatively high. This is reflected in the recommendations below.

### Recommendations

1) Establish the ECC Sufficiently in Advance of Election Day, Ensure Financial Independence and Appoint Impartial and Informed Arbiters.

To guarantee the right to an effective remedy, the electoral complaints adjudication body should be operational and prepared to receive and adjudicate complaints when the electoral process begins (for example, with candidate registration). One effective approach would be to introduce a permanent ECC secretariat within the IEC that would provide legal clerks to the ECC once Commissioners have been appointed; serve as a training corps to train adjudicators (ECC and PECC members); maintain a cadre of professional investigators; and deliver continued voter and civic education campaigns between election cycles to inform citizens about their right of redress and train party agents and other stakeholders on how to properly interact with the ECC. This structure would have a continuous mandate, but could expand or contract in size according to the needs of the electoral calendar.

Most importantly, the ECC and PECC appointment process should include mandatory consultation with a wide range of electoral stakeholders to ensure independence and impartiality. ECC Commissioners should not be appointed solely by the President. A selection committee that includes representatives from the President's office, the Supreme Court and the AIHRC could present nominees for ECC Commissioner positions. The appointment of ECC Commissioners should be subject to parliamentary approval and the appointment of PECC Commissioners should solely be the responsibility of ECC Commissioners.

To maintain independence in the face of any attempted interference or potential conflicts of interest, the ECC budget, management and operations must be independent of the executive branch, the IEC, and any donor programs that support institutions or individuals that the ECC may sanction in accordance with the law. Over the long term, the law should assign a portion of the national budget to support the ECC on similar terms to that of the IEC. Due to time restraints and the specialized subject knowledge required to rule on electoral contests and complaints, arbiters should be competent and informed in the specific area of electoral complaint adjudication. The Electoral Law should require that ECC Commissioners have specific skills and educational qualifications that ensure that electoral cases are heard by informed arbiters. Additionally, as needed, all ECC and PECC Commissioners should be trained before they take their positions.

A full-time ECC would mitigate some of the failings of a late start and would avoid the costs of expanding and contracting the PECCs each election. An ECC with a permanent secretariat controlled entirely by Afghans has the potential to cement local ownership and legitimacy over complaints adjudication. This might enable the institution to become a truly independent and integrated body capable of overseeing the electoral process.

2) Establish a Clear and Consistent Process/Procedure for Filing, Hearing and Resolving Complaints and Appeals and Continuously Improve Regulations and Procedures.

Developing clear standards and procedures governing the resolution of electoral disputes may minimize the likelihood of incomplete, inaccurate and arbitrary decisions. Clear guidelines on how to bring and adjudicate a claim within the electoral complaint system should be written, published and accessible in a timely manner in order to provide adequate notice and process to individuals, political parties, candidates and civil society. After each election, the ECC and the IEC should review their regulations, procedures or guidelines, draw lessons from their experience and work to improve the process.

The fair and impartial adjudication of disputes in Afghanistan requires clear definition of proscribed acts and procedures for their resolution. The ECC should develop regulations that define the elements of each violation set forth in Article 63 and should consider procedures to create an intermediate level of review within the ECC. This review would include hearings that are on the record; conducted by trained election complaints adjudicators; follow consistent procedures for all complaints either made directly to the ECC or via the PECCs; and are reviewed ultimately by the full ECC. The ECC should also establish clear guidelines on what events trigger the deadline to file a complaint or an appeal (the occurrence and the knowledge of the event) and on what constitutes valid evidence (e.g., hearsay exceptions).

The appellate hierarchy and process should be reviewed and clarified in the law and ECC regulations as follows:
a) Complainants must file their complaint according to the stated procedures at the provincial level before their relevant PECC.
b) If a relevant party is not satisfied, he or she may file an appeal with the ECC (central level)
c) Individuals who have a legal interest may appeal the ECC decision before the Supreme Court (acting as a Constitutional Court) only regarding serious matters such as the violation of a fundamental right. The right to appeal language in both the law and in subsequent regulations should be clearly redrafted as there has been persistent confusion among translations of the law in English, Pashto and Dari. In the past, this had led to some tension and misunderstandings, in particular between the ECC and the PECC, with the latter body denying the authority of the ECC to change a PECC decision. In addition, the Electoral Law states that the decisions of the ECC on election violations are final, but the law is not clear regarding review by the Supreme Court acting as a Constitutional Court in case of allegations that the ECC acted beyond its jurisdiction or violated a fundamental right.

Finally, all judgments of the IEC and ECC on electoral violations should be well reasoned, clearly written and reviewable to diminish the possibility that decisions overreach authority, are arbitrary and capricious or are in error. Furthermore, if this recommendation is adopted, this level of transparency will allow the ECC to make significant gains in building trust and confidence in the process.

3) Continue Developing Standards and Guidelines to Provide for an Electoral Complaint Adjudication Body that Judicially Expedites Decisions.

The IEC and ECC must improve its standards and guidelines to effectively and efficiently determine, as a preliminary matter, which complaints might be electoral violations that merit the use of additional resources to conduct full investigations. This process would focus the use of limited resources and help guarantee timely adjudication of electoral complaints and appeals.

In the previous election(s), the ECC used a triage method to identify which complaints on polling and counting should be adjudicated in priority. This process identified the major type of complaints filed in Afghanistan (e.g., allegations of fraud, threats and violence in the polling and counting process) and then attempted to prioritize when the ECC should consider each complaint based on a predetermination of each complaint's likely outcome on the election. The predetermination process as inherently uncertain, as the ECC was making these decisions based on allegations and hearsay and then making their final determinations based on weak evidence. Regardless of its actual effect on the outcome of final decisions, this predetermination process based on partial evidence added to claims of bias. To be clear, a triage process is absolutely necessary and the ECC was doing the best it could with the time and resources available.

The ECC should review and improve its current triage methodology. This methodology should set and publish legal elements and evidence needed to prove typical violations and provide detailed explanations of how the court will evaluate these elements and evidence. The ECC should also publicly discuss and document the process to be used to prioritize complaints and provide case studies. The ECC could also triage complaints related to registration of political parties and candidates, the Vetting Commission on illegal armed groups and campaigning practices.

4) Identify and Train a Team of Investigators on a Core Set of Standards and Principles for Election Investigations.
For more information, please refer to the aggregation and certification of final results category recommendations.

5) Clarify the Jurisdiction of Each Body Involved in the Electoral Adjudication Process and Provide Legal Certainty to Improve the Election Legal Framework.

When several entities have authority over electoral complaints, clear rules regarding specific subject matter jurisdiction of each entity should be established to provide consistency in the interpretation of the law and to avoid interference. A defined regime is also the key to avoiding harmful forum shopping and could promote judicial efficiency by reducing the caseload at each level.

ECC and PECC:

In the current Electoral Law, the PECCs' powers appear to be almost equal to those of the central ECC, leading to tension and misunderstandings about the respective authority of the commissions. In some cases, the PECC has questioned the right of the ECC to review or change a PECC decision. The ECC's authority over PECCs needs to be clarified in the law and in the ECC Rules of Procedure.

ECC and IEC:

Ambiguity has persisted in the ECC's jurisdiction over specific IEC decisions. The IEC should develop an appeal mechanism providing for review of its decisions by the ECC. The net result should be to create within the existing structure a more viable election dispute resolution body akin to a “tribunal,” without confronting issues of the Supreme Court's partiality or creating another entity that may raise its own interpretative issues. Also, if the ECC remains a temporary institution, the authority/responsibility of the IEC regarding the electoral adjudication process after the dissolution of the ECC should be clarified.

ECC, the Attorney General and the Judiciary:

It is necessary to strengthen understanding of the mandate and powers of electoral institutions in order to avoid a repeat of the interference by the Attorney General's Office (AGO) and the judiciary in the previous election(s). The jurisdiction of the AGO and criminal courts over electoral matters, such as fraud, should be clarified. The Attorney General, a presidential appointee, should not interfere in the conduct of elections, the tabulation of votes, the resolution of electoral disputes or certification of results, including seat allocation.

ECC and the Vetting Commission:

The current draft of the Electoral Law removes the militia restriction from the candidate vetting process. Under the present legal framework, the wording of Article 12(7) of the Electoral Law is ambiguous about the jurisdiction of the Vetting Commission. Despite the existence of an IEC regulation on the Vetting Commission outlining the respective roles of the Vetting Commission, the IEC and the ECC are still unclear and created delays in the 2010 electoral process. The law mentions that the Vetting Commission is mandated to vet candidates for membership or leadership of illegal armed groups and report findings to the IEC. “Vetting” is a translation of the Dari word barassy. It is not clear whether barassy means “in estigation” or “in estigation and determination.” Furthermore, the purpose of the requirement to report findings to the IEC is unclear. If the Vetting Commission remains, its jurisdiction and structure should be reviewed and clarified.

6) Increase the Depth and Breadth of Required Training Programs for ECC and PECC Arbiters and Staff.

As observed during the previous election(s), ECC staff lacked sufficient information or understanding to carry out their complaints function. A more robust and comprehensive training program for staff that is tailored to specific responsibilities will mitigate this issue in future elections. For arbiters and investigators, training programs should introduce the seven principle international standards for election complaints adjudication as described in Guidelines for Understanding, Adjudicating, and Resolving Disputes in Elections, and should seek to impute a comprehensive and up-to-date understanding of the Afghan electoral complaints adjudication process.

Training should be organized in a timely manner and whenever possible in small sessions. Training before Election Day should focus primarily on the legal department and in particular on the investigators who are responsible for the receipt, triage and collection of evidence and recommendations for the adjudication of the complaints and appeals. The Intake and Data Entry Department of the IEC at the National Tally Center should also be trained sufficiently, as these staff receive and register all complaints from headquarters and the provinces. For maximum effectiveness, session styles should include a combination of mini-lectures, case studies, role-playing and group discussions. A first series of training sessions should occur at the beginning of the election process. A second round of training on adjudication should be organized a few weeks before Election Day to assess challenges and errors from the pre-election complaints period and attempt to improve the process. Trainings should promote the uniform and transparent application of the Electoral Law through the development of informal but authoritative guidelines, in particular for the PECCs. Cascade training with experienced staff could be used to organize field visits and training for PECCs. It is important that training and supervision take place not only in Kabul but also in PECC offices.

It is also necessary to strengthen cooperation and communication between ECC and IEC staff. Cooperation between the IEC and ECC legal department should be strengthened in order to avoid tensions, misunderstandings and delays in the electoral process. Regular communication mechanisms should be in place during the entire election process.

7) Provide Training Opportunities to Other Stakeholders in the Election Process, Including Political Parties, Candidates, Relevant Nongovernmental Organizations, Observers and Media Outlets.

Education and training programs are necessary to clarify roles and responsibilities to candidates, political parties and government officials and to ensure a fair democratic process. ECC public outreach efforts should be conducted between elections and must receive greater resources and support. The IEC should also inform voters and candidates about the complaints process in the course of voter education campaigns.

As mentioned above, decisions should be publicized in a timely manner and information on ECC activities should be regularly posted on the ECC website. To help improve the transparency of this process, the IEC and ECC should engage civil society organizations to provide oversight and monitoring. This will help promote transparency of the complaints adjudication process. The media should also be encouraged to inform and report more responsibly on the election process, particularly on candidate complaints during the post-election period. The media should be fully educated on the complaints and adjudication process and both media and observers should have full access to a list of pending complaints in order to verify the complaints made publicly by candidates and parties.

8) Conduct an Effective Voter Education Campaign in Advance of Election Events, in Order to Inform the Public, Increase Trust and Promote Transparency of the Process.

The ECC has a responsibility to conduct civic education and inform voters about its activities. Regular communication with stakeholder groups, with a focus on political parties and candidates, is an important component to building trust and ensuring that the process is transparent. The ECC should also appoint a manager of media relations (spokesperson) who can serve as a reliable point of contact for domestic and international media and observers, and more actively manage the ECC's media operations. Lack of or difficult access to information could lead to misunderstandings, suspicions, and/or negative perceptions regarding the work of the ECC that could harm the electoral process.

9) Introduce an SMS-Based Monitoring and Mapping System.

To facilitate expedited investigations, the IEC and ECC could coordinate to introduce an SMS-based system to monitor and map allegations of fraud and malpractice. Civil society and observation groups could contribute to this effort. Through this process, reports of locations with high incidences of fraud and malpractice could trigger the immediate deployment of official teams to investigate reports and facilitate the IEC and ECC's resolution of specific issues here appropriate.

### 8. Observation and Oversight

### Impact Score: 7.6

### Vulnerability Score: 7.0

a. Major Weaknesses/Explanation of Ratings
Election observers and political entity agents play a critical role in the electoral process. Over time, the methodology used by election observation missions in Afghanistan has become increasingly more sophisticated and all-encompassing. Having said that, the main thrust of observer activities in Afghanistan centers on Election Day and subsequent results aggregation processes. Given the electoral vulnerabilities exposed in that country leading up to the 2004 election and onwards, this focus remains reasonable, but requires the addition of observation of voter registration and electoral dispute resolution mechanisms (which observer organizations like FEFA have also incorporated into their purview).

### Legal Framework (Subcategory Weight: 0%)

### Impact Score: 0.0

### Vulnerability Score: 0.0

The Electoral Law clearly recognizes that observers have an important role to play throughout the electoral process. The IEC accredits and codifies the rights and responsibilities of observers and political entity agents. In general, observers and agents have unfettered access to all components of the electoral process, as per international standards. Accordingly, the legal framework subcategory has been accorded no weight in the overall category assessment.

### Challenges to the Work of Observers/Agents (Subcategory Weight: 60%)

### Impact Score: 8.0

### Vulnerability Score: 9.0

In some countries, the interest among civil society and political entities to deploy observers and agents is somewhat limited. This is not the case in Afghanistan, where the IEC accredited 378,550 observers and agents (an extraordinarily high number). Reports and commentaries by the IEC, local and international media and other stakeholders, however, clearly indicate serious limitations in the actual presence of observers and agents on Election Day. The ability of non-IEC entities to deter and detect electoral malpractice and fraud on Election Day was severely limited by their absence from many polling stations.

Similarly, in spite of accrediting more than 370,000 agents representing political entities for the 2010 elections, remarkably few of them were actually present on Election Day, or even during the tabulation process at the national center in Kabul. As far as the assessment mission could ascertain, neither parties nor candidates had viable systems in place to obtain information from their agents in a timely and coherent manner. Anecdotal evidence indicates that only a fraction of the agents received any formal training or had access to information of relevance to their duties during polling, counting and tabulation of results. Accordingly, the agents' abilities to deter and detect malpractice and fraud were negligible.

Anecdotal evidence also suggests significant problems with agents of political entities. They were absent during polling, counting and tabulation of results, thereby undermining their effectiveness to deter and detect both electoral malpractice and fraud. Unfortunately, numerous reports indicate party representatives and their agents as perpetrators of electoral fraud, including ballot box stuffing as well as intimidation of domestic observers and IEC ad hoc staff. As these individuals are often closely linked with local strongmen, only a professional and well-trained polling center manager backed up by members of Afghan security forces posted to the polling center in question could counter such abuse (see recommendations related to the role of security forces, recruitment and training and capacity building categories).

### Observer Findings (Subcategory Weight: 15%)

### Impact Score: 7.0

### Vulnerability Score: 4.0

FEFA has been the leading domestic observer umbrella organization since the first post-Taliban elections in 2004. During the previous election(s), FEFA-accredited observers represented more than 90 percent of domestic of servers. Given their dominant role, the organization's activities and abilities during the most recent election will here be deemed reflective of the domestic observation sector in Afghanistan.

Over the years, FEFA has become an increasingly professional observation organization, building on technical support from the National Democratic Institute (NDI), the Asian Network for Free Elections and the Asia Foundation and more recently the University of California at San Diego. As a result, FEFA's methodology is inclusive and largely follows the guidelines codified in the Declaration of Principles for International Election Observation and Code of Conduct for International Election Observers.

According to FEFA, its 6,600 short-term observers (STDs) and 600 long-term observers (LTOs) faced significant challenges effectively impeding their work. The overriding impediment was the security situation in the country, which negatively impacted FEFA's ablity to recruit, train and deploy observers throughout the electoral process. In spite of the postponement of the elections, the deteriorating security environment was evident on Election Day. This limited FEFA's ability to observe Election Day operations and counting in a large number of politically significant districts, primarily (but not exclusively) across southern and eastern Afghanistan.

Even where FEFA managed to deploy observers, LTOs suffered from intimidation, night letters and threats of violence against family members and themselves. On Election Day, STOs were also frequently intimidated, which affected their ability to perform their duties or to continue observing at their assigned polling centers.

FEFA's final report from the previous election(s), complemented by senior FEFA officials, reveal four integrity-related areas of concern for the organization. Unfortunately, the distinctions between systemic manipulation, electoral malpractice and fraud are largely blurred by FEFA, thereby negatively affecting its findings and recommendations. Should FEFA adopt a clear distinction between the three categories from the outset, their data-collection activities, analysis and recommendations will become even stronger. This would require changes to training, check-lists and report structures, as currently systemic manipulation, electoral malpractice and fraud are largely lumped together under one label: fraud.

Dissecting FEFA information in accordance with the assessment methodology reveals the following findings:
1) Ballot box stuffing is the primary problem, while multiple voting due to a poor voter registration system is less significant. This does not mean, however, that proxy voting and underage voting should be ignored.
2) Systemic manipulation is a significant problem. It politicizes the IEC; undermines the ECC's ability to perform its electoral dispute duties effectively and impartially; and creates unclear jurisdictional lines between the IEC and the ECC.
3) Security forces are ineffective and responsible for both malpractice and fraud. Afghan security forces on the ground during the 2010 elections were largely unaware of their roles and responsibilities. In addition, in some instances they effectively facilitated fraud, especially ballot stuffing, by permitting local strongmen to control sensitive election material.
4) Substandard and opaque count and tabulation processes compromised the integrity of the overall electoral process.

### Credibility of Domestic Observer Organizations (Subcategory Weight: 25%)

### Impact Score: 7.0

### Vulnerability Score: 4.0

As discussed, FEFA has evolved into the main domestic observer umbrella organization in Afghanistan. Given its geographical coverage, capacity to observe all major components of the electoral process and ability to generate reports, the organization's standing is considerable. However, being primarily the only domestic observer organization has also rendered it a target for intimidation and political pressure. The credibility of the organization's findings is also undermined by lack of transparency. For instance, FEFA states it deployed observers in 3,538 polling stations on Election Day in 2010, but in its official findings the actual number of reports used was not disclosed. Nationwide observation efforts, even under the best of circumstances, lose data due to sick or otherwise absent observers and lost or incomplete checklists and data. In addition, even where observer missions have introduced mechanisms to screen out partisan observers, the problem often surfaces and forces the observer group to exclude their data. As this is a very serious problem for all organizations in Afghanistan, including the IEC, political parties and candidates, the very same condition is likely to hold true for FEFA. Unfortunately, FEFA has been silent about the reliability of its own data collecting and processing processes, which undermines the credibility of its findings.

### Recommendations

There are no reports of observers actually participating in electoral fraud. However, observers play an instrumental role in deterring and detecting fraud by other actors. This is especially the case when preventing ballot box stuffing and fraudulent counting processes.

1) Distinguish Between Fraud, Malpractice and Systemic Manipulation in FEFA's Observation Methodology.

FEFA's capability in this area can be significantly strengthened. The methodology used by domestic observer missions should clearly distinguish between and among systemic manipulation, electoral malpractice and fraud. If not, their analysis will only partially identify existing electoral vulnerabilities correctly and consequently risk issuing statements that are only partially correct.

2) Amend the Reporting Template for LTOs and STOs to Better Reflect Relevant election integrity distinctions.

LTO reporting templates should clearly distinguish between fraud, malpractice and systemic manipulation as currently these are largely lumped into the fraud category and thereby distort analysis, findings and recommendations. Checklists for STOs should also be amended to reflect the new distinctions, including questions to better measure the scale of the problems (in particular ballot box stuffing, counting and tabulation of results).

3) Improve LTO and STO Training Approach Based on Amended Reporting methodology.

Based on the amended data collection and reporting methodology, the three dimensions (fraud, malpractice and systemic manipulation) should form an integral part of LTO and STO trainings. This will further enable the observer missions to obtain accurate and clear data.

4) Improve Observer Mission Coding and Tracking Approaches.

Observer missions should develop better coding methodologies to collect and track various types of alleged electoral malpractice and fraud they submit to the IEC and ECC. This will force electoral institutions to act on allegations and report the outcome of their investigations more swiftly.

### 9. Infrastructure and Planning

### Impact Score: 6.6

### Vulnerability Score: 4.75

a. Major Weaknesses/Explanation of Ratings

### Strategic Planning (Subcategory Weight: 15%)

### Impact Score: 2.0

### Vulnerability Score: 3.0

Following the previous election(s), the IEC took the lead in organizing an extensive post-election review leading into its strategic planning. It built on this experience following the 2010 election, when it independently conducted a retrospective exercise without any input or participation by any of its international technical assistance providers. However, the 2010 strategic planning effort did not include the development of a comprehensive malpractice and fraud control plan. This type of plan should serve as an integral part of the IEC's overarching strategy for the electoral process. This issue is discussed further in the fraud mitigation planning subcategory below.

### Operational Planning (Subcategory Weight: 25%)

### Impact Score: 8.0

### Vulnerability Score: 4.0

While the post time period after the previous election's strategic planning effort as a completely homegrown exercise, the operational planning leading up to the election was more of a collaborative effort, led by the IEC Secretariat. Various IEC departments developed their respective plans, programs and deadlines. Based on this exercise, an overarching election operational plan and calendar emerged.

The Field Operations Department as successful in integrating its work with the IEC's field structure. Its headquarters staff frequently reached out to logistics officers at the provincial level to obtain information based on which operational plans were created and verified. This was particularly notable during the process of hammering out delivery and retrieval plans for Election Day material. Other departments were less successful in integrating their field counterparts, except in the implementation stage.

Overall, the IEC's heads of departments have generated a good understanding of and appreciation for operational planning processes. However, the operational plan lacked a coherent and coordinated approach based on which the IEC could develop its anti-fraud and malpractice measures. This undermined, rather than reinforced, the effectiveness of IEC measures. This was a significant omission by the IEC.

### Fraud Mitigation Planning (Subcategory Weight: 50%)

### Impact Score: 8.0

### Vulnerability Score: 6.0

As detailed previously, although the previous electoral processes were by no means immune to either malpractice or fraud, neither issue as on the top of the IEC's agenda leading up to the previous election(s) (and especially not electoral malpractice). The institutional framework category details the actions taken by the IEC to reduce the risks of fraud in previous election(s).

As noted, the main shortcoming in the IEC's malpractice and fraud strategy leading up to the previous election(s) was its lack of an integrated malpractice and fraud control plan. Instead of a comprehensive assessment of the possible vulnerabilities based on input from IEC officials at various organizational levels and civil society, political parties and security entities, only a select few individuals were charged with identifying risks and solutions. Although an impressive number of changes and improvements were achieved, several were Kabul-centric, focused on the IEC and functioned more as stand-alone activities than as components of an integrated plan. Furthermore, only limited attention was paid to proactively deter malpractice and fraud early on in the electoral process. On a similar note, the IEC failed to proactively engage the Afghan electorate and other key stakeholders in combating fraud and keeping them informed about actions taken by the IEC to combat vulnerabilities. As a result, the IEC was at a serious disadvantage going into the previous electoral process as it had not yet overcome the negative public perception from the previous election(s).

### Infrastructure and Technical Capabilities (Subcategory Weight: 10%)

### Impact Score: 3.0

### Vulnerability Score: 3.0

When considering planning and technical capabilities of the election administration in Afghanistan, it is important to keep in mind the general level of infrastructure, especially outside of the country's main cities. Major improvements have been made in the development of office complexes and, to a certain extent, power and communications channels. Organizations and state institutions need to be largely self-sufficient in terms of power, and cannot rely on landlines for communications. If one compares the IEC's infrastructure and technical capabilities with other GoA state institutions, it is clear that significant resources have been dedicated to ensure purpose-built facilities for the EMB's operations. This holds true for both Commissioner and Secretariat office spaces. A dedicated national media center was also built leading up to the previous election(s). A training center is currently under construction at IEC headquarters in Kabul.

However, the IEC's mandate and functions are unique in that it must have the capability to launch nationwide activities on a relatively short notice, thereby requiring a strong foundation on which to plan and execute rapid expansion and contraction of operations.

Over the years, the IEC has expanded its infrastructure at headquarters and provincial offices. Office space and warehousing capacity have grown and become increasingly more purposed. Although significant resources have been allocated to the Commission's communications and IT infrastructure, it still displays gaps that effectively curtail its command and control capabilities. Additionally, the IEC's ability to develop databases for its evolving tasks and requirements is still limited.

### Recommendations

1) Conduct Comprehensive Malpractice and Fraud Risk Assessments.

Although the IEC conducts post-election reviews and strategic planning exercises, it is not performing a comprehensive malpractice and fraud risk assessment. By institutionalizing the risk assessment process, the IEC will have a significantly better understanding of the true malpractice and fraud risks facing election administration in Afghanistan.

2) Develop a Malpractice and Fraud Control Plan to Deter, Detect and Mitigate Vulnerabilities

Based on the results of the risk assessment, a malpractice and fraud control plan should be developed by the IEC. It should include improved detection and mitigation mechanisms, and more importantly, mechanisms to promote significantly stronger deterrence. This plan should become an integral part of both the IEC's strategic planning and operational planning efforts, with which mutually reinforcing effects will be achieved and gaps avoided.

### 10. Public Information and Voter Education

### Impact Score: 6.5

### Vulnerability Score: 5.5

a. Major Weaknesses/Explanation of Ratings

Public outreach is a critical element for any election, particularly so for a country like Afghanistan that is implementing elections under a new system in a fragile, post-conflict environment. Public outreach by election officials informs citizens and candidates of election-related rules, laws, and processes; emphasizes the importance of casting a vote; and outlines the process. At a fundamental level, public outreach and education is also an exercise in empowerment, ensuring all citizens have access to and confidence in their electoral and political system, as candidates and voters, and a voice in the future of their country. From an electoral integrity perspective, strong public outreach efforts strengthen the transparency and legitimacy of the electoral process by creating public confidence and acceptance.

### Mandate and Capacity of EMB (Subcategory Weight: 25%)

### Impact Score: 6.0

### Vulnerability Score: 5.0

After previous Afghan elections, the attention of the international community shifted away from the electoral process. The all-Afghan IEC began receiving the attention and support it deserved. It was extremely challenging for the IEC to build its long-term institutional capacity during the election period when it was focused on the immediate operational challenge at hand. The IEC was aware of its mandate relating to public information and voter education. With the support of international advisers in place, the IEC attempted to implement this mandate.

For the previous electoral cycles, the IEC's Public Outreach Department (POD) developed messages and materials to educate the public about their role in the electoral process; roles and responsibilities of various electoral agencies; how to prepare for elections; and what to expect at each stage of the process. The POD also runs a permanent Election Education Center (EEC) to undertake electoral education programs.

There were several external factors that adversely impacted IEC outreach activities, including the deteriorating security situation and Afghanistan's multi-member SNTV electoral system, which did not encourage strong political parties. Only five parties registered in time to appear on the ballot, with five other small parties registering in the following weeks. The IEC was unable to communicate with large national political party networks since the SNTV system was not conducive to the development of strong national/regional political parties. Accordingly, an explanation of rules, regulations, procedures, electoral issues and events had to be undertaken for independent candidates. The IEC also was not in a position to ensure quality control and monitor activities of field civic educators due to cost, security and mobility restrictions.

Overall, public outreach efforts of the IEC for the previous electoral cycles were impressive, particularly since the operation was confronted with serious security challenges, high illiteracy rates among beneficiaries, a strict electoral calendar, an ethnically diverse population, geographic barriers and a relatively new and modern democratic system of governance. However, the perception of electoral fraud was and will continue to be a major challenge for the 2014-15 election period. A significant voter education campaign will be required to ensure voters, candidates and other stakeholders understand how electoral malpractice and fraud undermine the democratic process, the stakeholders who could deter and detect fraud, available mechanisms for the aggrieved and the role of the IEC relative to other electoral decision makers.

### EMB Voter Information and Education (Subcategory Weight: 50%)

### Impact Score: 7.0

### Vulnerability Score: 6.0

Managing external relations is an important aspect of election management, particularly when a country's elections are being closely watched by the international community, are supported by a myriad of donors and the need for information is high for local stakeholders. To ensure a strategic approach to communications and advance planning for contentious stages in the electoral process, senior IEC staff and advisers developed an “information dissemination plan,” identifying key stages of the electoral timeline and focusing on where there would be intensified public interest or problems. Senior IEC staff chaired regular meetings for donors (mainly from embassies of large donor nations), observers (mainly international) and other stakeholders (technical assistance providers and civil society representatives). The latter group was never well-defined nor were meetings well-attended. As a result, they were quickly dropped and participants attended meetings with one of the other groups instead.

One of the main challenges to instilling a culture of public outreach in the electoral process in Afghanistan was the narrow view of stakeholders, which focused largely on the international community and insufficiently on Afghan civil society, Afghan political entities and institutions beyond the security apparatus. The IEC was insufficiently communicative with political entities, civil society and the general public during the extended period after the election when it was dealing with complaints adjudication, audits and other processes to address malpractice and fraud. This engendered an atmosphere of distrust that led to many conspiracy theories.

One positive improvement was the IEC Media Center, which was established in a previous election(s) to serve as a venue for press conferences and provide facilities for journalists to work and file stories. This development marked significant progress in the IEC's efforts to improve its institutional capability to conduct outreach to the media and enhance its transparency. It also emphasized the IEC's commitment to publicly sharing information and marked a significant departure from its more opaque operations in previous election(s). In the lead-up to and following Election Day, the IEC held numerous press conferences at the Media Center to inform the media and observers about the electoral process. The new, permanent Media Center gives the IEC the capacity to better interact with the press and the public throughout the electoral cycle by utilizing its skilled staff and a fully functional and well-equipped facility.

The POD also supported voter outreach and other public information efforts. Ahead of the previous elections, the POD systematically collected, catalogued and reviewed all training, voter education and outreach materials that were used previously. Following this process, the POD embarked on the development, translation and printing of new training and outreach materials for the previous election cycles and beyond. These materials provided information about voter registration, candidate nominations, the campaign period, voting rights, voting procedures, the counting process, dispute resolution and other topics. Messages were also developed to raise awareness of electoral reforms and build public confidence in the IEC. Materials produced included posters, billboards, leaflets, brochures, mock ballots, sample ballots, banners, stickers and polling station signs. Messaging for all material was carefully formulated and tested with target audiences.

IEC paid special attention to designing messages, materials and outreach activities that catered to the specific needs of women and that were culturally, ethnically and linguistically acceptable. It proved particularly effective in Afghanistan to implement a two-pronged outreach strategy, focusing one approach directly on women and the other on mullahs and village elders. Very often, the latter's acceptance was required for women to run for office or to vote. Given low literacy rates, voter education for women was primarily conducted through community mobilization events and face-to-face activities, supplemented by public information (print and electronic media), posters and leaflets. Despite these efforts, in many parts of the country it was extremely unsafe for women to run for office and impossible for them to come out to vote.

Public outreach and voter education messages were also distributed through radio, television, mobile networks and mobile theater performances. SMS pilot projects were developed, sending over five million IEC-branded messages across Afghanistan ahead of the previous parliamentary elections. Civil society partners also assisted in the conduct of an election quiz. In discussions, IEC officials expressed an interest in engaging omen's councils and village councils in the future for these efforts.

Ahead of the previous presidential elections, the IEC POD, through UNDP ELECT, contracted the Lapis media production company to produce and arrange media placement of a television documentary on the presidential and provincial elections. The documentary would provide voters with detailed information on voter registration, ballots (presidential and provincial council), voting procedures, monitoring and observation, security arrangements, counting procedures and run-off elections for the office of the president. The documentary was produced in Dari and Pashto and was aired on five popular Afghan TV channels.

Two hundred and fifty thousand copies of a presidential candidate catalog were produced, containing information on 41 candidates, their backgrounds, work experiences and positions on key issues. These catalogs were distributed to the public through civil society organizations, the EEC and a variety of other stakeholders. To produce these catalogs, a questionnaire was designed and disseminated to each candidate. Thirty-four candidates responded, with the notable exceptions of incumbent President Hamid Karzai and Dr. Abdullah Abdullah, who refused to publish their political platforms (notwithstanding media pressure).

To promote wider dissemination of public information and voter education messages, the IEC established a call center at Roshan Telecom that operated from May 2009 until November 2010. The toll-free lines received a total of 5,511,771 calls, of which 3,807,146 were answered due to capacity limitations of the call center. Callers waiting for an operator were able to listen to voter information messages. All printed and electronic materials produced by the IEC POD mentioned the call center's 190 toll-free numbers. In addition, specific radio spots and various SMS-based products reinforced using the call center for voter questions.

Call center data from the previous election periods is instructive for devising future public information and voter education programs. Many callers lacked even basic data on the election (purpose of the election and relevant dates), while others were comfortable enough with the mechanism to submit detailed observations of electoral violations. To preemptively address questions that indicated a lack of basic knowledge, the IEC POD, along with its voter education partners, would be well advised to conduct a formal lessons learned exercise. Regarding the submission of electoral complaints via the call center, operators supplied callers with addresses and telephone numbers of PECC offices along with the website address of the ECC. Overall, the call center was successful and is an excellent tool for increasing the reach of public information in Afghanistan. It should be expanded for the 2014 and 2015 election cycles, as noted below.

### Voter Education by Other Stakeholders (Subcategory Weight: 25%)

### Impact Score: 6.0

### Vulnerability Score: 5.0

Given the Afghan population's limited experience with elections and democratic processes, effective civic education is a crucial factor in ensuring the success of the upcoming elections and the democratic process. While a broad-based and extensive civic education campaign would ideally be rooted in and built upon school-based civic education, election timelines and available funding have left Afghan and international stakeholders without the means to conduct an effective long-term civic education campaign.

Limited civic education activities used in the past include mass media, face-to-face activities and distribution of printed material. An IFES project survey conducted by subcontractor Counterpart International shows that Afghans who participated in a public outreach session had a greater appreciation for democratic values, greater confidence and were more engaged in community and political affairs. Given that 68 percent of Afghanistan's population is under the age of 25, it as critical to instill an appreciation of democratic governance; an understanding of how the democratic electoral system works; and what their role is within it (including holding election officials and elected officials to account).

### Recommendations

1) Use IEC Malpractice and Fraud Control Plan for Public Outreach and External Relations Efforts.

As discussed throughout this report, the IEC should develop an anti-fraud and malpractice plan and make it a key focus of its public outreach and external relations efforts to voters, political entities, media, civil society and other national and international stakeholders. This clear focus will not only deter fraud and malpractice but also will go a long way in addressing the public perception of fraud that undermined the legitimacy of the 2009 and 2010 elections.

2) Expand the Scope and Size of the IEC Call Center.

The scope and size of the call center should be expanded significantly in light of widespread mobile phone penetration in Afghanistan. A mechanism for cooperation between the call center and the ECC should be established early on in the process in order to use the call center as a resource for both the IEC and ECC and to ensure better processing reports of malfeasance, as well as information dissemination on complaints and their adjudication. The call center could also be a valuable tool to publicize the malpractice and fraud control plan. A pre-recorded message on the IEC's electoral integrity measures could be played during any hold/wait time.

3) Target Voter and Civic Education Messages According to the Most Relevant information needs Voter education messages should include the following information, at a minimum:
a) Eligibility for voter registration, including the necessary documents for registration.
b) The IEC's legal authority, mandate and responsibilities, such as the authority to quarantine and invalidate ballot boxes.
c) Polling station locations.
d) Information on quarantine and audit procedures, in advance of the counting process, to ensure full understanding on the part of all stakeholders.
e) Support for a growing culture of democracy in Afghanistan, in which losing candidates accept election results and do not resort to accusations of fraud.

4) Implement Training Programs for Political Parties and Candidates.

5) Training, Information and Education Programs Directed Specifically at Political Parties and Candidates are Needed, in Order to Increase Awareness of and Facilitate Improved Compliance with Election Rules and Procedures.

6) Establish an IEC Monitoring and Evaluation Mechanism that Works Closely With Field Liaisons/Outreach Officers.

During discussions, IEC officials identified a disconnect between the POD, which was responsible for developing voter education messages and materials, and the staff conducting voter education in the field who were recruited by and report to officials at the field operation level. While it is not uncommon that different headquarters departments share these functions, it is imperative that there is excellent coordination and communication in order to ensure that the messages reach the public in a timely, systematic and accurate manner.

7) Increase Capacity of the POD.

The POD should be supported (both technically and financially) to ensure it is able to meet its mandated responsibilities and to expand its capacity as the coordinating entity for all organizations conducting civic and voter education in Afghanistan.

8) Increase Civic and Electoral Education Directed at Women.

Civic and electoral education directed specifically at women should take place between elections, not just in the few short months prior to Election Day. More workshops need to be organized, particularly for female candidates and potential candidates to ensure women understand electoral processes and the importance of following guidelines for nomination. Additionally, the IEC should conduct further research on effective tools and methods for civic education for women.

9) Establish MOUs between the IEC and the Ministries of Information and Telecommunications.

The IEC should explore establishing MOUs with the Ministries of Information and Telecommunications for cell phone usage and free airtime in order to disseminate public information and voter education messages to a wide swath of the Afghan population.

### VI. SYSTEMIC MANIPULATION ASSESSMENT

As noted previously, systemic manipulation is defined as “the use of domestic legal provisions and/or electoral rules and procedures that run counter to widely accepted democratic principles and international standards, and that purposefully distort the will of voters.” The systemic manipulation of individual aspects of the election process can have wide-ranging implications for the credibility of an election and provide openings for both malpractice and fraud.

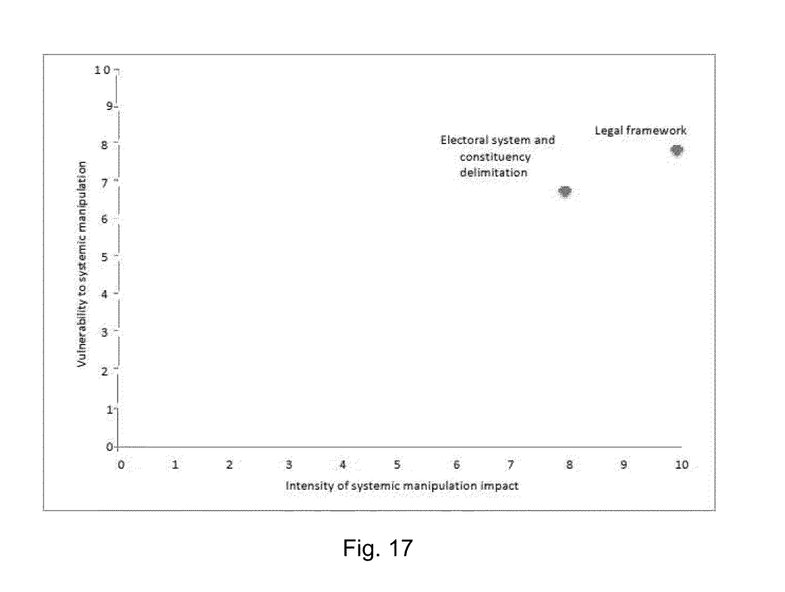

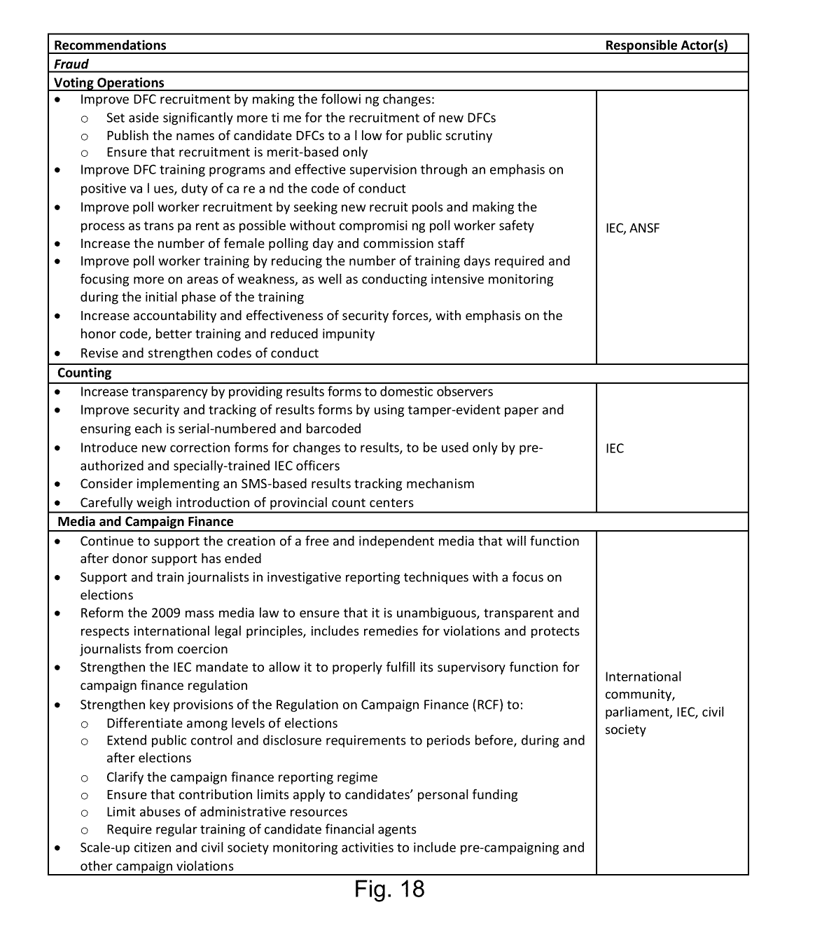

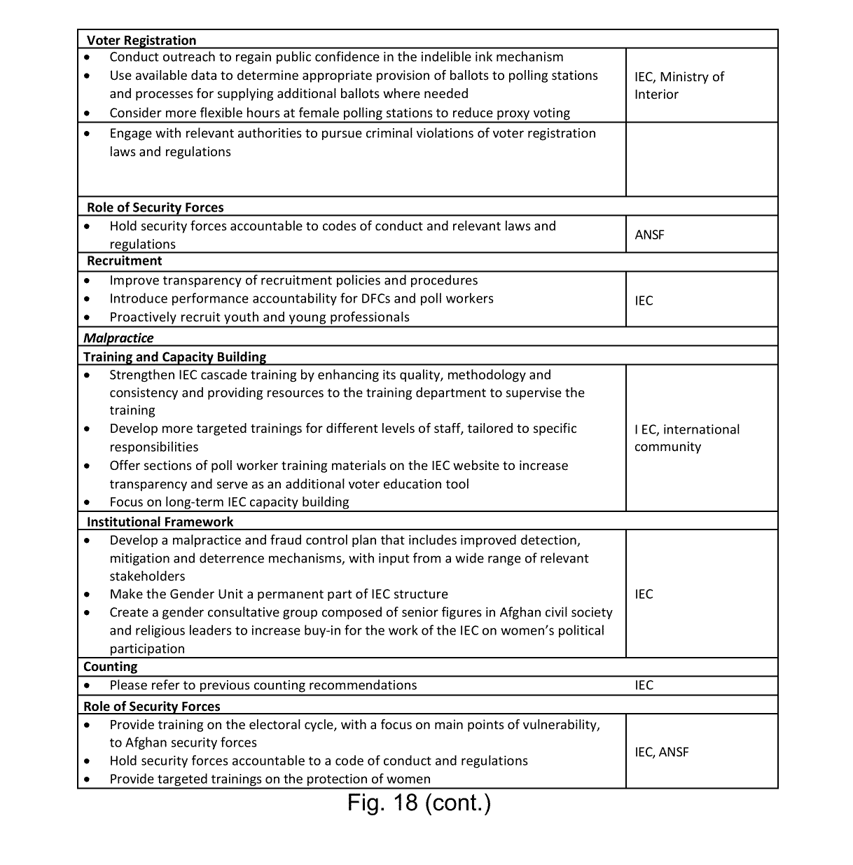

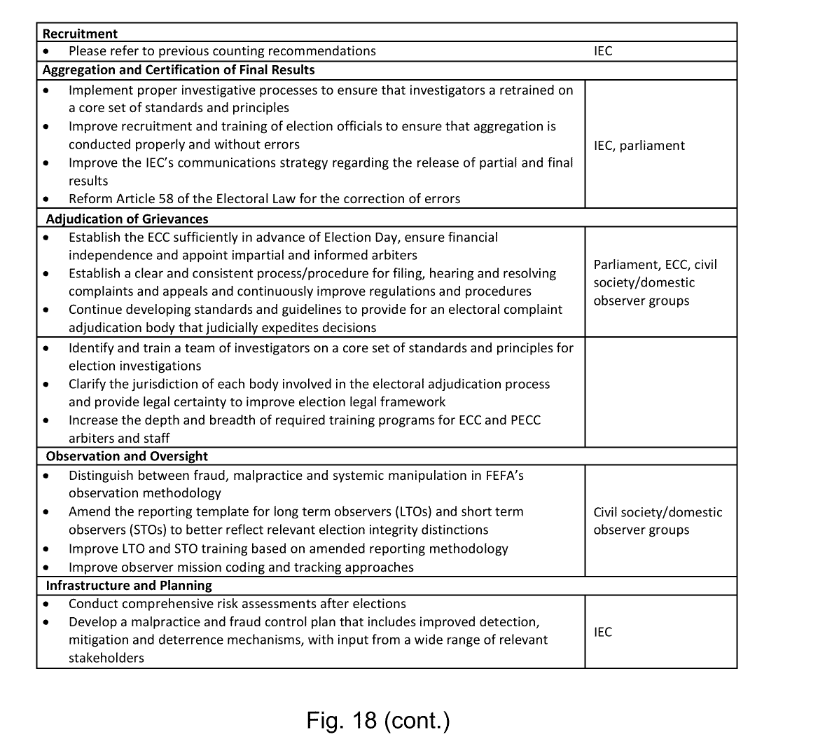

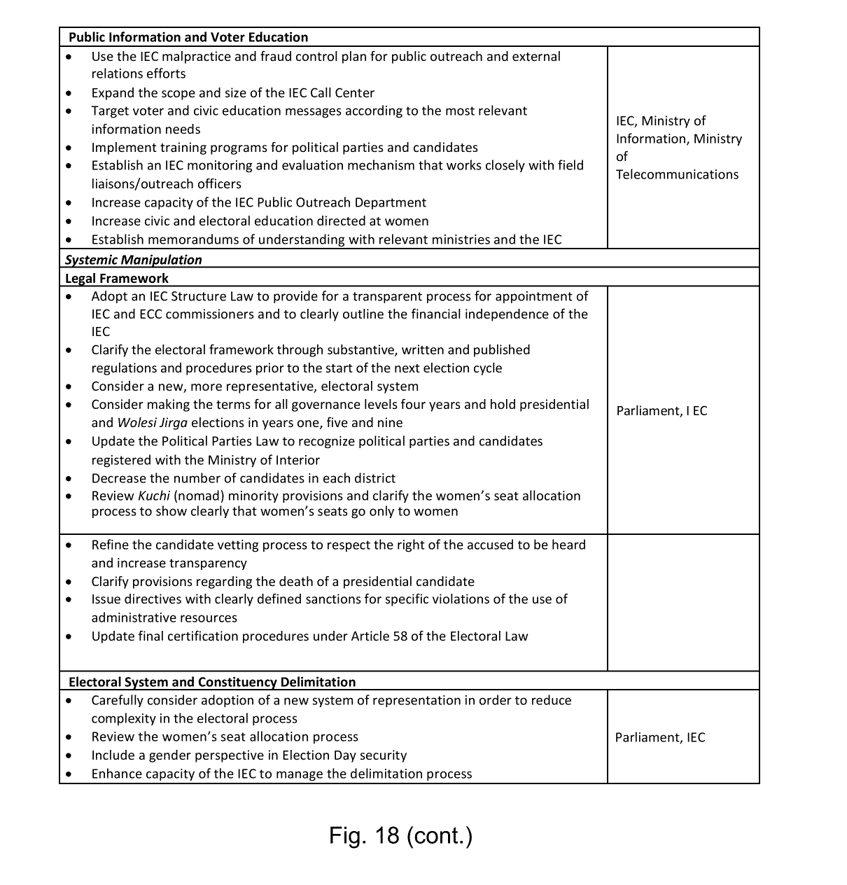

The assessment team determined that the following two electoral process categories in Afghanistan are especially vulnerable to systemic manipulation. They are scored in FIG. 17 according to the guidelines described in the Methodology section of this report:
1) Legal Framework
2) Electoral System and Constituency Delimitatio

The recommendations captured for these categories are mainly directed at political stakeholders, including the GoA and the diplomatic community.
1. Legal Framework

Impact Score: 9.2

### Vulnerability Score: 7.75

a. Major Weaknesses/Explanation of Ratings

Following the overthrow of the Taliban in 2001 and the appointment of an interim government in Afghanistan, the conduct of legitimate elections was critical to cementing the democratic process and strengthening democratic institutions. It remains so today. The foundation of this aspiration is the development and implementation of a sound legal framework for elections.

### Structure of the Legal Framework (Subcategory Weight: 15%)

### Impact Score: 8.0

### Vulnerability Score: 4.0

An electoral legal framework should be unambiguous, understandable and transparent. It should address all components of an electoral system and guarantee the integrity of the process through impartial electoral management and full participation by an informed electorate, political parties and civil society. The overall structure of the legal framework that governs elections in Afghanistan draws on provisions from the constitution, Electoral Law, Political Parties Law and applicable presidential decrees along with regulations and procedures of the IEC and the ECC. There are, however, large gaps and ambiguities in the current framework. These gaps must be clarified through substantive, written and published laws, regulations and procedures issued prior to the next election cycle. Most importantly, the electoral reform process has not been sufficiently transparent and, depending on how and which legal framework is adopted before the next set of elections, new provisions in the framework could further undermine the credibility of the electoral process.

Even with these gaps and ambiguities, foundational legal documents state that Afghanistan will respect international legal principles. For example, Article 83 of the Afghanistan Constitution states that “Members of the Wolesi Jirga shall be elected by the people through free, general, secret and direct balloting.” Furthermore, it also states that “the elections shall adopt measures to attain—through the electoral system—general and fair representation for all the people of the country, and proportionate to the population of every province, on average, at least two females shall be elected members of the House of the People from each province.” Finally, Article 7 states that “The United Nations Charter, inter-state agreements, as well as international treaties to which Afghanistan has joined, and the Universal Declaration of Human Rights shall be respected.” Afghanistan has ratified the ICCPR, and Article 2 of that document states, “Each State Party to the present Covenant undertakes to respect and to ensure to all individuals within its territory and subject to its jurisdiction the rights recognized in the present Covenant, without distinction of any kind, such as race, color, sex, language, religion, political or other opinion, national or social origin, property, birth or other status.” Finally, on Sep. 18, 2012, Afghanistan also ratified the Convention on the Rights of Persons with Disabilities (CRPD). If these public international law commitments were respected, the legal framework would provide the opportunity for Afghanistan to implement an inclusive electoral process that is free, general, secret and conducted by direct balloting. However, due to gaps in the current framework and a lack of respect for the rule of law, Afghanistan is not meeting its international legal commitments.

When combined with other vulnerabilities in the process (e.g., the appointment process of election officials, the overarching security environment, a faulty voter register, cultural barriers to participation and multiple ID cards), the current legal framework undermines the credibility and effectiveness of the electoral process. Some examples of this include:
1) Article 61.1 that outlines the appointment process for ECC Commissioners (discussed previously in the adjudication of grievances category)
2) Article 14 ties citizens voting locations to the voter list rather than to the constituency as indicated on their voter card, which weakens the process due to serious inaccuracies in the voter register (this would be a strong provision if the voter lists were accurate)
3) Article 15 could facilitate multiple voting because it allows voters to prove their identity by showing “documents” provided by the IEC, whereas the previous law allowed the voter registration card as the only proof of identity.

Furthermore, the election calendar creates substantial challenges for the IEC. The Electoral Law requires the IEC to declare an election date but also provides the terms for several subprovincial elections, with other terms provided for in the constitution. The result is that beyond previous election(s), the electoral framework dictates a major election per year: Presidential (2014) and Wolesi Jirga (2015). There are high economic costs and risks of political instability associated with this sequencing of elections. Any change to the sequence would require changing the constitution or sidestepping the current legal framework, which is an unfortunate trend.

Beyond this myriad of defects in the 2010 Electoral Law, several important issues remain to be addressed. These include: women's seat allocation; definitions and procedures for electoral violations; consequences of the death of a presidential candidate; and the role and procedures for the Vetting Commission that addresses illegal militia membership questions.

Finally, the high number of candidates on the ballot is still confusing to voters, as is the SNTV electoral system. The SNTV system is furthermore exceptionally sensitive to fraud as even a very limited number of fraudulent ballots could affect the outcome of the election. These core issues must be addressed if long-term stability and self-managed elections are the driving goal.

In sum, the legal framework as it stands now has major gaps and ambiguities. When combined with other weaknesses, such as a systemic disrespect for the rule of law, it has a substantial impact on the overall electoral process. Until these weaknesses are addressed in a meaningful way, changes to the electoral framework will not—on their own—address the major vulnerabilities to fraud and malpractice in the Afghan electoral process. However, real, meaningful reform, as outlined below in the recommendation section, could diminish the amount of systemic manipulation.

### Credibility of the Legal Framework (Subcategory Weight: 25%)

### Impact Score: 8.0

### Vulnerability Score: 7.0

In 2010, Afghanistan adopted a new law to govern elections. This was done by means of a controversial presidential decree regarding Article 79, rather than through the normal legislative process. This law by decree was rejected by the Wolesi Jirga but eventually entered into force by default after the Meshrano Jirga refused to consider the decree or reject it, believing—perhaps incorrectly—that Article 109 of the constitution prevented parliament from including on its work agenda any proposal for amending the election law during the last year of their term. In reality, the Meshrano Jirga was arguably within its rights to consider the new law, as the decree had actually brought the law into force and was by then current law, not a proposal for amending law. In addition, Article 90.1 of the constitution says that parliament can ratify, modify or reject a legislative decree. Article 109 forbids consideration of amendments to the election law in that period, but in this case the issue was whether an existing law (President Karzai's decree) should have been rejected. Regardless, the legal frame work as not adopted through the normal legislative process and was perceived as an attempt to manipulate the system by the President; therefore, credibility of the framework was gravely harmed.

Most importantly, lack of acceptance by parties, candidates, civil society and the electorate makes the entire electoral process vulnerable to fraud as all stakeholders see the framework as nothing more than formal rules that can be manipulated or discarded. This is an illustration of the difficulties Afghanistan is facing in accepting the rule of law generally.¹¹⁸ The credibility of the legal framework is weak and exceedingly vulnerable to fraud. In short, until rule of law begins to take hold and the legal framework for elections is reformed and adopted through the normal legislative process, stakeholders will actively discredit the legal framework and be more apt to use gaps and inconsistencies to their advantage.

### Electoral Law Reform Process (Subcategory Weight: 60%)

### Impact Score: 10.0

### Vulnerability Score: 9.0

As stated above, the election law reform process has not been transparent or inclusive and this greatly undermines the credibility of the elections. This issue was cited in nearly all of our interviews as the major source of systemic manipulation in Afghanistan. Because the precedent of reforming the law through presidential decree has been set, the entire process is extremely vulnerable to systemic manipulation. The 2010 legal reform process did not provide the kind of electoral reform hoped for after the 2004, 2005 and 2009 elections. There was almost no time given to the IEC to comment on the proposed decree for the 2010 Electoral Law. This practice illustrates a common failing of senior bodies in Afghanistan. They place too little value in advice from bodies they regard as lower status, even those with relevant technical knowledge and experience in the field. As it turned out, the 2010 Electoral Law contained no provision for the establishment of the IEC. With the full repeal of the 2005 Electoral Law, a huge gap emerged within the legal framework that remains as of the writing of this report. Furthermore, the law does not stipulate how many IEC Commissioners are needed or how they are appointed. Election law reform has not historically been conducted according to a legal, inclusive and transparent process. The decree process is extremely vulnerable to perceptions of and actual fraud and, if taken advantage of, could have the highest possible impact on the elections by defining who can run for elections, how elections are administered and who serves as the final arbiter of the process.

### Recommendations

1) Adopt an IEC Structure Law.

In an effort to clarify the electoral legal framework, there should be one overarching election law that includes the provisions that are now in the separate draft IEC Structure Law. However, if the IEC Structure Law is passed as a stand-alone law it must provide for a transparent and inclusive process for the appointment of IEC and ECC Commissioners, for fixed terms exceeding the term of the President or for staggered terms. The Structure Law should not contradict the Electoral Law; that is, it should not attempt to restate the powers and authority of the IEC or ECC, unless the Structure Law explicitly amends provisions of the Electoral Law. Finally, the Structure Law should clearly outline the financial independence of the IEC.

2) The IEC, where Appropriate, should Clarify the Overall Legal Framework Through Substantive, Written and Published Regulations and Procedures Prior to the Start of the Next Election Cycle.

The draft Electoral Law contains ambiguities about election administration. To the extent possible within its authority, the IEC should publish substantive regulations and procedures prior to the beginning of the next election cycle (including regulations governing the operation of the IEC and ECC).

3) Consider a New, More Representative, Electoral System.

Afghanistan should consider introducing a new electoral system that ensures broader representation, provides incentives for party development, and reduces opportunities for intimidation and fraud. There are several options available, such as allowing voters to vote for three candidates on the list and not just one (not ranked) to reduce the impression of wasted votes. There are several publications that address this issue, including Fixing Afghanistan's Electoral System, Arguments and Options for Reform by Andrew Reynolds and John Carey.

4) Consider Making the Terms for all Governance Levels Four Years and Hold Presidential and Wolesi Jirga Elections in Years One, Five, and Nine.

Article 160, Paragraph 2 of the constitution evinced a desire to hold the presidential and Wolesi Jirga elections concurrently, even though it was expressed as a transitional provision. The present structure of five, four and three-year terms results in the incessant recurrence of elections in inconsistent combinations, which is expensive and confusing for stakeholders. Afghanistan should consider setting four-year terms for positions at all levels of governance, and holding presidential and Wolesi Jirga elections in years one, five and nine and provincial, municipal and village elections in years three, seven, and eleven. If these changes are to be made and respect for the rule of law maintained, the constitution would require an amendment to consolidate all or some of these elections.

5) Update the Political Parties Law.

Parliament should launch an inclusive and comprehensive review of the 2009 Political Parties Law, with a focus on party registration. Parliament should consider requiring the IEC to recognize political parties registered with the Ministry of Interior. Candidates should be permitted to register with affiliation to any party with the Ministry of Interior and appear on the ballot with proper party affiliation.

6) Decrease the Number of Candidates in Each District.

The high number of candidates per district under the 2010 Electoral Law negatively impacted the right to a free and informed vote by causing unnecessary confusion for voters. The issue of voter confusion should be fixed by either (a) dividing large provinces into smaller constituencies; (b) changing signature and monetary deposit requirements; or (c) adding a literacy requirement for candidates. Arguments that these types of provisions would limit the right of candidacy should be balanced by the fact that the enormous ballots required to accommodate all of the candidates actually impede a voter's right to a simple and clear process.

7) Review Kuchi (Nomad) Minority Provisions.

Provisions for the protection of Kuchi minorities should be reviewed to assess whether they are satisfactory to the Kuchis and whether they contravene the constitutional provision against tribal distinctions. Kuchis must be permitted to choose to register as Kuchi or as regular voters. If the quota is maintained, regulations should be reviewed to clarify whether seats reserved for Kuchis are included in calculations to determine the total number of seats reserved for women.

8) Review the Women's Seat Allocation Process.

The women's seat allocation process must be clarified to show clearly and absolutely that women's seats go only to women. The Electoral Law currently states that “if there are not enough female candidates on the list to occupy the allocated seat or seats in certain constituencies, the IEC shall . . . adopt measures to make sure the seats allocated to females (from the same gender) do not remain vacant.” For the upcoming parliamentary election, the IEC should adopt the following process: if there are insufficient female candidates to fill a seat in a province or replace a woman who does not assume her seat, then the next most successful female candidate in the country who has not received a seat should fill the position, regardless of her location of residence. This provision will decrease incentives for men to assassinate or intimidate women in order to fill their seat(s). For future election cycles, the Electoral Law should be amended to ensure that this requirement is clear.

9) Refine the Candidate Vetting Process

If the election law maintains the restriction against militia members running for office, the candidate vetting process should be refined to set vetting procedures that respect the right of the accused to be heard and increase transparency by mandating full and published records of the vetting process, including—when appropriate—the source of evidence. It should also require the IEC to remove candidates found to be members of illegal militias. A redefined process for vetting militia should: specify the steps of investigation; provide notice to the accused to appear; allow for the IEC to exclude militia members; and provide for the right of appeal to the ECC. In terms of excluding candidates on the basis that they are holding office, the law should be clarified by: banning candidates in specified top-level government positions; giving lower-level civil servants the right to leave without pay from the date of registration as a candidate to the certification of results, with the right to return to position if not elected; and forbidding any discrimination against candidates who take leave permitted by law.

10) Clarify Provisions Regarding the Death of a Presidential Candidate.

The implications of a presidential candidate's death on the election process should be clarified and explained in the Electoral Law. Only the death of a candidate in contention—not, for example, the 20th candidate out of 30 —should potentially trigger a repeat of a stage of the election (e.g., candidate nomination or just the voting process). This ensures the law reduces the incentive for assassination and clarifies which stages of the election would be repeated in the event of a death.

11) Address Issues Surrounding the Abuse of Administrative Resources.

The use of state resources in campaigning was a problem in the 2010 elections and therefore should be a priority for reform. The IEC should issue directives with clearly defined sanctions for specific violations. In addition, the Wolesi Jirga should address the issue of financial reporting and consider defining the specific authority of the IEC to regulate it. Phased reporting should be contemplated so that the financial activity of campaigns can face public scrutiny. Attention and priority should also be given to establishing a threshold for incurring and reporting electoral campaign expenses, the disclosure of candidate's wealth and assets, the involvement and cooperation of other government institutions, and the creation of mechanisms that provide for greater transparency and accountability of campaign financing (including the application of information and communication technologies).

12) Update Final Certification Procedures.

Prior to final certification of election results under Article 58 of the Electoral Law, procedures should provide for correction of errors and the possibility of reopening a violation finding if new and unmistakable evidence shows, by clear and convincing evidence, that the violation did not occur. This recommendation is also featured in the aggregation and certification of final results category of this report.

### 2. Electoral System and Constituency Delimitation

### Impact Score: 6.7

### Vulnerability Score: 6.65

a. Major Weaknesses/Explanation of Ratings

The election system used to select members of Afghanistan's Wolesi Jirga is SNTV. The system is used in the country's 34 provinces plus one Kuchi constituency, which consists of the entire country. There is also a quota mechanism for women. Under SNTV, each voter casts one vote for a candidate but, unlike in a first-past-the-post (FPTP) system, there is more than one seat to be filled in each electoral district. Candidates receiving the highest vote totals fill these positions.

### Complexity (Subcategory Weight: 65%)

### Impact Score: 6.0

### Vulnerability Score: 7.0

On the face of it, the simplicity of SNTV is alluring, but strategically the system is actually very complex. Many observers argue that the only individuals that are able to take advantage of the SNTV system are local and clan-based political elites whose influence the Afghan Electoral Law was originally intended to diminish. Local strongmen can use their influence to instruct certain villages to vote for one candidate, while other villages must vote for other specific candidates. Weak and disorganized parties cannot mobilize voters in this manner. The effect of this system is that it has “impeded the development of political parties, directed the type of campaigning conducted by candidates, and shaped voting behavior.” In addition to diluting the effectiveness of political parties, by providing an advantage for independent candidates and the political elite, the system generates a large number of wasted votes.

The result of using SNTV is that “the system throws up enormous obstacles to the rational translation of support among voters into representation.” Furthermore, the increase in number of candidates places greater logistical and financial burdens on the IEC (e.g., massive ballot papers, complicated count processes and smaller margins between candidates that require a more precise vote count process in an already challenging environment). This higher burden on the IEC, coupled with weak political parties that should be playing a more robust observation role in the process, has increased the likelihood of malpractice and fraud by inadequately trained and supervised poll workers and observer groups.

### Inclusiveness (Subcategory Weight: 35%)

### Impact Score: 8.0

### Vulnerability Score: 6.0

Domestic legal provisions and relevant international treaties ratified by Afghanistan provide for an inclusive electoral system, as detailed previously. For example, Article 83 of the Afghanistan Constitution states, “The Wolesi Jirga shall be elected by the people through free, general, secret and direct alloting.” Furthermore, it also states that “the elections shall adopt measures to attain—through the electoral system—general and fair representation for all the people of the country, and proportionate to the population of every province, on average, at least two females shall be elected members of the House of the People from each province.” Article 7 states that “The United Nations Charter, interstate agreements, as well as international treaties to which Afghanistan has joined, and the Universal Declaration of Human Rights shall be respected.” As noted previously, Afghanistan has ratified the ICCPR, herein Article 2 states, “Each State Party to the present Covenant undertakes to respect and to ensure to all individuals within its territory and subject to its jurisdiction the rights recognized in the present Covenant, without distinction of any kind, such as race, color, sex, language, religion, political or other opinion, national or social origin, property, birth or other status.” Finally, Afghanistan also ratified the CRPD. If respected, this framework would provide the opportunity to implement an inclusive electoral process.

In practice, however, there are ongoing systemic and cultural obstacles that severely restrict the participation of women and persons with disabilities in the political and civic life in Afghanistan. The deteriorating security environment also works to further suppress women's participation in the electoral process. Several of the stakeholders interviewed in Afghanistan stressed that, in the most extreme circumstances, the security and cultural obstacles to women participating in the electoral process resulted in increased fraud with unused ballots (those not used by legitimate female voters) used to stuff ballot boxes.

### Districting Equity (Subcategory Weight: 0%)

### Impact Score: 0.0

### Vulnerability Score: 0.0

Boundary delimitation is not currently seen as a critical part of the electoral cycle that is vulnerable to systemic manipulation in Afghanistan. Therefore, the assessment team has accorded it no weight in the overall category scoring. However, the draft Electoral Law currently under consideration by the parliament has provisions that will change the electoral system from SNTV to a FPTP system. If the electoral system is changed from SNTV to FPTP, the delimitation process will become fundamental to the integrity of the process. In a FPTP system, the candidate that wins the most votes within a constituency is elected. This normally results in the development of a two-party system, which may help to address the issue of underdeveloped parties within Afghanistan. Yet, the integrity of this system is contingent on the fairness of the boundary delimitation process. That is, if constituent boundaries are drawn in a way that gives one party an unfair advantage over its rivals, the integrity of the process is undermined.¹³⁴ Significantly, under an FPTP system, boundaries largely determine who is and who is not elected, tying both candidates and voters to specific districts. This process is nearly impossible without conducting a census to clearly define how many individuals reside within a constituency. Only then will the IEC be able to determine equal voting power—allowing each citizen to vote with equal influence in each constituency where they maintain their right to vote.¹³⁵ Therefore, although not currently a prevailing issue, if FPTP is adopted boundary delimitation will move up in both the vulnerability and impact measurements in our integrity assessment.

Within the current legal framework and electoral system, there is a clear requirement to draw district council boundaries. Article 140 of the Afghanistan Constitution requires that district councils be established through “free, general, universal, secret and direct elections.” Article 84 indicates that district councils are necessary to elect representatives to the Meshrano Jirga. Article 32 of the Electoral La adds “there shall be a district council in every district elected through direct, free, universal and secret elections by the voters of the district.” Yet, a major hurdle to effectively address the delimitation issue is the fact that there are currently a number of agencies tasked with responsibilities related to demarcating districts and identifying villages that fall within them. These include the Independent Directorate of Local Governance (IDLG), the Central Statistics Office (CSO), the Afghan Geodesy and Cartography Head Office (AGCHO), and the Afghanistan Information Management Service (AIMS). There is no consensus in Afghanistan on what the boundaries of districts are or might be. This was a major impediment in 2004 when local elections were first contemplated and it remains so today. In short, despite the attention that the change in the national electoral system is likely to receive from the international community, it must also be recognized that local government is often the most important form of governance for citizens as it deals with issues affecting their lives on a daily basis. Therefore, establishing legitimate district councils and mayors is also extremely important and should not be overlooked. To date, neither the political will nor the resources needed have been available to conduct a census that would serve as the foundation for a legitimate delimitation process.

### Recommendations

1) Political Stakeholders should Carefully Consider Adoption of a New System Of Representation in Order to Reduce Complexity in the Electoral Process/

Recommending a specific new system of representation is beyond the scope of this assessment and is a political question to be considered by all stakeholders in the political process.

2) Review the Women's Seat Allocation Process.

Please refer to the previous category on legal framework for detailed recommendations.

3) Include a Gender Perspective in Election Day Security.

The IEC should review Election Day security and logistical plans from a gender perspective, taking into account issues that impact omen's access to polling stations, such as location and opening hours. In addition, special places, such as schools, need to be reserved for female candidates to conduct electoral campaigning.

4) Enhance Capacity of the IEC to Manage the Delimitation Process.

When attention turns to determining electoral districts, the delimitation process must be managed by an IEC with sufficient technical capacity and credibility as an impartial and principled body. This will in turn enhance the credibility of the process. The delimitation process should consider the following: population density; ease of transportation and communication; geographic features; existing patterns of human settlement; financial viability and administrative capacity of electoral areas; financial and administrative consequences of boundary determination; and existing boundaries and communities of interest.

The relevant governmental authority could conduct a census that would provide the IEC with the necessary information for the delimitation process. Census-taking could be supported by several existing tools. For example, U.S. National Geospatial Intelligence Agency (NGA) satellite imagery is available for much of the country and can be used as a uniform base map to identify and locate settlements. This satellite imagery has been made available to the CSO and AGCHO, as well as to a number of other ministries and agencies within Afghanistan. A door-to-door canvas would also supply population data for every settlement as well as GPS coordinates and a name (or a list of names) for the settlement. If well managed, the census would provide an accurate base map and village list—assuming other agencies and ministries within the government are willing to accept it as definitive.

### VII. RECOMMENDATIONS AND CONCLUSIONS

Elections in Afghanistan are conducted against a backdrop of severe security problems. Although this context makes it exceedingly challenging to organize elections that will be acceptable to the Afghan people, it is not insurmountable. Credible elections in 2014 and 2015 will require, however, an extraordinary effort by the IEC and other Afghan stakeholders.

The IEC and its technical assistance providers have made several important improvements to the process to safeguard against electoral fraud. Many of these changes were in evidence during the previous election(s). Despite these efforts, the previous elections in Afghanistan were marred by a prevailing narrative of fraud. The IEC's own actions did little to disprove this notion, and the general perception of these elections was that they were indeed largely fraudulent. Based on our analysis, we disagree in part with such statements.

Certainly, there were many instances of fraud, a major problem that must be attacked prior to the 2014 and 2015 elections. To a large extent it was found, however, that the label of “fraud” has been incorrectly applied to administrative problems, such as the large number of errors on the results forms in the polling stations. These distinctions are not simply semantic; by distinguishing between fraud and malpractice, the IEC can more readily prioritize a focus on administrative weaknesses and reduce the risk of unnecessarily invalidating large numbers of ballot boxes from the count.

The IEC cannot overcome these problems on its own. The Commission must proactively take ownership of its administrative and malpractice challenges and the fraud risks that fall within its mandate, but other Afghan institutions must also play a pivotal role. As this report has detailed, there are significant legal, structural and operational changes that must be made to improve the election process in Afghanistan prior to the 2014 and 2015 polls. All stakeholders, including the IEC, ECC, parliament, security forces, domestic observers, civil society organizations and the diplomatic and donor community, have a role to play in improving the credibility and legitimacy of the electoral process.

The following is a brief list of recommendations for each of the main stakeholder groups. Additional recommendations and detailed approaches were included in the relevant categories of this report. This list is not intended to be exhaustive; rather, it focuses on the most vulnerable areas of the electoral process in 2014 and 2015 based on the analysis conducted by the assessment team.

### Independent Election Commission

1) Develop a fraud and malpractice control plan to deter, detect and mitigate vulnerabilities in close collaboration with Afghan election stakeholders (parties, civil society organizations, media, state institutions).
2) Ensure that activities to combat malpractice and fraud become an integral part of the organization's public information and voter education strategy from the outset.
3) Establish proper investigative processes and allocate a sufficient amount of resources to the count, aggregation and investigation process.
4) Consider the introduction of provincial count centers into the counting process.
5) Develop and implement improved security and tracking of results forms.
6) Improve communications strategy regarding the release of partial and final results.
7) Strengthen the DFC recruiting process by ensuring that hiring is merit-based only and by setting aside significantly more time for recruitment efforts to allow for a period of public scrutiny of candidates.
8) Improve DFC training and supervision.
9) Implement a more transparent poll worker recruitment process.
10) Improve training and supervision of poll workers.
11) Revise and strengthen codes of conduct for all election officials.
12) Use available data to determine appropriate provision of ballots to polling stations and processes for supplying additional ballots where needed on Election Day.

### Election Complaints Commission

1) Establish a clear and consistent process/procedure for filing, hearing and resolving complaints and appeals.
2) Identify and train a team of investigators on a core set of standards and principles for election investigations

### Parliament/Political Stakeholders

1) Carefully consider adoption of a new system of representation in order to reduce complexity in the electoral process.
2) Enhance the capacity of the IEC to manage the delimitation process.
3) Establish the ECC sufficiently in advance of Election Day, ensure financial independence and appoint impartial and informed arbiters.
4) Launch an inclusive and comprehensive review of the 2009 Political

Parties Law, with a special focus on party registration.
5) Reform the Electoral Law to:
   a) Clarify the provision for reserved seats for women to ensure that it does not encourage assassination or intimidation of female candidates.
   b) Clarify Article 58 on the correction of errors.
6) Require that Commissioners have specific skills and educational qualifications that ensure that electoral cases are heard by informed arbiters.
7) Clarify the jurisdiction of each body involved in the electoral adjudication process and provide legal certainty to improve the election legal framework.

### Security Forces

1) Increase awareness of the roles and responsibilities of security forces during the election process through improved training and an emphasis on values, ethos and service to the nation.
2) Consider moving the location of security officials shortly before Election Day in order to avoid dependency on local powerbrokers.
3) Prosecute members of security forces who violate the electoral legal framework.

### Domestic Observers and Civil Society Organizations

1) Improve domestic observation methodology, reporting templates and training approaches to distinguish between fraud, malpractice and systemic manipulation.

### International Diplomatic and Donor Community

1) Encourage the Afghan government to ensure the legal framework is more inclusive and transparent for the 2014 electoral process.
2) Provide sufficient funding and other resources to ensure the successful development and implementation of an IEC fraud and malpractice control plan.

1. An electoral integrity assessment method for analyzing areas of the electoral process at risk of fraud, malpractice and systemic manipulation for a particular country, comprising:
assembling an assessment team to conduct the electoral integrity assessment for a particular country;
conducting a desk study to collect information needed to properly prepare members of the assessment team and preliminarily identify the potential areas of fraud, malpractice and systemic manipulation;
identifying focus areas of likely vulnerability;
identifying overarching categories that are most vulnerable to acts of systemic manipulation, malpractice, and fraud;
identify additional members of the assessment team based on the specific focus areas and necessary country and regional expertise;
preparing for deployment of the assessment team;
reviewing and revising all ratings by assessment team;
conducting a timeline and resource analysis; and
preparing and distributing assessment report.

2. The method according to claim 1, further comprising assigning one or more subcategories to each category.

3. The method according to claim 2, further comprising selecting relevant questions related to analyzing fraud, malpractice and systemic manipulation for each subcategory.

4. The method according to claim 3, further comprising assigning multiple distinct data points for each subcategory to produce an overall rating for each category.

5. The method according to claim 1, further comprising assigning two to six subcategories for each overarching category.

6. The method according to claim 1, wherein the multiple distinct data points is three (3) distinct data points.

7. The method according to claim 1, wherein quantitatively accessing the electoral process comprises generating a quantitative vulnerability index.

8. The method according to claim 1, including rating vulnerability to fraud.

9. The method according to claim 7, wherein no vulnerability is rated zero (0), minimal vulnerability is rated one (1), some impact is rated two (2), moderately vulnerable is rated three (3), somewhat highly vulnerable is rated four (4), high vulnerable is rated five (5), and extremely high vulnerability is rated six (6).

10. The method according to claim 9, including rating the intensity of fraud impact, wherein no impact is rated zero (0), minimal impact is rated one (1), some impact is rated two (2), moderate impact is rated three (3), somewhat high impact is rated four (4), high impact is rated five (5), and extremely high impact is rated six (6).

11. The method according to claim 1, including rating vulnerability to fraud and intensity of fraud impact.

12. The method according to claim 1, wherein a guideline for a low rating of 0-1 is for no recent history of electoral fraud, non recent history of electoral violence, electoral stake holders who violate voting rights and/or election rules are punished, electoral process exhibits limited vulnerability to electoral fraud, election management body has a comprehensive electoral fraud control plan in place and/or at least significant ballot security measures, voters have a high level of electoral literacy, and key stakeholders trust election-related institutions comprising election management body, judiciary, and police.

13. The method according to claim 12, wherein a guideline for a medium rating of 2-4 is for a recent history of some electoral fraud, recent history of political and/or electoral violence, incentives exist to commit fraud, some components of electoral process remain vulnerable to fraud, partial fraud control plan in place, limited, ad-hoc ballot security measures in place, voters exhibit limited electoral literacy, election stakes are high, and key stakeholders somewhat trust election-related institutions.

14. The method according to claim 13, wherein a guideline for a medium rating of 2-4 is for a recent history of some electoral fraud, recent history of political and/or electoral violence, incentives exist to commit fraud, some components of electoral process remain vulnerable to fraud, partial fraud control plan in place, limited, ad-hoc ballot security measures in place, voters exhibit limited electoral literacy, election stakes are high, and key stakeholders somewhat trust election-related institutions.

15. The method according to claim 12, wherein a guideline for a high rating of 5-6 is for a recent history of extensive electoral fraud, electoral process is vulnerable to fraud across multiple components, no electoral fraud control plan is in place, no limited ad hoc ballot security measures in place, voters exhibit low electoral literacy, significant and widespread political and/or electoral violence, election stakes are high, electorate is highly polarized and/or outcome is too close to call, some or all fraudsters act with impunity, and key stakeholders have no trust in election-related institutions.

16. The method according to claim 1, wherein a guideline for a high rating of 5-6 is for a recent history of extensive electoral fraud, electoral process is vulnerable to fraud across multiple components, no electoral fraud control plan is in place, no limited ad hoc ballot security measures in place, voters exhibit low electoral literacy, significant and widespread political and/or electoral violence, election stakes are high, electorate is highly polarized and/or outcome is too close to call, some or all fraudsters act with impunity, and key stakeholders have no trust in election-related institutions.

17. The method according to claim 1, further comprising graphing vulnerability to fraud verses intensity of fraud impact.

18. The method according to claim 12, further comprising graphing vulnerability to fraud verses intensity of fraud impact.

19. The method according to claim 1, further comprising bubble sizing the categories of potential fraud assessment.

20. The method according to claim 1, wherein the bubble size can be 0 to 2 years, more than 2 to 3 years, and more than 3 to 5 years.

21. The method according to claim 1, further comprising assigning a percent weight to each overarching category of potential fraud to provide a weighted rating of vulnerability to fraud and intensity of fraud impact.
